(19) United States
(12) Patent Application Publication
(10) Pub. No.: US 2006/0057729 A1
(43) Pub. Date: Mar. 16, 2006

(54) Diffraction grating-based encoded element having a substance disposed thereon

(75) Inventors: John A. Moon, Wallingford, CT (US); Martin A. Putnam, Cheshire, CT (US); Michel Perbost, Bethany, CT (US)

Correspondence Address: Illumina, Inc.;c/o Portfolio IP, P.O. Box 52050, Minneapolis, MN, 55402, US

(73) Assignee: Illumina, Inc.

(21) Appl. No.: 11/206,987

(22) Filed: Aug. 18, 2005

Related U.S. Application Data
(63) Continuation-in-part of application No. 10/661,234, filed on Sep. 12, 2003.
(63) Continuation-in-part of application No. 10/661,031, filed on Sep. 12, 2003.
(63) Continuation-in-part of application No. 10/661,082, filed on Sep. 12, 2003.
(63) Continuation-in-part of application No. 10/661,254, filed on Sep. 12, 2003.
(63) Continuation-in-part of application No. 10/990,057, filed on Nov. 15, 2004.
(60) Provisional application No. 60/602,427, filed on Aug. 18, 2004.
(60) Provisional application No. 60/611,205, filed on Sep. 17, 2004.
(60) Provisional application No. 60/611,676, filed on Sep. 20, 2004.

(51) Int. Cl. G03H 1/00; G01N 21/64

(52) U.S. Cl. 436/57; 359/2; 436/166; 436/524

(57) ABSTRACT

The present invention generally provides multicomponent articles of manufacture and methods of making them. In its broadest aspect, the invention provides a multicomponent article that includes a diffraction grating-based encoded element, wherein the encoded element includes an optical substrate having at least one surface, and an optical coding element; and a substance disposed on at least a portion of the surface of the substrate. The optical substrate may be made from a wide variety of materials. Importantly the multicomponent article may be a reagent particle wherein the substance includes a reagent. The reagent may be chosen from a wide range of biological macromolecules and oligomeric molecules, from any organic chemical or inorganic chemical compound including pharmaceutical agents and candidate pharmaceutical agents, modifications of any of them, and from any microbiological entity, a cell, and similar entities. In another aspect the invention provides a coded reagent library including a plurality of reagent particles described herein the preceding paragraphs. In another aspect the invention provides a method of preparing a multicomponent article including the steps of providing a diffraction grating-based encoded element, and binding a substance to a surface of said optical substrate. The invention also provides a method of preparing a coded reagent library. Additionally the invention provides a method of synthesizing a polynucleotide reagent on a multicomponent article.

### CROSS REFERENCES TO RELATED APPLICATIONS

The present application claims the benefit of. U.S. Provisional Applications Ser. No. 60/602,427, filed Aug. 18, 2004, entitled “Diffraction Grating-Based Encoded Element Having a Substance Disposed Thereon” (Docket No. CV-0076 PR); Ser. No. 60/611,205, filed Sep. 17, 2004, entitled “Diffraction Grating-Based Encoded Microparticles For Multiplexed Experiments” (Docket No. CV-0085 PR); and Ser. No. 60/611,676, filed Sep. 20, 2004, entitled “Diffraction Grating-Based Encoded Microparticles For Multiplexed Experiments” (Docket No. CV-0091 PR); and is a continuation-in-part of. U.S. patent application Ser. No. 10/661,234, filed Sep. 12, 2003, entitled “Diffraction Grating-Based Optical Identification Element”, (Docket No. CV-0038A); Ser. No. 10/661,031, filed Sep. 12, 2003, entitled “Diffraction Grating-Based Encoded Micro-particles for Multiplexed Experiments”, (Docket No. CV-0039A); Ser. No. 10/661,082, filed Sep. 12, 2003, entitled “Method and Apparatus for Labeling Using Diffraction Grating based Encoded Optical Identification Elements” (Docket No. CV-0040); Ser. No. 10/661,254 filed Sep. 12, 2003, entitled “Chemical Synthesis Using Diffraction Grating-Based Encoded Optical Elements” (Docket No. CV-0043); and Ser. No. 10/990,057 filed Nov. 15, 2004, entitled “Diffraction Grating-Based Encoded Particles for Multiplexed Experiments” (Docket No. CV-0094 US); all the above of which are incorporated herein by reference in their entirety.

The following cases contain subject matter related to that disclosed herein and are all incorporated herein by reference in their entirety: U.S. patent application Ser. No. 10/661,115, filed Sep. 12, 2003, entitled “Assay Stick” (Docket No. CV-0041); U.S. patent application Ser. No. 10/661,836, filed Sep. 12, 2003, entitled “Method And Apparatus For Aligning Microbeads In Order To Interrogate The Same” (Docket No. CV-0042); U.S. patent application Ser. No. 10/661,116, filed Sep. 12, 2003, entitled “Method Of Manufacturing Of A Diffraction Grating-Based Identification Element” (Docket No. CV-0044); and U.S. patent application Ser. No. 10/763,995, filed Jan. 22, 2004, entitled, “Hybrid Random Bead/Chip Based Microarray” (Docket No. CV-0054); and U.S. patent application, Ser. No. 10/956,791, filed Oct. 1, 2004, entitled “Optical Reader for Diffraction Grating-Based Encoded Optical Identification Elements” (Docket No. CV-0092 US).

### FIELD OF THE INVENTION

The present invention relates generally to a diffraction grating-based encoded element bearing any intended substance disposed thereon, useful in carrying out a broad range of processes, assays, and reactions. Somewhat more specifically, the elements may be particles that may be digitally encoded wherein the codes are readable in real time. The encoded articles may bear any intended substance disposed thereon, which may be bound to the element by noncovalent interactions or covalent bonding.

### BACKGROUND OF THE INVENTION

Multiplexed assay methods have been developed for use in the biotechnology industry and in contemporary laboratory research methods in recent years. Such processes depend for their success on the ability to multiplex parallel processes, assays or reactions, each of which takes place in a similar physical format, in a large collection of essentially identical systems. A common platform for such methods involves use of arrays. An array is typically created on a surface or substrate, divided into a gridwork of array points. Each locus in the array is separately addressable, and carries an identifiable probe for a process or assay, or an identifiable reagent for use in a chemical reaction. Indeed, in certain common arrays, unique probes are constructed at a particular locus by carrying out a unique sequence of chemical reactions in order to provide the desired final product.

A second commonly used modality for multiplexing processes, assays, or reactions employs individual particles or beads as the substrate for the unique probes or reagents. Particles have typically been suspended in a fluid for carrying out an assay, process, or reaction. They have then been segregated from the fluid, typically by gravitational settling, centrifugation, filtration, or via magnetic separation, for removing unneeded or exhausted reaction or assay components, and for washing free of previous reaction or assay compositions.

U.S. Pat. No. 6,579,729 states that in synthesizing combinatorial libraries the first coding system employed DNA as the code. This patent also states that a variety of other forms of encoding have been reported, including encoding with sequenceable bio-oligomers (e.g., oligonucleotides and peptides), and binary encoding employing a set of non-sequenceable electrophoric tagging molecules (Ohlmeyer et al. (1993) PNAS 90:10922-10926).

U.S. Pat. No. 6,586,190 relates to a high throughput multiplexed displacement assay which, it reports, incorporates the technology developed by Luminex Corporation, Austin Tex. (U.S. Pat. No. 5,981,180). This technology provides a collection of one hundred 5 um microspheres (“beads” or “particles”) individually labeled by a defined combination of two dyes in 100 different combinations. The bead identity, and therefore the identity of the analyte coupled to it, is determined by flow cytometry.

Still according to U.S. Pat. No. 6,586,190, an additional marker system has been referred to as the Quantum Dot™ (Quantum Dot Corporation, Palo Alto, Calif.). It reports that the Quantum Dot™ is a 2-10 nm CdSe crystal which, depending on its size, emits a single wavelength light ranging from ultraviolet to infrared when excited with UV light (Chan and Nie (1998), Science 281:2016-2018). In this approach, each bead, either a polymer bead or a glass bead, is identified by a defined population of quantum dots. The complexity of the quantum dot population defines the total number of distinct beads that can be encoded. For example, according to the above referenced patent, if five quantum dots are used, 242 beads can be encoded.

There are certain problems or disadvantages encountered with the multiplexed systems described above. In the case of arrays, one can only assay for those substances or components positively bound to a spot or locus in the array. In this sense, an array may be considered a “closed” system in that it is limited to planning or foresight employed in laying out the array. A process, assay, or reaction not conceived of cannot be probed by an array. In many arrays, an effort to create a high density of spots on the substrates imposes spatial limitations on the processes, assays or reactions that may be carried out at each spot. This is because it is difficult to resolve adjacent spots when preparing or using the array. This interferes with the ability of arrays effectively to conduct multiplexed processes

Particles employed to date have certain other disadvantages. Although each particle is unique, it may not be distinguishable from its partners without use of some kind of label. Particles may be labeled by dyes, for example, that may provide an analog signal related to coding an identity. Alternatively, a particle may carry a second chemical composition, in addition to the primary composition related to the process, assay, or reaction for which it is intended, that must be identified in order to learn the coding for the particle. Such chemical codes may require “off-line” or secondary processing in order to be identified, removing the versatility of manipulating the particle in “real time”, i.e., within the time frame of a process, assay, or reaction. In addition, certain known bead systems are constrained to a relatively small number of codes available.

From the above discussion it is apparent that there remains a need in multiplexed applications for open systems that are not limited or confined by numerical constraints as to the number of parallel processes, assays, or reactions that may be carried out. There remains a need to move away from array-based systems, since open systems afford distinct advantages and versatility with respect to handling and manipulation not provided by arrays. In addition, there is a strong need for an article that is encoded so that it can be unambiguously identified in real time. There is further a need for an article carrying a code that may be read using physical methods, and that do not rely on secondary determinations for reading the code. There is additionally a need for an article carrying a code that may be read in the real time of the assay experiment. There is further a need for an article that is conveniently employed in a wide range of biological, chemical and related biotechnological systems for conducting processes, assays, sensing, and reactions. In addition several needs for films, coatings, or membranes disposed on an encoded article exist. The present invention address these unmet needs.

### SUMMARY OF THE INVENTION

The present invention generally provides multicomponent articles of manufacture and methods of making and using them. In its broadest aspect, the invention provides a multicomponent article that includes
a) a diffraction grating-based encoded element, wherein the encoded element comprises an optical substrate having at least one surface and comprising at least one substrate material, said substrate having at least one diffraction grating disposed therein, said grating having a resultant refractive index variation at a grating location, said grating being embedded within a substantially single material of said substrate, said grating providing an output optical signal indicative of a code when illuminated by an incident light signal propagating from outside said substrate, said optical output signal being a result of passive, non-resonant scattering from said grating when illuminated by said incident light signal; and
b) a substance disposed on at least a portion of the surface of the substrate.

In various significant embodiments the multicomponent article is a particle. Additionally in certain embodiments the article may have an optical substrate made from materials including silica, a silicate, a glass, a semiconducting material, a ceramic material, a polymer, a resin, a rubber material, or a derivative thereof.

In further important embodiments the multicomponent article has a code that includes a plurality of bits, which in various embodiments are digital bits. Furthermore, each bit may have a plurality of states. In additional important embodiments the code includes a plurality of bits, each bit having a corresponding spatial location and each bit in the code having a value related to the intensity of the output optical signal originating from the spatial location of each bit.

In certain advantageous embodiments of the multicomponent article the substance may be bound to the substrate with a chemical bond, and in certain other embodiments the substance is bound to the substrate by noncovalent interactions. Additionally, in various advantageous embodiments the substance may be a coating, and in further advantageous embodiments the coating may be a lipid monolayer, a lipid bilayer, a gel, a polymer, or a resin.

In many important embodiments the multicomponent article is a reagent particle wherein the substance includes a reagent. In still additional important embodiments a single reagent is bound to a particle such that the particle code identifies the reagent. In highly important embodiments of the reagent particle, the reagent includes a nucleic acid; a polynucleotide; an oligonucleotide; a nucleotide; a nucleoside; a protein nucleic acid; an oligopeptide nucleic acid; a protein or fragment thereof; an enzyme or fragment thereof, a receptor or fragment thereof, a polypeptide; an oligopeptide; an amino acid; a derivative of any of them; a modification of any of them; a moiety chosen from among a synthetic organic molecule, a synthetic intermediate, a synthetic precursor, an antibiotic, a metabolite, a candidate pharmaceutical agent, a pharmaceutical agent; or a moiety chosen from among a virus particle or any portion thereof, a prokaryotic cell, a eukaryotic cell, a vertebrate cell, a mammalian cell, a human cell, any portion of the foregoing cells, a liposome, a vesicle, and a subcellular organelle.

In still further advantageous embodiments the reagent particle additionally includes a linker between a surface and a moiety including the reagent, and the reagent moiety includes a spacer between the linker and the reagent. In general, each of the linker and spacer may include any of a broad range of aliphatic, aromatic, heteroaromatic, alicyclic, aralkyl, heteroatomic, and heteroatom-containing moieties. Further, the linker may include silyl derivatives containing such moieties.

In a further aspect the invention provides a coded reagent library including a plurality of reagent particles described in the preceding paragraphs. In significant embodiments of the library, a first optical substrate bearing a first code is bound to a first reagent and a second substrate bearing a second code is bound to a second reagent; in alternative embodiments a plurality of reagents is bound to a particle.

In many important embodiments of the coded reagent library a reagent that is a component of the library includes a nucleic acid; a polynucleotide; an oligonucleotide; a nucleotide; a nucleoside; a protein nucleic acid; an oligopeptide nucleic acid; a protein or fragment thereof, an enzyme or fragment thereof, a receptor or fragment thereof, a polypeptide; an oligopeptide; an amino acid; a derivative of any of them; a modification of any of them; a moiety chosen from among a synthetic organic molecule, a synthetic intermediate, a synthetic precursor, an antibiotic, a metabolite, a candidate pharmaceutical agent, a pharmaceutical agent; or a moiety chosen from among a virus particle or any portion thereof, a prokaryotic cell, a eukaryotic cell, a vertebrate cell, a mammalian cell, a human cell, any portion of said cell, a liposome, a vesicle, and a subcellular organelle.

In still a further aspect the invention provides a first assay composition including a reagent particle as described as described above and a fluid medium. In significant embodiments the assay composition further includes an analyte contained in the fluid. In a related aspect the invention provides a second assay composition that includes a library of reagent particles described in the preceding paragraphs and a fluid medium. In significant embodiments the second assay composition further includes an analyte contained in the fluid.

In still an additional aspect the invention provides a method of preparing a multicomponent article including the steps of:
a) providing a diffraction grating-based encoded element, wherein the encoded element comprises an optical substrate having at least one surface and comprising at least one substrate material, said substrate having at least one diffraction grating disposed therein, said grating having a resultant refractive index variation at a grating location, said grating being embedded within a substantially single material of said substrate, said grating providing an output optical signal indicative of a code when illuminated by an incident light signal propagating from outside said substrate, said optical output signal being a result of passive, non-resonant scattering from said grating when illuminated by said incident light signal; and
b) binding a substance to at least a portion of a surface of said optical substrate.

In various advantageous embodiments of this method the article is a particle.

In additional important embodiments of this method the substance is a reagent. In additional important embodiments the method includes the additional steps of
a) identifying the code embedded in the particle, and
b) binding a single reagent to the substrate,
   thereby identifying the coded particle as bearing the reagent.

In yet additional important embodiments of this method, step b) further includes
b′) contacting the surface of the optical substrate with a first composition including a linker precursor, wherein the precursor includes a linker, under conditions whereby the linker precursor binds to the substrate; and
b″) contacting the linker precursor bound to the substrate with a second composition including a reagent precursor, wherein the precursor includes the reagent, under conditions whereby the reagent precursor binds the linker precursor;
thereby binding the reagent to the article.

In alternative important embodiments of this method, step b) further includes
b′) combining a linker precursor and a reagent precursor, wherein the reagent precursor includes the reagent, under conditions whereby the reagent precursor binds the linker precursor to form a conjugate; and
b″) contacting the surface of the optical substrate with a composition including the conjugate, under conditions whereby the linker moiety included within the conjugate binds to the substrate;
thereby binding the reagent to the article.

In still further important embodiments of this method the substrate includes silica, a silicate, a glass, a semiconducting material, a ceramic material, a polymer, a resin, a rubber material, or a derivative thereof

In still further advantageous embodiments of the method, each of the linker and spacer may include any of a broad range of aliphatic, aromatic, heteroaromatic, alicyclic, aralkyl, heteroatomic, and heteroatom-containing moieties, and further may include silyl derivatives containing such moieties.

In still additional advantageous embodiments of the method the reagent includes a nucleic acid; a polynucleotide; an oligonucleotide; a nucleotide; a nucleoside; a protein nucleic acid; an oligopeptide nucleic acid; a protein or fragment thereof; an enzyme or fragment thereof, a receptor or fragment thereof, a polypeptide; an oligopeptide; an amino acid; a derivative of any of them; a modification of any of them; a moiety chosen from among a synthetic organic molecule, a synthetic intermediate, a synthetic precursor, an antibiotic, a metabolite, a candidate pharmaceutical agent, a pharmaceutical agent; or a moiety chosen from among a virus particle or any portion thereof, a prokaryotic cell, a eukaryotic cell, a vertebrate cell, a mammalian cell, a human cell, any portion of said cell, a liposome, a vesicle, and a subcellular organelle.

In still a further aspect the invention provides a method of preparing a coded reagent library including the steps of:
a) providing a plurality of diffraction grating-based encoded elements, wherein each encoded element includes an optical substrate having at least one surface and including at least one substrate material, said substrate having at least one diffraction grating disposed therein, said grating having a resultant refractive index variation at a grating location effective to provide an optical code therein, said grating being embedded within a substantially single substrate material, said grating providing an output optical signal indicative of the code when illuminated by an incident light signal; and
b) binding a reagent to at least a portion of the optical substrate of each diffraction grating-based encoded element provided in step a);
   thereby providing a coded reagent library.

In important embodiments the method of preparing a coded reagent library further includes the steps of
a′) in step a) maintaining a first optical substrate bearing a first code separate from a second substrate bearing a second code, and
b′) in step b) binding a first reagent to the first optical substrate and a second reagent to the second optical substrate.

In yet a further aspect the invention provides a method of synthesizing a polynucleotide reagent including the steps of:
a) providing a diffraction grating-based encoded element, wherein the encoded element includes an optical substrate having at least one surface and including at least one substrate material, said substrate having at least one diffraction grating disposed therein, said grating having a resultant refractive index variation at a grating location effective to provide an optical code therein, said grating being embedded within a substantially single substrate material, said grating providing an output optical signal indicative of the code when illuminated by an incident light signal; and
b) binding a first nucleotide to at least a portion of a surface of said optical substrate; and
c) extending the nucleotide sequence by sequential addition reactions;
thereby synthesizing a polynucleotide bound to a multicomponent article.

In significant embodiments the method of synthesizing a polynucleotide reagent further including the steps of:
a) identifying the code embedded in the particle, and
b) identifying the sequence of the polynucleotide,
thereby identifying the coded particle as bearing the polynucleotide.

In a related aspect the invention provides a method of synthesizing a polynucleotide reagent to provide a multicomponent article including the steps of:
a) providing a diffraction grating-based encoded element, wherein the encoded element includes an optical substrate having at least one surface and including at least one substrate material, said substrate having at least one diffraction grating disposed therein, said grating having a resultant refractive index variation at a grating location effective to provide an optical code therein, said grating being embedded within a substantially single substrate material, said grating providing an output optical signal indicative of the code when illuminated by an incident light signal; and
b) binding a polynucleotide to at least a portion of a surface of said optical substrate.

In yet an additional related aspect the invention provides a method of synthesizing a coded polynucleotide reagent library including the steps of:
a) providing a plurality of diffraction grating-based encoded elements, wherein each encoded element includes an optical substrate having at least one surface and including at least one substrate material, said substrate having at least one diffraction grating disposed therein, said grating having a resultant refractive index variation at a grating location effective to provide an optical code therein, said grating being embedded within a substantially single substrate material, said grating providing an output optical signal indicative of the code when illuminated by an incident light signal; and
b) binding a first nucleotide reagent to at least a portion of the optical substrate of each diffraction grating-based encoded element provided in step a); and
c) extending the nucleotide sequence bound to each optical substrate by sequential addition reactions;
thereby providing a coded polynucleotide reagent library.

In still a further related aspect the invention provides a method of synthesizing a coded polynucleotide reagent library including the steps of:
a) providing a plurality of diffraction grating-based encoded elements, wherein each encoded element includes an optical substrate having at least one surface and including at least one substrate material, said substrate having at least one diffraction grating disposed therein, said grating having a resultant refractive index variation at a grating location effective to provide an optical code therein, said grating being embedded within a substantially single substrate material, said grating providing an output optical signal indicative of the code when illuminated by an incident light signal; and
b) binding a polynucleotide reagent to at least a portion of the optical substrate of each diffraction grating-based encoded element provided in step a);
thereby providing a coded polynucleotide reagent library.

### BRIEF DESCRIPTION OF THE FIGURES

FIG. 1 is a side view of an embodiment of a diffraction grating-based encoded element, in accordance with the present invention.

FIG. 2 is a top level optical schematic for reading a code in an a diffraction grating-based encoded element, in accordance with the present invention.

FIG. 3 is a flow chart of the method of attaching a substance to a diffraction grating-based encoded element, performing an assay and analyzing the diffraction grating-based encoded element, in accordance with the present invention.

FIG. 4 is a side view of a diffraction grating-based encoded element having a substance attached to the outer surface thereof, in accordance with the present invention.

FIG. 5 is a side view of a diffraction grating-based encoded element having a substance attached to the outer surface thereof, in accordance with the present invention.

FIG. 6 is a schematic view of a plurality of diffraction grating-based encoded elements having different identification or codes and coated with different probe substances disposed in a cell with a plurality of test substances, in accordance with the present invention.

FIG. 7 is a schematic view of plurality of diffraction grating-based encoded elements after the performance of an assay, aligned in a plurality of grooves, disposed on a substrate, and a bead detector that scans each diffraction grating-based encoded element for determining the code and fluorescence of each diffraction grating-based encoded element, in accordance with the present invention.

FIG. 8 is a side view of a diffraction grating-based encoded element after the performance of an assay, and a bead detector that determines the code and fluorescence of the diffraction grating-based encoded element, in accordance with the present invention.

FIG. 9 is a side view of a diffraction grating-based encoded element after the performance of an assay, and a more detailed view of a bead detector that determines the code and fluorescence of the diffraction grating-based encoded element, in accordance with the present invention.

FIG. 10 is an optical schematic for reading a code in a diffraction grating-based encoded element, in accordance with the present invention.

FIG. 11 is an image of a code on a CCD camera from a diffraction grating-based encoded element, in accordance with the present invention.

FIG. 12 is a graph showing an digital representation of bits in a code in a diffraction grating-based encoded element, in accordance with the present invention.

FIG. 13 illustrations (a)-(c) show images of digital codes on a CCD camera, in accordance with the present invention.

FIG. 14 illustrations (a)-(d) show graphs of different refractive index pitches and a summation graph, in accordance with the present invention.

FIG. 15 is an alternative optical schematic for reading a code in a diffraction grating-based encoded element, in accordance with the present invention.

FIG. 16 illustrations (a)-(b) are graphs of reflection and transmission wavelength spectrum for a diffraction grating-based encoded element, in accordance with the present invention.

FIGS. 17-18 are side views of a thin grating for a diffraction grating-based encoded element, in accordance with the present invention.

FIG. 19 is a perspective view showing azimuthal multiplexing of a thin grating for a diffraction grating-based encoded element, in accordance with the present invention.

FIG. 20 is side view of a blazed grating for a diffraction grating-based encoded element, in accordance with the present invention.

FIG. 21 is a graph of a plurality of states for each bit in a code for a diffraction grating-based encoded element, in accordance with the present invention.

FIG. 22 is a side view of a diffraction grating-based encoded element where light is incident on an end face, in accordance with the present invention.

FIGS. 23-24 are side views of a diffraction grating-based encoded element where light is incident on an end face, in accordance with the present invention.

FIGS. 25, illustrations (a)-(c) are side views of a diffraction grating-based encoded element having a blazed grating, in accordance with the present invention.

FIG. 26 is a side view of a diffraction grating-based encoded element having a coating, in accordance with the present invention.

FIG. 27 is a side view of whole and partitioned diffraction grating-based encoded element, in accordance with the present invention.

FIG. 28 is a side view of a diffraction grating-based encoded element having a grating across an entire dimension, in accordance with the present invention.

FIG. 29, illustrations (a)-(c), are perspective views of alternative embodiments for a diffraction grating-based encoded element, in accordance with the present invention.

FIG. 30, illustrations (a)-(b), are perspective views of a diffraction grating-based encoded element having multiple grating locations, in accordance with the present invention.

FIG. 31, is a perspective view of an alternative embodiment for a diffraction grating-based encoded element, in accordance with the present invention.

FIG. 32 is a view a diffraction grating-based encoded element having a plurality of gratings located rotationally around the diffraction grating-based encoded element, in accordance with the present invention.

FIG. 33 illustrations (a)-(e) show various geometries of a diffraction grating-based encoded element that may have holes therein, in accordance with the present invention.

FIG. 34 illustrations (a)-(c) show various geometries of a diffraction grating-based encoded element that may have teeth thereon, in accordance with the present invention.

FIG. 35 illustrations (a)-(c) show various geometries of a diffraction grating-based encoded element, in accordance with the present invention.

FIG. 36 is a side view a diffraction grating-based encoded element having a reflective coating thereon, in accordance with the present invention.

FIG. 37 illustrations (a)-(b) are side views of a diffraction grating-based encoded element polarized along an electric or magnetic field, in accordance with the present invention.

FIG. 38 is a diagrammatic representation of particular embodiments of a multicomponent article of the invention.

FIG. 39 is a diagrammatic representation of noncovalent binding of a reagent to a diffraction grating-based encoded element by means of electrostatic interactions.

FIG. 40 is a diagrammatic representation of a reagent-bearing article of the present invention. Panel a) represents incorporation of a bifunctional linker. Panel b) represents incorporation of a trifunctional linker.

FIG. 41 is a diagrammatic representation of an embodiment of a method of synthesizing a reagent-bearing article of the invention. Panel a) depicts the first reaction step. Panel b)depicts the second reaction step. The symbols are the same as those used in FIG. 40.

FIG. 42 is, a diagrammatic representation of an embodiment of a method of synthesizing a reagent-bearing article of the invention. Panel a) depicts the first reaction step. Panel b)depicts the second reaction step. The symbols are the same as those used in FIG. 40.

FIG. 43 is a representation of certain embodiments showing linker precursors contacting a silica surface.

FIG. 44 illustrates a two-step reaction employed to bind an oligonucleotide reagent to a silica substrate.

FIG. 45 illustrates a two-step reaction employed to bind an oligonucleotide reagent to a silica substrate.

FIG. 46 illustrates a two-step reaction employed to bind a nucleotide reagent to a silica substrate.

FIG. 47 illustrates a two-step reaction employed to bind a nucleotide reagent to a silica substrate.

### DETAILED DESCRIPTION OF THE INVENTION

All patents, patent application publications, and patent applications identified herein are incorporated by reference in their entireties, as if appearing herein verbatim. All technical publications identified herein are also incorporated by reference.

In its most general aspect the present invention provides a diffraction grating-based encoded element wherein the element includes an optical substrate and a surface, at least a portion of the surface thereof having a substance or a material disposed thereon. The nature of the substance or material broadly encompasses a molecular, supramolecular, polymeric, resinous, plastic or rubber structure bound to at least a portion of the surface. The substance accomplishes a broad range of intended objectives such as serving as an anchoring structure for binding additional components, masking a portion of the surface of the article, altering the hydrodynamic flow properties thereof, altering the physical properties thereof, carrying out processes, assays, sensing, and reactions; and so forth. In various embodiments of the present invention the substance or material includes a reagent.

In describing various embodiments of the invention use of the modifiers “important”, “significant”, “advantageous”, and related words, are intended to be synonymous with each other. These words are not intended to indicate that any particular embodiment is more or less important than another.

As used herein “a diffraction grating-based encoded element having a substance disposed thereon” and similar terms and phrases relates to any construct of the invention including an optically encoded diffraction grating for identification of the element and a substance or material adhered or bonded thereto. As used herein, the phrase “a diffraction grating-based encoded element having a substance disposed thereon”, and similar terms and phrases, may be abbreviated to or substituted by “multicomponent article”, and similar terms and phrases. The phrase “a diffraction grating-based encoded element” may be substituted herein by similar terms and phrases, including by way of nonlimiting example “optically encoded element”, “grating encoded element”, “optical element”, and so forth. The terms “diffraction grating-based encoded micro-particle”, “diffraction grating-based encoded element”, and “optical identification element” have been used in related, co-owned U.S. patent applications, including U.S. Ser. No. 10,645,686 filed Aug. 20, 2003 to describe identical or similar objects.

The optically encoded element is broadly understood as having no prescribed size or shape. Its size as measured by a largest dimension thereof may range from as large as 1 mm, or as large as 1 m, or even larger, to as small as 1 μm, or as small as 1 nm, or even smaller. Its shape is provided so as to carry out a particular function or purpose in optimal fashion.

In advantageous embodiments a diffraction grating-based encoded element is fabricated as a particle. Accordingly, the present invention provides a diffraction grating-based encoded particle to which is bound one or more substances for carrying out an unrestricted variety of physical, chemical or biological processes, assays, sensing, or reactions. The phrase “diffraction grating-based encoded particle” may be substituted herein by similar terms and phrases, including by way of nonlimiting example “optically encoded particle”, “grating encoded particle”, “optical particle”, and so forth. Because the number of particles employed in any one determination is in principle without limit, the particles are eminently suitable for use in multiplexed processes, i.e., in high throughput systems. The particles carry an embedded code, which in advantageous embodiments is a digital code, and which is rapidly readable by optical instrumentation so that the identity of the particle is immediately available, even if its physical location in an particle is random. Likewise, there is a one-to-one correspondence between the embedded code and the identity of the substance that the particle carries; in other embodiments the identity of the substance is determined, thus establishing the code-substance correspondence. The particles are inexpensive to manufacture and the identification codes are easy and inexpensive to imprint into the particles. In this regard, since each particle is encoded, its route through a microfluidic system, such as a flow sorter, is readily controllable by programmable fluid switches or flow controls. Establishment of a code-substance correspondence permits the particles of the invention to be used in any of a broad range of processes, assays, sensing, and reactions. The substances bound to the particles may be, without limitation, any biological particle such as a cell or a virus particle or fragment thereof, a biological macromolecule or fragment thereof, or any biological metabolite, or any low molecular weight compound. These may be screened in high throughput systems for ability to bind, react with, or identify a target substance in a sample. Substances bound to particles of the invention may be also serve as intermediates in a synthetic reaction scheme to synthesize a desired substance in situ, bound to the particles. The above discussion identifies exemplary uses for the particles of the invention, without intending to limit such uses in any way.

As used herein the terms “diffraction grating-based encoded particle”, “particle”, “bead”, “microparticle”, “microbead”, and similar terms and phrases are used synonymously to designate a relatively small construct whose size is adequate both to contain upon it or within it a code readable by a suitable device, and to have bound to it sufficient reagent material to serve the functions and purposes of the invention. The term “particle” or any of its synonyms is used herein as a label. None of these terms restricts any embodiment or application of the present invention to certain dimensions, materials and/or geometries.

In favorable embodiments of a particle the code is a digital code. Without limiting the scope of the invention, a particle of the invention may range in a longest dimension from as small as a fraction of a micrometer or smaller to as large as 1 millimeter or several millimeters, or even larger. Attributes of a suitable particle include ease of handling in various laboratory and assay formats, ease of applying or embedding a code, ease of binding or attaching a reagent, and ease of determining both the embedded code and the attributes of the reagent. A further attribute of certain embodiments of a particle of the invention is its ease of handling in microfluidic flow systems. In view of the above considerations, the overall shape of a particle of the invention is not circumscribed or limited by any description herein, but rather a particle may be fabricated optimally to accomplish objectives such as those mentioned above. Likewise details of the shape, cross section, and other descriptions of the three-dimensional geometry of a particle are not limited by any description herein. In general, any equivalent of a particular particle described herein is intended to fall within the scope of the claims.

As used herein the terms “substrate”, “optical substrate”, and similar terms and phrases relate to at least a major component, if not the entire component, that constitutes an optically encoded element employed in the invention. The substrate has applied to or embedded within its structure a code, including a digital code, that provides the coding for the article. In many embodiments of the invention an instrumental reader employing optical radiation is used to read the code, including a digital code (see below). In those cases the substrate is an “optical substrate” as used herein, having optical transparency or analogous attributes that adapt it for reading the code in the practice of the invention. Any of several functionally equivalent materials or compositions may be employed to provide a substrate or an optical substrate of the present invention.

As used herein the terms “code”, “encoded” and similar terms and phrases are broadly intended to relate to a readable code applied on or embedded within an article of the invention such that a given article is identifiable by its code. The code is comprised of one or more positions in a series of positions, wherein each position in the code bears a permitted value for the code being employed. In many important embodiments disclosed herein the code is a digital code, wherein each position of the code assumes only allowed discrete values. If the code is binary (base 2), one of two values occurs at each position; likewise if the code has base n, the value at a particular position in the series is one of the n discrete values that characterizes the base n code. The series of positions in the code is readable by suitable instrumentation employed in the practice of the invention, thereby providing the complete code that identifies the article; advantageously the code is readable in “real time” while an article is being employed in a process, assay, or reaction. In general, any equivalent of a particular code system described herein is intended to fall within the designation of a code of the invention, including any digital code, and to fall within the scope of the claims.

As used herein the term “optical coding element” and similar terms and phrases relates to a series of encoded positions applied to or embedded within a substrate. An optical coding element is readable by instrumentation employing, by way of nonlimiting example, any instrument or reader capable of interrogating the code. An example of such a reader is disclosed in commonly owned U.S. patent application, Ser. No. 10/956,791, entitled “Optical Reader for Diffraction Grating-Based Encoded Optical Identification Elements”, filed Oct. 1, 2004 (CyVera Docket No. CV-0092 US). The series of positions in the optical coding element define a code for the article on which or in which the element appears. Any equivalent encoded optical coding element, including a digital optical coding element, is encompassed within the scope of the present invention.

As used herein the terms “substance” or “material” and similar terms and phrases relate broadly to any material entity bound to at least a portion of the surface of the diffraction grating-based encoded element to provide a multicomponent article of the invention. The substance or material may be bound to a surface of the article by adhesion or adherence, including any noncovalent interaction. Alternatively the substance or material may be bound covalently to reactive groups included on the surface of the optically encoded element.

As used herein the term “reagent” and similar terms and phrases is employed broadly to designate a chemical substance that is a substance of interest in the invention, and that is bound or coupled to an optically encoded element to form a multicomponent article of the invention. The term “reagent” is intended to be synonymous with the terms “reactant”, “ligand”, “probe”, “active agent”, and related terms and phrases, and may be used herein synonymously with them. A particular usage may depend on a particular context. In general, a particular reagent bound or coupled to an optically encoded element accomplishes a particular objective of the invention in a process, assay or reaction in which the reagent takes part. In important uses any reagent of the invention may be one of the two members of a specific binding pair or a specific reactant pair. In certain circumstances more than two reagents engage in a specific binding interaction or a specific reactant process, in which case the synonymous designations “specific binding set” or “specific reactant set” may be employed.

The members of a specific binding pair or a specific binding set may interact by noncovalent interactions only; specificity is determined by the spatial distribution and nature of the noncovalent interactions determining the binding process. In such cases a reagent may synonymously be designated a “ligand” or a “probe”. The cognate member(s) of the binding pair or binding set may be designated by terms such as “receptor”, “target”, and similar terms and phrases known to workers of skill in fields related to the present invention. In general, when a reagent probe is bound to an optically encoded element, any specific target that is a cognate of the probe that is present in a composition in which the encoded element is suspended may bind to the probe; and likewise for a bound ligand and its cognate receptor.

The reagent of a multicomponent article may additionally be a sensing element. The sensing element is sensitive to one or more environmental parameters, and provides an output indicative of the state of the environmental parameter(s).

The reagent of a multicomponent article may also be a reactant employed in a chemical synthesis to create a new chemical substance by reaction with one or more cognate reactants. The cognates are contained within a composition in which the reagent article is suspended. In this case the specific reactant pair or the specific reactant set combine by forming new covalent bonds to generate the new chemical substance as the product of the reaction.

In general the designations “reagent”, “reactant”, “ligand”, “probe”, “active agent”, and related terms and phrases are understood by workers of skill in fields related to the present invention to encompass the full breadth of chemical substances to be bound in a multicomponent article of the invention without limitation.

As used herein, the term “library” shall mean a plurality, set, group or collection, and the terms “reagent library”, “DNA library”, “polynucleotide library”, “protein library”, “combinatorial library”, and similar terms and phrases relate to a plurality, a set, a group, or a collection, of reagents, DNA molecules, polynucleotides, proteins, combinatorial chemicals and the like. As used herein, the terms “reagent library”, “DNA library”, “polynucleotide library”, “protein library”, “combinatorial library”, and similar terms and phrases relate further to members of the respective libraries being bound to a plurality of multicomponent articles, or to a plurality of particles, of the invention, as set forth in detail herein. Any equivalent usage of “library” as understood by a worker of skill in fields related to the present invention are also encompassed within the term.

As used herein the terms “moiety”, “radical”, “fragment”, “grouping”, and similar terms and phrases, are synonymously related to a chemical entity that is a portion or a fragment of a larger chemical entity or chemical compound. In general a moiety, radical, or grouping has at least one free chemical bond. The free chemical bond binds the moiety, radical, or grouping to a cognate portion of the larger chemical element.

As used herein a single line “—” between two chemical moieties, or emanating from a particular chemical moiety, designates a covalent chemical bond.

When used herein the standard chemical symbols for the chemical elements represent those elements (see, for example, Handbook of Chemistry and Physics, CRC Press, Cleveland, Ohio, 1972; inside back cover). CAPITAL LETTERS that are not standard symbols for any chemical element are used to identify generic or specific chemical moieties as described herein in context.

As used herein the term “linker” and similar terms is related to a chemical moiety interposed between the surface of an article, such as a reagent particle, and a reagent-bearing moiety. In general a linker moiety links a particle to a reagent-bearing moiety. Thus in general the linker precursor used to incorporate the linker into the reagent particle of the invention is at least bifunctional, and may have a functionality of 3 or greater. In addition a linker may serve additional functions such as extending the reagent away from close proximity to the surface of the particle to permit ease of binding or reaction of the reagent to its cognate binding member(s). The chemical description of certain embodiments of a linker is provided below. In general any equivalent moiety serving to adapt the reagent-bearing moiety to the particle surface is considered within the scope of the present invention.

As used herein the term “spacer” and similar terms is related to a fragment of a reagent-bearing moiety that serves to bind the reagent to the linker. The properties of a spacer are similar to those of a linker, but as used herein the two terms are distinguished as defined in these paragraphs and elsewhere in this specification. Thus a spacer precursor is likewise at least bifunctional and may have a functionality of 3 or higher. A bifunctional spacer precursor is designed to form a covalent bond with the linker, on the one hand, and with the reagent on the other. A spacer with a higher functionality than two may, for example, bind to more than one linker, or to more than one reagent. In general any equivalent moiety serving to adapt the reagent to the linker is considered within the scope of the present invention.

As used herein the term “heteroatom” relates to a divalent O or S atom, or to a divalent NR grouping, wherein R may be H, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino.

A Diffraction Grating-Based Encoded Element

An optically encoded element of the invention is constituted at least in a significant portion thereof, if not entirely, of a substrate. In important embodiments the substrate is an optical substrate. In important examples the substrate is constructed of a silica or a silicate glass material. Silica or silicates have Si—O— or Si—OH groupings on the surface, which may be utilized as a reactive grouping for binding a linker. A variety of reagents for binding to silica or silicate glasses is available from Gelest, Inc. (Morrisville, Pa.) as well as from other vendors. Certain modalities for derivatizing substrates such as silica are presented in U.S. Pat. Nos. 6,444,268 B2 and 6,3219,674 B1. Derivatization prepares a substrate for binding a reagent. Additionally a substrate may be bound by noncovalent interactions with the substrate.

Alternatively the substrate may be constituted of a polymer or resin. The polymer or resin may adsorb a reagent by noncovalent interaction, or it may have, or be derivatized to bear, substituent groups on the surface of the substrate to which a linker may be bound or to which a reagent may be bound directly. Nonlimiting examples of polymers useful in preparing bead substrates include homopolymers and copolymers of polystyrene and derivatives thereof, polyamides such as various nylons, polyvinyl alcohol resins, polyacrylates (including esters and crosslinked resins thereof), polymethacrylates (including esters and crosslinked resins thereof), polyacrylamides including crosslinked resins thereof, polycarbonates, polyesters including polycolactide-glycolides, latexes, and several other polymers, and resins known in the art. Many polymers and resins are known as supports in various solid phase assays, processes and synthetic reactions. A general set of definitions of various categories of polymers useful as optical substrates of the invention is given in Pure Appl. Chem., Vol. 68, No.12, pp. 2287-2311, 1996.

As an example, U.S. Pat. No. 6,607,921 states that representative supports for various bound reagents include, by way of illustration, polymeric (resin) beads, polymeric gels, glass beads, silica chips and capillaries, agarose, diatomaceous earths, pulp, and the like. The patent identifies preferred solid as those having minimal non-specific binding properties, and further as derivatized porous polystyrene-divinylbenzene polymer beads, such as POROS beads (available from Perseptive Biosystems, Framingham, Mass.).

Furthermore, an optical substrate may have a compounded structure composed of more than one substance or material. As a nonlimiting example, a diffraction grating-based encoded element may have an inner component composed of one substance, and be coated with a different substance. Thus, an inner component may be made of silica or a glass, and may be coated with a polymer material. In the case of complex structures, a surface for binding a reagent is an outermost surface.

A diffraction grating-based encoded element provided by the present invention generally includes an optical substrate having at least one surface. The optical substrate includes an optical coding element providing an output signal corresponding to a code, such as a digital code, embedded therein when the coding element is illuminated with incident radiation. In significant embodiments of the invention the optical coding element comprises an optical diffraction grating. In addition, the reagent-bearing article, such as a reagent particle, includes a reagent bound to a surface of the substrate.

As noted above, common embodiments of the invention provide an element in the form of a particle and the substance is a reagent bound to the particle. Advantageously the reagent is bound via a linker interposed between a surface of the particle and a reagent moiety that includes the reagent as part of its structure. Additionally the reagent moiety may include a spacer placed between the linker and the reagent.

Reagent Particle with Optical Substrate and Grating

An important embodiment of a reagent particle of the invention is represented in FIG. 1. A diffraction grating-based encoded element 8 (or a diffraction grating-based encoded element) comprises a known optical substrate 10, having an optical diffraction grating 12 disposed (or written, impressed, embedded, imprinted, etched, grown, deposited or otherwise formed) in the volume of or on a surface of a substrate 10. The grating 12 is a periodic or aperiodic variation in the effective refractive index and/or effective optical absorption of at least a portion of the substrate 10.

The diffraction grating-based encoded element 8 described herein is similar to that described in Copending patent application Ser. No. 10/645,686 filed Aug. 20, 2003 (U.S. patent application Publication 200400759007; CyVera Docket No. CV-0038A), which is incorporated herein by reference in its entirety.

In particular, the substrate 10 has an inner region 20 where the grating 12 is located. The inner region 20 may be photosensitive to allow the writing or impressing of the grating 12. The substrate 10 has an outer region 18, which does not have the grating 12 therein.

The grating 12 is a combination of one or more individual spatial periodic sinusoidal variations (or components) in the refractive index that are collocated at substantially the same location on the substrate 10 along the length of the grating region 20, each having a spatial period (or pitch) Λ. The resultant combination of these individual pitches is the grating 12, comprising spatial periods (Λ1-Λn) each representing a bit in the code. Thus, the grating 12 represents a unique optically readable code, made up of bits, where a bit corresponds to a unique pitch Λ within the grating 12. Accordingly, for a digital binary (0-1) code, the code is determined by which spatial periods (Λ1-Λn) exist (or do not exist) in a given composite grating 12. The code or bits may also be determined by additional parameters (or additional degrees of multiplexing), and other numerical bases for the code may be used, as discussed herein and/or in the aforementioned patent application.

The grating 12 may also be referred to herein as a composite or collocated grating. Also, the grating 12 may be referred to as a “hologram”, as the grating 12 transforms, translates, or filters an input optical signal to a predetermined desired optical output pattern or signal.

In certain significant embodiments the substrate 10 has an outer diameter D1 and comprises silica glass (SiO₂) having the appropriate chemical composition to allow the grating 12 to be disposed therein or thereon. As noted above, other materials for the optical substrate 10 may be used if desired. For example, the substrate 10 may be made of any glass, e.g., silica, phosphate glass, borosilicate glass, or other glasses, or made of glass and a polymer, resin or plastic, or solely of a polymer, resin, or plastic. Regardless of the material used to fabricate the particle, the region therein in which the digital code is applied, such as the inner region 20 in FIG. 1, may be photosensitive to allow the writing or impressing of the grating 12.

In addition to the materials discussed herein, the substrate 10 may be made of chalcogenide, a chalcogenide-based material, selenide, and/or a selenide-based material, or the like, such as that described in U.S. Pat. No. 5,846,889 to Harbison et al, and/or U.S. Pat. No. 6,195,483 to Moon et al, each of which are incorporated herein by reference in their entirety. However, any material that is capable of having a diffraction grating disposed therein may be used.

The grating 12 may be impressed in the substrate 10 by any technique for writing, impressing, embedding, imprinting, or otherwise forming a diffraction grating in the volume of or on a surface of a substrate 10. Nonlimiting examples of some known techniques are described in U.S. Pat. Nos. 4,725,110 and 4,807,950, entitled “Method for Impressing Gratings Within Fiber Optics”, to Glenn et al; and U.S. Pat. No. 5,388,173, entitled “Method and Particle for Forming Aperiodic Gratings in Optical Fibers”, to Glenn, respectively, and U.S. Pat. No. 5,367,588, entitled “Method of Fabricating Bragg Gratings Using a Silica Glass Phase Grating Mask and Mask Used by Same”, to Hill, and U.S. Pat. No. 3,916,182, entitled “Periodic Dielectric Waveguide Filter”, Dabby et al, and U.S. Pat. No. 3,891,302, entitled “Method of Filtering Modes in Optical Waveguides”, to Dabby et al, which are all incorporated herein by in their entireties.

Alternatively, instead of the grating 12 being impressed within the substrate material, the grating 12 may be partially or totally created by etching or otherwise altering the outer surface geometry of the substrate to create a corrugated or varying surface geometry of the substrate, such as is described in U.S. Pat. No. 3,891,302, entitled “Method of Filtering Modes in Optical Waveguides”, to Dabby et al, which is incorporated herein by reference to the extent necessary to understand the present invention, provided the resultant optical refractive profile for the desired code is created.

Further, alternatively, the grating 12 may be made by depositing dielectric layers onto the substrate, similar to the way a known thin film filter is created, so as to create the desired resultant optical refractive profile for the desired code.

The optical substrate 10 with the grating 12 has a length L and an outer diameter D1, and the inner region 20 diameter D. The length L can range from very small “microbeads” (or microelements, micro-particles, or encoded particles), about 1-1000 microns or smaller, to larger “macroelements” for larger applications (about 1.0-1000 mm or greater). In addition, the outer dimension D1 can range from small (less than 1000 microns) to large (1.0-1000 mm and greater). The diameter D of the inner region 20 where the grating 12 may be located may be any value within the outer dimension D1 provided the performance and functional requirements are met for the desired application. For example, the diameter D can range from about 0.1 micron (or smaller) to the outer dimension D1 (in which case there would be only one region), depending on the application and performance requirements as discussed herein and in the referenced co-pending patent applications. Other dimensions and lengths for the substrate 10 and the grating 12, or portions thereof, may be used.

The grating 12 may have a length Lg of about the length L of the substrate 10. Alternatively, the length Lg of the grating 12 may be shorter than the total length L of the substrate 10.

The outer region 18 is made of pure silica (SiO₂) and has a refractive index n2 of about 1.458 (at a wavelength of about 1553 nm), and the inner grating region 20 of the substrate 10 has dopants, such as germanium and/or boron, to provide a refractive index n1 of about 1.453, which is less than that of outer region 18 by about 0.005. Other indices of refraction n1,n2 for the grating region 20 and the outer region 18, respectively, may be used, if desired, provided the grating 12 can be impressed in the desired grating region 20. For example, the grating region 20 may have an index of refraction that is larger than that of the outer region 18 or grating region 20 may have the same index of refraction as the outer region 18 if desired.

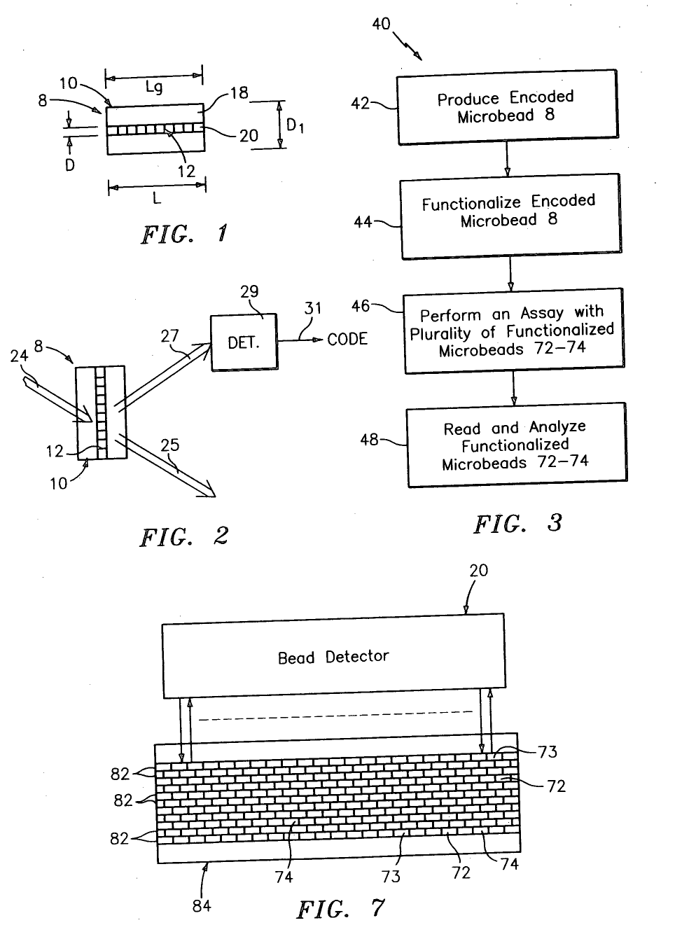

Referring to FIG. 2, an incident light 24 of a wavelength λ, e.g., 532 nm from a known frequency doubled Nd:YAG laser or 632 nm from a known Helium-Neon laser, is incident on the grating 12 in the substrate 10. Any other input wavelength λ can be used if desired provided λ is within the optical transmission range of the substrate (discussed more herein and/or in the aforementioned patent application). A portion of the input light 24 passes straight through the grating 12, as indicated by a line 25. The remainder of the input light 24 is reflected by the grating 12, as indicated by a line 27 and provided to a detector 29. The output light 27 may be a plurality of beams, each having the same wavelength λ as the input wavelength λ and each having a different output angle indicative of the pitches (Λ1-Λn) existing in the grating 12. Alternatively, the input light 24 may be a plurality of wavelengths and the output light 27 may have a plurality of wavelengths indicative of the pitches (Λ1-Λn) existing in the grating 12. Alternatively, the output light may be a combination of wavelengths and output angles. The above techniques are discussed in more detail herein and/or in the aforementioned patent application.

The detector 29 has the necessary optics, electronics, software and/or firmware to perform the functions described herein. In particular, the detector reads the optical signal 27 diffracted or reflected from the grating 12 and determines the code based on the pitches present or the optical pattern, as discussed more herein or in the aforementioned patent application. An output signal indicative of the code is provided on a line 31.

Optically Encoded Multicomponent Article

A multicomponent article of the invention may be constructed wherein separate zones or regions of the particle are fabricated of the same or different materials. In one embodiment of a multicomponent article, a core material may be coated with a second material. For example a polymeric coating may be applied to a core material. Coating can be accomplished by immersing a substrate of the invention in a composition comprising a polymer, and subsequently drying the substrate, leaving a coating of the polymer on the outside surface. As a second example, a polymeric coating can be applied by anchoring an active monomer moiety to a substrate. The resulting particle is immersed in a composition comprising additional polymerizable monomers, and polymerization is initiated. The resulting particle has a coating comprised of the polymerized polymer.

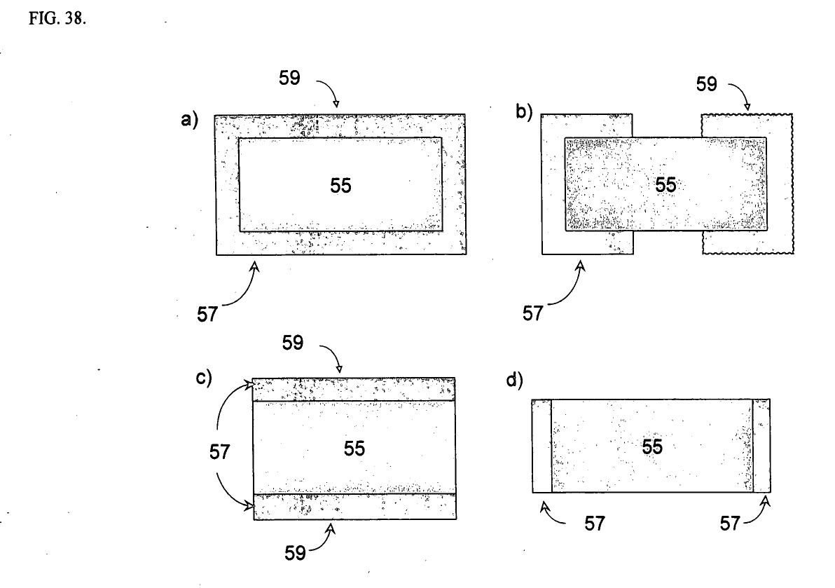

Many embodiments of a multicomponent article may be envisioned. Particular embodiments are schematically illustrated, by way of nonlimiting example, in FIG. 38. Although other configurations are consistent with the representations in FIG. 38, for purposes of discussion it may be supposed that the views are of a cylindrical particle viewed in cross section from the side, i.e., parallel to the cylindrical axis. In all the panels, the optical substrate 55 is contacted by a substance 57. In Panel a), the optical substrate is surrounded by the substance. In Panel b) a portion of the surface of the substrate capping one end is contacted by the substance. In additional embodiments not illustrated in panel b), each end of the optical substrate may have a substance capping the surfaces. In panel c) the substance contacts cylindrical surfaces of the optical substrate; in other embodiments not illustrated the substance may cover only a portion of the cylindrical surface, such as contact biased toward one end, or striped applications of the substance that are parallel to the cylindrical axis. In panel d) both ends are shown capped by substances; in related embodiments only one end of the cylindrical particle may be so capped. In panels a) through c) of FIG. 38, additional optional segments from which the substance may be absent are indicated by the dashed lines surrounding the regions 59. These optional variations of the embodiments shown are intended to illustrate that essentially unlimited ways exist to apply a substance to a substrate, and/or to mask the substrate from the substance.

Optically Encoded Multicomponent Article with Adsorbed Reagent

In many important embodiments of the invention the substance includes a reagent.

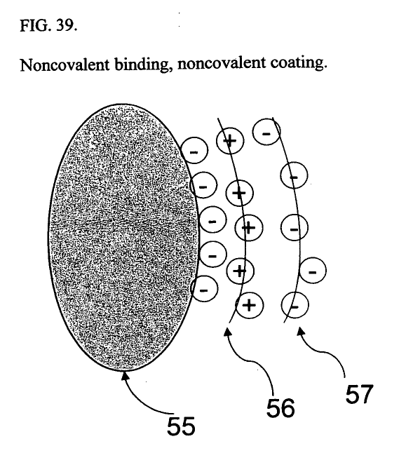

A reagent may be adsorbed by noncovalent interactions to an optical substrate. A variety of reagents may be adsorbed in this way. Many proteins and polypeptides are sufficiently surface active that they adhere strongly to a surface of an optical substrate. Included in this category are antibodies. In addition, nucleic acids and polynucleotides are bound noncovalently to a surface of an optical substrate. One embodiment believed, without wishing to bound by theory, to involve electrostatic interactions is represented in FIG. 39. Here, a polycation 56 is first adsorbed to a surface, such as a surface of an optical substrate comprised of silica or a silicate, shown at 55. Silica or a silicate is believed to manifest negative fixed charges on the surface. A polycation commonly used is poly-(L-lysine); other examples include polyethylenimine and polyvinylamine. Subsequently a nucleic acid, polynucleotide or oligonucleotide, which is a polyanion (shown at 57) is then bound to the polycation, providing a reagent-bearing article with a nucleic acid, polynucleotide or oligonucleotide bound as the reagent.

An alternative embodiment of an adsorbed reagent thought to be bound by electrostatic interactions involves constructing an optical substrate covalently bound to a linker (see below) that terminates in a cationic group. A high density of fixed positive charges on the surface of the substrate results. These then may adsorb a polyanion such as a nucleic acid, polynucleotide or oligonucleotide, as in the preceding paragraph.

Alternatively a substrate may be coated with a substance that is primarily nonpolar or hydrophobic in nature. Examples include long chain fatty acids, fatty acid esters, phospholipids, other amphiphiles, waxes, hydrophobic polymers, and the like. With a surface on the substrate now having a nonpolar or hydrophobic character, a reagent with an ability to adsorb to such a surface may be applied. Many proteins adsorb to such nonpolar surfaces while still preserving their biological function. Single strand oligonucleotides and polynucleotides may also bind to such a coated surface.

In certain embodiments, a substance modeling a biological lipid bilayer may be constructed. Then a reagent such as a protein that occurs naturally embedded within a biological lipid bilayer membrane may be adsorbed to the optical substrate via the bilayer membrane. In order to accomplish this, a substrate may be coated with a mock or artificially induced lipid bilayer. By way of nonlimiting example, a cationic phospholipid, such as a phosphatidyl choline or a phosphatidyl serine may first be adsorbed, wherein the cationic charge in the polar head of the amphiphile adsorbs to a negative surface charge of an article such as a silica or a silicate. A second layer of an amphiphilic lipid adsorbs to the first layer to result in a lipid bilayer construct that resembles a natural biological membrane. A holoprotein membrane-bound protein including a hydrophobic membrane anchor, or a covalently bound fatty acyl anchor, is then adsorbed to the lipid bilayer, resulting in an article bearing the membrane protein as a reagent.

In more general embodiments of a membrane-coated article, any amphiphile that forms a micelle, or that is employable in the formation of a liposome structure, may be adsorbed to a substrate as described in the preceding paragraph to form a substrate coated with a lipid bilayer. Similarly, in nonaqueous, or nonpolar, solvents, a single layered membrane of amphiphiles may be bound.

In general, any equivalent coating of a substrate to provide an article with a surface different from that of the uncoated substrate and characteristic of the material used in the coating is contemplated within the scope of the invention. Such coatings are known to workers of skill in fields related to the present invention. After acquiring a coating, any reagent contemplated within the scope of the invention may be adsorbed to the surface presented by the coating.

Optically Encoded Multicomponent Article with Covalent Linker, Spacer, and Reagent

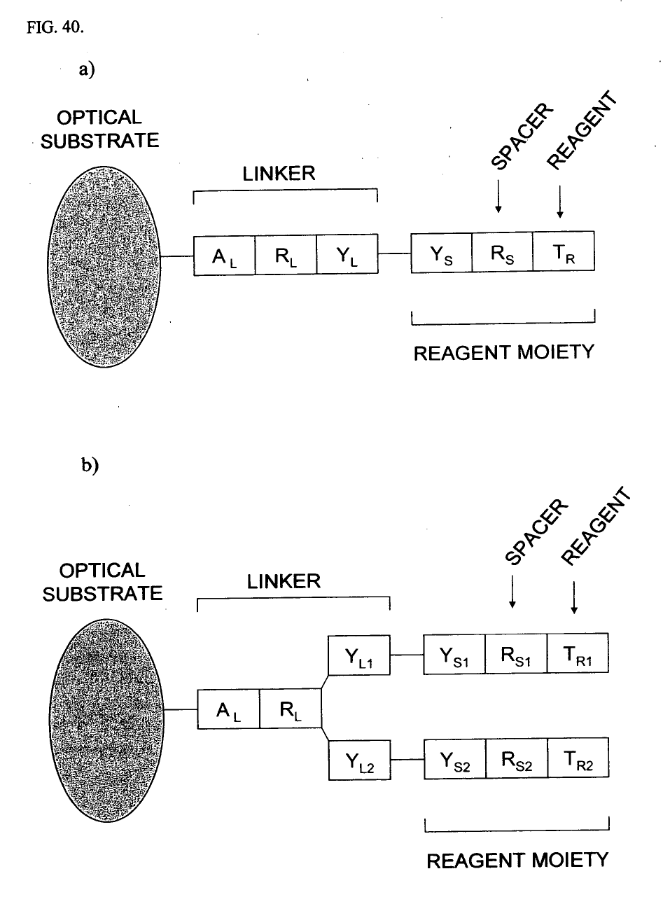

A significant embodiment of a reagent-bearing article is represented diagrammatically in FIG. 40, panel a) wherein the article is a particle. The particle is shown binding a linker, a spacer and a reagent. It is seen that the linker has a structure given as
-A_{L}-R_{L}—Y_{L}-
In this structure A_{L} is a moiety that binds a surface of the particle, R_{L} is a linking group, and Y_{L} represents a grouping that binds the moiety comprising the reagent.

In important embodiments A_{L} comprises T or a Z-Si(R_{A})(R_{B}) moiety; wherein
T comprises Q, S—S, O-QC, NR₃—CQ, CQ-O, CQ-NR₃, N═N, SO₂—NR₃, or NR₃—SO₂;
Z is absent or comprises Q;
R_{A} and R_{B} are independently X, Z, OR₃, or NR₃R₃;
   wherein X is F, Cl, Br, or I;
   wherein R₃ is H, normal or branched chain alkyl, normal or branched chain alkylene, cycloalkyl, aryl, or aralkyl; and
   wherein R₃ comprises between 0 and 20 C atoms; and
Q is O or S.
In many significant embodiments R_{L} comprises (D)ₙ;
   wherein each D moiety is independently a heteroatom, a carbonyl group, a C(R₁)(R₂) group, a C(R₁)══ group, a saccharide residue, an amino acyl residue, a modified amino acyl residue, a nucleotidyl group, or a modified nucleotidyl group;
   wherein any one or more D moieties may bind a Y_{L} moiety;
   wherein n represents the degree of multiplicity of inclusion of D and varies from 0 to 3000;
   each R₁ and R₂ is independently H, OH, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino;
   R₁, and R₂ each independently comprise between 0 and 20 C atoms.

Examples of structures available for Y_{L} are discussed in more detail below. In certain embodiments the moiety Y_{L} may be absent. In such cases R_{L} directly binds the moiety comprising the reagent. In other embodiments, R_{L} may have more than one D moiety terminating in a Y_{L} moiety, thus permitting one linker to bind more than one reagent-bearing moiety (see FIG. 40, panel b, for an embodiment in which a linker binds two Y_{L} moieties, designated by the additional subscripts 1 and 2.). By way of nonlimiting example, a trifunctional linker including two Y_{L} moieties may be created by attaching a Y_{L} moiety to more than one D moiety, or else by having a branched structure within a single D moiety and binding Y_{L} moieties to branches within the D grouping. Additionally, Y_{L} may be include a dendrimer structure such that Y_{L} binds to R_{L} with a single valence, but terminates in a plurality of combining groups that bind to Y_{S}. A dendrimer terminus to Y_{L} affords the option of binding a plurality of reagents to a single site on the particle. Thus, a dendrimeric embodiment of Y_{L} may terminate in two combining groups, or three combining groups, or even more.

A linker may be so constructed as to include within it a cleavable site. Nonlimiting examples of cleavable sites include disulfide groupings, esters, and vic-diols. Advantages of including cleavable sites in a linker relate to the ability subsequently to cleave a moiety including a reagent from the optical substrate. This would enable various quality control assays, use of the reagent free of the substrate, and so on. Bifunctional reagents including cleavable sites that may be use in a linker are available, for example, from Pierce Biotechnology, Inc., Rockford, Ill.

The moiety containing the reagent T_{R} is diagrammed (see FIG. 40) as
—Y_{S}—R_{S}-T_{R};
wherein Y_{S} is a grouping that binds the linker, and R_{S} is a spacer. In certain embodiments, including when Y_{L} is absent, Y_{S} may be absent. When Y_{S} is absent, the spacer R_{S} binds the linker moiety R_{L} directly.

In many embodiments in which Y_{S} is present, its composition may be given by one of the entries shown in Table 1, below.

In important embodiments of the reagent-bearing moiety, the R_{S} component is constituted of (D)ₙ,
wherein each D moiety is independently a heteroatom, a carbonyl group, a C(R₁)(R₂) group, a C(R₁)══ group, a saccharide residue, an amino acyl residue, a modified amino acyl residue, a nucleotidyl group, or a modified nucleotidyl group;
wherein n represents the degree of multiplicity of inclusion of D and varies from 0 to 3000; and
wherein each R₁ and R₂ is independently H, OH, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino; and
wherein R₁, and R₂ each independently comprise between 0 and 20 C atoms.

As shown in FIG. 40, R_{S} is linked to the reagent T_{R}.

A spacer may be so constructed as to include within the spacer chain a cleavable site. Nonlimiting examples of cleavable sites include disulfide groupings, esters, and vic-diols. Advantages of including cleavable sites in a spacer relate to the ability subsequently to cleave a moiety including a reagent from the optical substrate. This would enable various quality control assays, use of the reagent free of the substrate, and so on. Bifunctional reagents including cleavable sites that may be use in a spacer are available, for example, from Pierce Biotechnology, Inc., Rockford, Ill.

The groupings Y_{L} and Y_{S}, when present, are linked together in the reagent-bearing article (see FIG. 40). Mutually specific groupings are used as Y_{L} and Y_{S} since they are the products of a chemical reaction between a Y_{L} precursor Y_{LP} and a Y_{S} precursor Y_{SP}. A nonlimiting set of pairs of mutually specific groupings is presented in Table 1. Any mutually specific groupings may occur as Y_{L} and Y_{S}; such mutually specific groupings are widely known to workers of skill in fields of synthetic organic chemistry and similar fields related to the present invention. In Table 1, each entry for Y_{L} or for Y_{S} terminates with a line signifying a chemical bond. It is understood that the bonds facing each other on a given row of Table 1 are joined so as to form the same bond, indicating that the two entries in adjacent columns of the same row are in fact bonded to each other as mutually specific groupings. Equivalent mutually specific groupings that are effective to bond a linker to a reagent-bearing moiety fall within the scope of the present invention, and are encompassed within the scope of the claims.

TABLE 1

| REACTION | | |
|---|---|---|
| OR ACTIVE | | |
| GROUP | LINKER TERMINUS (Y_{L}) | SPACER TERMINUS (Y_{S}) |
| — | Q— | — |
| | N(R₃)— | — |
| | — | —Q |
| | — | —N(R₃ |
| Aldehyde, | CR₃═ | ═N |
| acetal, | | |
| hemiacetal | | |
| | N═ | ═CR₃ |
| Epoxide | C(R₃)(OH)—C(R₃)(R₄)— | —O |
| | C(R₃)(OH)—C(R₃)(R₄)— | —N(R₃) |
| | O— | —C(R₃)(R₄)—C(R₃)(OH) |
| | N(R₃)— | —C(R₃)(R₄)—C(R₃)(OH) |
| Haloalkyl | — | —N(R₃) |
| | N(R₃)— | — |
| Epihalohydrin | 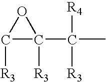 | —N(R₃) |
| | 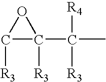 | —O |
| | O— | 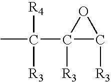 |
| | N(R₃)— | 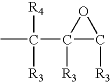 |
| Sulfonyl halide | SO₂— | —N(R₃) |
| | N(R₃)— | —SO₂ |
| Activated ester, | CQ— | —N(R₃) |
| DCCI coupling | | |
| | CQ— | —O |
| | N(R₃)— | —CQ |
| | O— | —CQ |
| Urethane, | N(R₃)CQ— | —N(R₃) |
| isocyanate, | | |
| isothiocyanate | | |
| | N(R₃)— | —CQNR₃ |
| Alpha,beta- | C(R₃)(R₄)—C(R₃)(M)— | —N(R₃) |
| unsaturated | | |
| carbonyl | | |
| | N(R₃)— | —C(R₃)(M)—C(R₃)(R₄) |
| Anhydride | 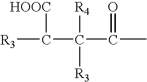 | —N(R₃) |
| | 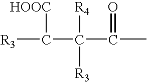 | —Q |
| | N(R₃)— | 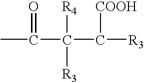 |
| | Q— | 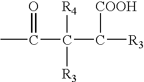 |
| Diene | Diels- | -Alder |
| | Alder- | -Diels |
| | C(R₃)(R₄)—C(R₃)(R₄)— | —NR₃ |
| | C(R₃)(R₄)—C(R₃)(R₄)— | —Q |
| | NR₃— | —C(R₃)(R₄)—C(R₃)(R₄) |
| | Q— | —C(R₃)(R₄)—C(R₃)(R₄) |
| Thiol | S— | —S |
| Cyclo- | cyclopentadienyl- | —[Me]-cyclopentadienyl |
| pentadiene | | |

wherein R₃ and R₄ are independently H, normal or branched chain alkyl, normal or branched chain alkylene, cycloalkyl, aryl, or aralkyl;

wherein R₃ and R₄ each independently comprise between 1 and 20 C atoms;

wherein Q is O or S;

wherein M is COOH, COOR₃, CHO, CN, CON(R₃)(R₄), NO₂, SOR₃, or SO₂R₃;

wherein [Me] designates any metal cation that forms a metallocene complex;

X is F, Cl, Br, or I;

Diels designates any conjugated diene that can combine with an ethylenic moiety to form a Diels-Alder adduct;

Alder designates any ethylenic moiety that can combine with a conjugated diene to form a Diels-Alder adduct; and

cyclopentadienyl refers to any monocyclic or polycyclic cyclopentadienyl radical.

In Tables 1 and 2, the product obtained upon reacting an amine with an aldehyde, a hemiacetal, or an acetal is a Schiff base. Frequently, in order to prevent dissociation of a Schiff base back to the original reactants, the Schiff base if further reduced to provide a singly-bonded grouping that includes a simple amino group.

In order to synthesize a Y_{L}—Y_{S} bond between the linker and the reagent-bearing moiety, a mutually specific pair of precursors, a Y_{LP} precursor and a Y_{SP} precursor, are caused to react with each other to form a Y_{L}—Y_{S} bond. Any mutually specific groupings may occur as Y_{LP} and Y_{SP}; such mutually specific groupings are widely known to workers of skill in fields of synthetic organic chemistry and similar fields related to the present invention. A nonlimiting set of pairs of mutually specific groupings is presented in Table 2. In Table 2, each entry for Y_{LP} or for Y_{SP} ends in a chemically reactive grouping. It is understood that the precursors facing each other on a given row of Table 2 react with each other to form products such as those shown in Table 1. Equivalent mutually specific precursors that are effective to bond a linker to a reagent-bearing moiety fall within the scope of the present invention, and are encompassed within the scope of the claims. Any other way of achieving the bonding shown in Table 1 is within the scope of the present invention. More generally, equivalent grouping of one or more moieties that effectively binds a reagent to an optical substrate is encompassed within the scope of the present invention, and falls within the scope of the claims.

TABLE 2

| REACTION OR | LINKER PRECURSOR | SPACER PRECURSOR |
|---|---|---|
| ACTIVE GROUP | (Y_{LP}) TERMINUS | (Y_{SP}) TERMINUS |
| — | QH | H |
| | N(R₃)H | H |
| | H | QH |
| | H | N(R₃)H |
| Aldehyde, acetal, | C(R₃)═O | N(R₃)H |
| hemiacetal | | |
| | C(R₃)(OR₃)(OH) | N(R₃)H |
| | C(R₃)(OR₃)(OR₃) | N(R₃)H |
| | N(R₃)H | O═C(R₃) |
| | N(R₃)H | (R₃O)(HO)C(R₃) |
| | N(R₃)H | (R₃O)(R₃O)C(R₃) |
| Epoxide | 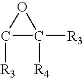 | HO |
| | 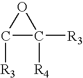 | HN(R₃) |
| | OH | 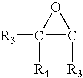 |
| | N(R₃)H | 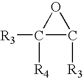 |
| Haloalkyl | X | HN(R₃) |
| | N(R₃)H | X |
| Epihalohydrin | 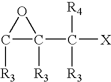 | HN(R₃) |
| | 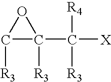 | HO |
| | OH | 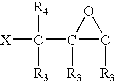 |
| | N(R₃)H | 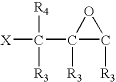 |
| Sulfonyl halide | SO₂—X | HN(R₃) |
| | N(R₃)H | X—SO₂ |
| Activated ester, | CQOR₅ | HN(R₃) |
| DCCI coupling | | |
| | CQOR₅ | HO |
| | N(R₃)H | R₅OCQ |
| | OH | R₅OCQ |
| Urethane, | (R₃)NCQOR₃ | HN(R₃) |
| isocyanate, | | |
| isothiocyanate | | |
| | N(R₃)H | R₃OCQN(R₃) |
| | N(R₃)C═Q | HN(R₃) |
| | N(R₃)H | Q═CNR₃ |
| Alpha,beta- | C(R₃)(R₄)═C(R₃)(M) | HN(R₃) |
| unsaturated | | |
| carbonyl | | |
| | N(R₃)H | (M)(R₃)C═C(R₃)(R₄) |
| Anhydride | 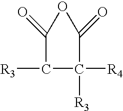 | HN(R₃) |
| | 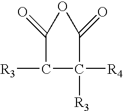 | HQ |
| | N(R₃)H | 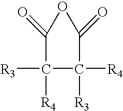 |
| | QH | 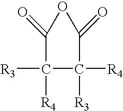 |
| Diene | Diels- | -Alder |
| | Alder- | -Diels |
| | C(R₃)(R₄)═C(R₃)(R₄) | HNR₃ |
| | C(R₃)(R₄)═C(R₃)(R₄) | HQ |
| | NR₃H | C(R₃)(R₄)═C(R₃)(R₄) |
| | QH | C(R₃)(R₄)═C(R₃)(R₄) |
| Thiol | SH | HS |
| Cyclopentadiene | cyclopentadienyl | [Me] + cyclopentadienyl |

wherein R₃ and R₄ are independently H, normal or branched chain alkyl, normal or branched chain alkylene, cycloalkyl, aryl, or aralkyl, wherein R₃ and R₄, each independently comprise between 1 and 20 C atoms;

where R₅ is H (in the presence of a coupling agent such as dicyclohexylcarbodiimide), pentachlorophenyl or N-hydroxysuccinimidyl;

wherein Q is O or S;

wherein M is COOH, COOR₃, CHO, CN, CON(R₃)(R₄), NO₂, SOR₃, or SO₂R₃;

wherein [Me] designates any metal cation that forms a metallocene complex;

X is F, Cl, Br, or I;

Diels designates any conjugated diene that can combine with an ethylenic moiety to form a Diels-Alder adduct;

Alder designates any ethylenic moiety that can combine with a conjugated diene to form a Diels-Alder adduct; and

cyclopentadienyl refers to any monocyclic or polycyclic cyclopentadienyl radical.

In general an encoded reagent-bearing article of the invention is prepared by
a) providing an optical substrate having at least one surface, the substrate comprising an optical coding element providing an output signal corresponding to a code embedded in the coding element when the coding element is illuminated with incident radiation; and
b) binding the reagent to a surface of the optical substrate.
   When the code embedded in the particle is identified, and a single known reagent is bound to the surface, the coded particle is identified as bearing the known reagent.

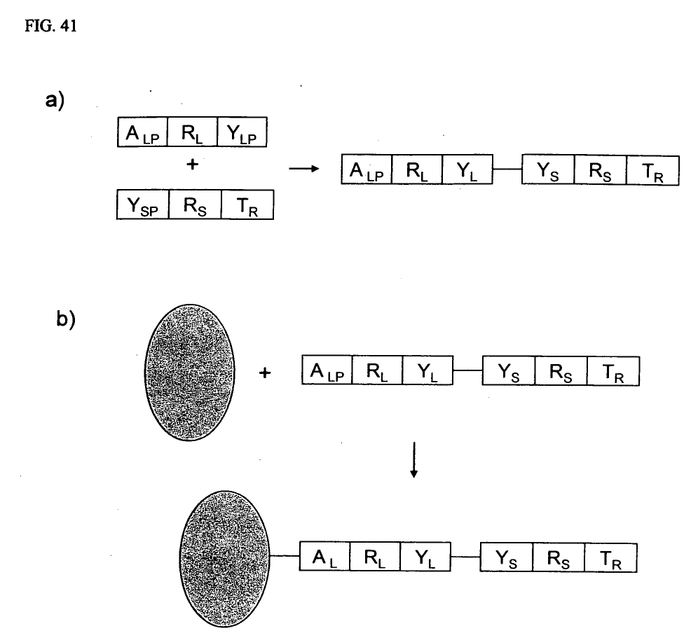

Three generic components comprising a reagent-bearing article are identified in FIG. 40 and in several embodiments of the present invention, namely, the optical substrate, the linker, and the reagent-bearing moiety. The optical substrate and the reactive precursors of the linker and the reagent-bearing moiety may be reacted with each other in any suitable order to prepare the reagent-bearing article. In some embodiments of synthesizing the article, the linker precursor and the precursor of the reagent-bearing moiety may be combined first to prepare a linker-reagent moiety conjugate (see FIG. 41, panel a)). The latter, which still bears a reactive group A_{LP} suitable for combining with a surface of the optical substrate, is then combined with the substrate to form a reagent-bearing article of the invention, as shown in FIG. 41, panel b).

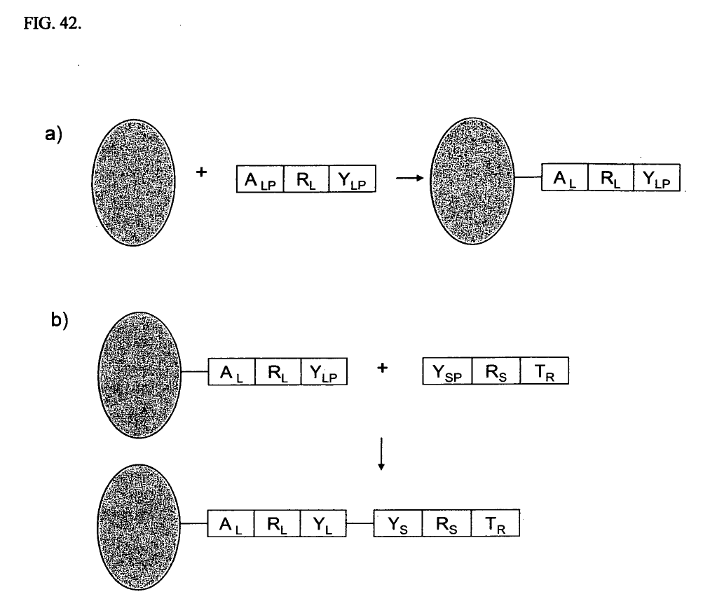

Alternatively, the optical substrate may be combined first with a reactive linker precursor to bind the linker to the substrate (see FIG. 42, panel a)). The bound linker is then contacted with a reactive precursor of the reagent-bearing moiety, yielding the final product, a reagent-bearing article of the invention as depicted in FIG. 42, panel b).

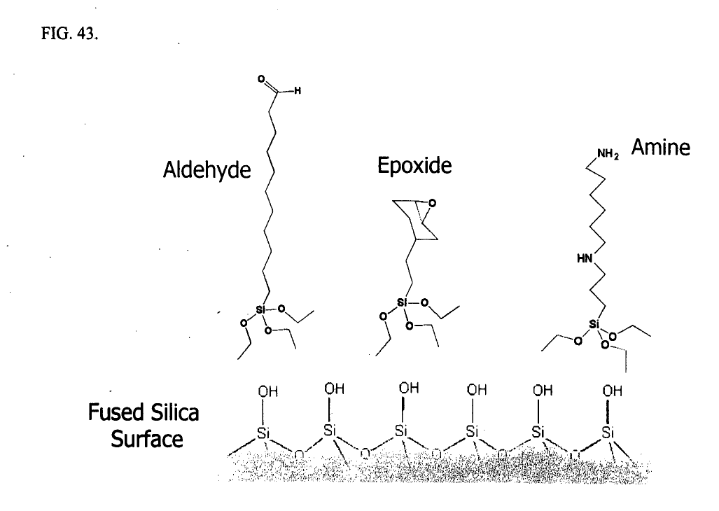

Certain embodiments of bifunctional linker precursors are illustrated by way of nonlimiting example in FIG. 43, in the proximity of a silica surface. Each precursor may react with the substrate via one or more of its ethoxy groups. Then the second functionality, namely an aldehyde, an epoxide, or an amine, is available to react further with a spacer precursor or directly with a reagent or reagent precursor.

In the preparative reactions described above, the linker precursor employed may be generically described as having the structure
A_{LP}-R_{L}—Y_{LP};

wherein the A_{LP} moiety comprises an activated reagent that forms a covalent bond with the substrate;

wherein, in significant embodiments, R_{L} comprises (D)ₙ,
wherein each D moiety is independently a heteroatom, a carbonyl group, a C(R₁)(R₂) group, a C(R₁)══ group, a saccharide residue, an amino acyl residue, a modified amino acyl residue, a nucleotidyl group, or a modified nucleotidyl group;
wherein any one or more D moieties may bind a Y_{LP} moiety;
wherein n represents the degree of multiplicity of inclusion of D and varies from 0 to 3000;

wherein Y_{LP} is a reactive moiety, such as described previously in nonlimiting examples in Table 2, that forms a covalent bond with the reagent precursor;

wherein each R₁ and R₂ is independently H, OH, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino; and

wherein R₁, and R₂ each independently comprise between 0 and 20 C atoms.

In certain embodiments of the linker precursor, R_{L} may have more than one D moiety terminating in a Y_{LP} moiety, thus permitting one linker to bind more than one reagent-bearing moiety (see FIG. 39, panel b, for an embodiment in which a linker binds two Y_{L} moieties). In addition, a trifunctional linker precursor including two Y_{LP} moieties may be created by including a D moiety having a branched structure and binding Y_{LP} moieties to branches within the D grouping. Additionally, Y_{LP} may include a dendrimer structure such that Y_{LP} binds to R_{L} with a single valence, but terminates in a plurality of combining groups that react with Y_{SP}. A dendrimer terminus to Y_{LP} affords the option of binding a plurality of reagents to a single site on the particle. Thus, a dendrimeric embodiment of Y_{LP} may terminate in two combining groups, or three combining groups, or even more.

The reactive moiety A_{LP} may comprise a moiety T when the surface of the optical substrate is a polymer, resin, or plastic. T may comprise HQ, HS—S, X-QC, X—NR₃-CQ, X—CQ-O, X—CQ-NR₃, HN═N, X—SO₂—NR₃, or X—NR₃—SO₂. Alternatively, A_{LP} may comprise a moiety T or a Z-Si(R_{A})(R_{B}) moiety when the substrate is a silica, a silicate, or a glass, wherein Z may comprise R_{C}. In these various representations of T and Z-Si(R_{A})(R_{B}),

R_{A}, R_{B}, and R_{C} are independently X, Z, OR₃, or NR₃R₃;
wherein R₃ is H, normal or branched chain alkyl, normal or branched chain alkylene, cycloalkyl, aryl, or aralkyl,
wherein R₃ comprises between 0 and 20 C atoms;
wherein X is F, Cl, Br, or I; and

Q is O or S.

In the reactions employed in preparing a reagent-bearing article, the precursor of the reagent moiety may described as
—Y_{SP}—R_{S}-T_{R};

wherein Y_{SP} is a grouping that reacts with the linker precursor, and R_{S} is a spacer. Y_{SP} is a reactive moiety, such as described previously in nonlimiting examples in Table 2, that forms a covalent bond with the linker precursor.

In many advantageous embodiments of the reagent-bearing moiety, the R_{S} component is constituted of (D)ₙ,
wherein each D moiety is independently a heteroatom, a carbonyl group, a C(R₁)(R₂) group, a C(R₁)══ group, a saccharide residue, an amino acyl residue, a modified amino acyl residue, a nucleotidyl group, or a modified nucleotidyl group;
wherein n represents the degree of multiplicity of inclusion of D and varies from 0 to 3000; and
wherein each R₁ and R₂ is independently H, OH, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino; and
wherein R₁, and R₂ each independently comprise between 0 and 20 C atoms.

Preparation of Coded Reagent Libraries

A coded reagent library is constituted of a plurality of multicomponent articles wherein the articles have differing reagents bound to them. Such a coded reagent library may be prepared, for each article in the collection of articles, generally by a method including
a) providing a diffraction grating-based encoded element, wherein the encoded element includes
   i) an optical substrate having at least one surface, and
   ii) an optical coding element comprising at least one diffraction grating disposed therein, said grating having at least one refractive index pitch superimposed at a common location effective to provide an optical code therein, the grating providing an output optical signal when illuminated by an incident light signal, said optical output signal being indicative of the code in said coding element; and
b) binding a reagent to a surface of each of said optical substrates, thus preparing each member of a coded reagent library.
   In more particular aspects, a coded reagent library is prepared by including the following additional detailed steps:
a′) in step a) above maintaining a first optical substrate bearing a first code separate from a second substrate bearing a second code, and
b′) in step b) above binding a first reagent to the first optical substrate and a second reagent to the second optical substrate.

Particle-Linker Composition

An optical substrate may be bound with a linker precursor only, to form a particle-linker composition. Such a composition has altered properties in terms of buoyancy, fluid dynamics, and so forth, so that it may be employed to advantage to affect behavior in fluid and flowing suspensions.

The Reagent

The reagent T_{R} may be any chemical substance useful in a process, assay, or reaction to which the reagent-bearing article of the invention may be applied. In many important embodiments of the invention, a reagent may include a nucleic acid, a polynucleotide, an oligonucleotide, a nucleotide, a nucleoside, a protein nucleic acid, a peptide nucleic acid, a protein or fragment thereof, an enzyme or fragment thereof, a receptor or fragment thereof, a polypeptide, an oligopeptide, an amino acid, a derivative of any of the foregoing, a modification of any of the foregoing, a synthetic organic molecule, a synthetic intermediate, a synthetic precursor, an antibiotic, a metabolite, any biochemical moiety, a candidate pharmaceutical agent, a pharmaceutical agent, a virus particle or a portion thereof, a prokaryotic cell, a eukaryotic cell, a vertebrate cell, a mammalian cell, a human cell, any portion of said cell, a liposome, a vesicle, and a subcellular organelle.

Polynucleotides

As used herein the terms “nucleic acid” and “polynucleotide” are considered synonymous with each other, and are used as conventionally understood by workers of skill in fields such as biochemistry, molecular biology, genomics, and similar fields related to the field of the invention. A polynucleotide employed in the invention may be single stranded or a base paired double stranded structure, or even a triple stranded base paired structure. A polynucleotide may be a DNA, an RNA, or any mixture or combination of a DNA strand and an RNA strand, such as, by way of nonlimiting example, a DNA-RNA duplex structure. A polynucleotide and “oligonucleotide” as used herein are identical in any and all attributes defined here for a polynucleotide except for the length of a strand. As used herein, a polynucleotide may be about 50 nucleotides or base pairs in length or longer, or about 60, or about 70, or about 80, or about 100, or about 150, or about 200, or about 300 nucleotides or base pairs or even longer. An oligonucleotide may be at least 3 nucleotides or base pairs in length, and may be shorter than about 70, or about 60, or about 50, or about 40, or about 30, or about 20, or about 15 nucleotides or base pairs in length.

A “nucleoside” is conventionally understood by workers of skill in fields such as biochemistry, molecular biology, genomics, and similar fields related to the field of the invention as comprising a monosaccharide linked in glycosidic linkage to a purine or pyrimidine base; and a “nucleotide” comprises a nucleoside with at least one phosphate group appended, typically at a 3′ or a 5′ position (for pentoses) of the saccharide, but may be at other positions of the saccharide. Nucleotide residues occupy sequential positions in an oligonucleotide or a polynucleotide. Accordingly a modification or derivative of a nucleotide may occur at any sequential position in an oligonucleotide or a polynucleotide. All modified or derivatized oligonucleotides and polynucleotides are encompassed within the invention and fall within the scope of the claims. Modifications or derivatives can occur in the phosphate group, the monosaccharide or the base.

By way of nonlimiting examples, the following descriptions provide certain modified or derivatized nucleotides. The phosphate group may be modified to a thiophosphate or a phosphonate. The phosphate may also be derivatized to include an additional esterified group to form a triester. The monosaccharide may be modified by being, for example, a pentose or a hexose other than a ribose or a deoxyribose. The monosaccharide may also be modified by substituting hydryoxyl groups with hydro or amino groups, by esterifying additional hydroxyl groups, and so on.

The base may be modified in many ways; several modified bases occur naturally in various nucleic acids, and other modifications may mimic or resemble such naturally occurring modified bases. Nonlimiting examples of modified or derivatized bases include 5-fluorouracil, 5-bromouracil, 5-chlorouracil, 5-iodouracil, hypoxanthine, xanthine, 4-acetylcytosine, 5-(carboxyhydroxylmethyl)uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil, beta-D-mannosylqueosine, 5′-methoxycarboxymethyluracil, 5-methoxyuracil, 2-methylthio-N6-isopentenyladenine, uracil-5-oxyacetic acid (v), wybutoxosine, pseudouracil, queosine, 2-ihiocytosine, 5-methyl-2-thiouracil, 2-thiouracil, 4-thiouracil, 5-methyluracil, uracil-5-oxyacetic acid methylester, uracil-5-oxyacetic acid (v), 5-methyl-2-thiouracil, 3-(3-amino-3-N-2-carboxypropyl) uracil, (acp3)w, and 2,6-diaminopurine.

Nucleotides may also be modified to harbor a label. Nucleotides bearing a fluorescent label or a biotin label, for example, are available from Sigma (St. Louis, Mo.).

A significant use of a nucleic acid-, polynucleotide-, or oligonucleotide-bearing reagent-bearing article is in assay directed to identifying a target sequene to which the probe hybridizes. The selectivity of a probe for a target is affected by the stringency of the hybridizing conditions. “Stringency” of hybridization reactions is readily determinable by one of ordinary skill in the art, and generally is an empirical calculation dependent upon probe length, washing temperature, and salt concentration. In general, longer probes require higher temperatures for proper annealing, while shorter probes need lower temperatures. Hybridization generally depends on the ability of denatured DNA to reanneal when complementary strands are present in an environment below their melting temperature. The higher the degree of desired homology between the probe and hybridizable sequence, the higher the relative temperature which can be used. As a result, it follows that higher relative temperatures would tend to make the reaction conditions more stringent, while lower temperatures less so. For additional details and explanation of stringency of hybridization reactions, see Ausubel et al., Current Protocols in Molecular Biology, Wiley Interscience Publishers, (1995).

Nonlimiting examples of “stringent conditions” or “high stringency conditions”, as defined herein, include those that: (1) employ low ionic strength and high temperature for washing, for example 0.015 M sodium chloride/0.0015 M sodium citrate/0.1% sodium dodecyl sulfate at 50° C.; (2) employ during hybridization a denaturing agent, such as formamide, for example, 50% (v/v) formamide with 0.1% bovine serum albumin/0.1% Ficoll/0.1% polyvinylpyrrolidone/50 mM sodium phosphate buffer at pH 6.5 with 750 mM sodium chloride, 75 mM sodium citrate at 42° C.; or (3) employ 50% formamide, 5×SSC (0.75 M NaCl, 0.075 M sodium citrate), 50 mM sodium phosphate (pH 6.8), 0.1% sodium pyrophosphate, 5× Denhardt's solution, sonicated salmon sperm DNA (50 μg/ml), 0.1% SDS, and 10% dextran sulfate at 42° C., with washes at 42° C. in 0.2×SSC (sodium chloride/sodium citrate) and 50% formamide at 55° C., followed by a high-stringency wash consisting of 0.1×SSC containing EDTA at 55° C.

“Moderately stringent conditions” may be identified as described by Sambrook et al., Molecular Cloning: A Laboratory Manual, New York: Cold Spring Harbor Press, 1989, and include the use of washing solution and hybridization conditions (e.g., temperature, ionic strength and % SDS) less stringent that those described above. An example of moderately stringent conditions is overnight incubation at 37° C. in a solution comprising:20% formamide, 5×SSC (150 mM NaCl, 15 mM trisodium citrate), 50 mM sodium phosphate (pH 7.6), 5× Denhardt's solution, 10% dextran sulfate, and 20 mg/ml denatured sheared salmon sperm DNA, followed by washing the filters in 1×SSC at about 37-50° C. The skilled artisan will recognize how to adjust the temperature, ionic strength, etc. as necessary to accommodate factors such as probe length and the like.

High stringency conditions promote high selectivity in the hybridization of a probe to a target. Stringency conditions may be modified or adjusted by a worker of skill in the art to adapt hybridization conditions to use in high throughput or multiplexed assay systems (Ausubel et al.). In addition, in high throughput or multiplexed assay systems, both the probe characteristics and the stringency may be optimized to permit achieving the objectives of the multiplexed assay under a single set of stringency conditions.

Protein Nucleic Acids

As used herein, the terms “protein nucleic acids”, “peptide nucleic acids”, or “PNAs” refer to nucleic acid mimics, e.g., DNA mimics, in which the deoxyribose phosphate backbone is replaced by a pseudopeptide backbone and only the four natural nucleobases are retained. The neutral backbone of PNAs has been shown to allow for specific hybridization to DNA and RNA under conditions of low ionic strength. The synthesis of PNA oligomers can be performed using standard solid phase peptide synthesis protocols as described in Hyrup et al. (1996) above; Perry-O'Keefe et al. (1996) PNAS 93: 14670-675. A PNA can be incorporated into a reagent-bearing article as the reagent to serve as a probe in a diagnostic assay.

Polypeptides and Proteins

As used herein an “amino acid” designates any one of the naturally occurring alpha-amino acids that are found in proteins. In addition, the term “amino acid” designates any nonnaturally occurring amino acids known to workers of skill in protein chemistry, biochemistry, and other fields related to the present invention. These include, by way of nonlimiting example, sarcosine, hydroxyproline, norleucine, alloisoleucine, cyclohexylalanine, phenylglycine, homocysteine, dihydroxyphenylalanine, ornithine, citrulline, D-amino acid isomers of naturally occurring L-amino acids, and others.

Additional examples of non-naturally occurring amino acids that may be substituted for a natural amino acid of a reagent peptide include the following alpha-amino acids: 2-aminobutyric acid, 2-amino-isobutyric acid, beta-alanine, beta-(4-biphenyl)-alanine, citrulline, diaminobutyric acid, homoarginine, homocysteine, 1-naphthylalanine, 2-naphthylalanine, norvaline, p-chlorophenylalanine, p-aminophenylalanine, p-fluorophenylalanine, p-nitrophenylalanine, 4-pyridylalanine, alpha,beta-diaminopropionic acid, cyclohexylalanine, norvaline, beta-(3-pyridinyl)alanine, 1-amino-1-cyclo-hexanecarboxylic acid, alpha-aminoisobutyric acid, 1-amino-1-cyclopropanecarboxylic acid, 1-amino-1-cyclobutanecarboxylic acid, 1-amino-1-cyclopentanecarboxylic acid, 1-amino-1-cyclohexanecarboxylic acid, 1-amino-1-cycloheptanecarboxylic acid, 1-amino-1-cyclooctanecarboxylic acid, and 1-amino-1-cyclononanecarboxylic acid. In addition, an alkyl or aryl residue in the preceding amino acids may contain 1-4 hydroxy substituents. Additional examples of amino acyl derivatives that may be incorporated into peptide reagent are disclosed in U.S. Pat. No. 6,841,657, incorporated herewith in its entirety.

By way of nonlimiting example, a derivatized amino acid residue may further have the following side chains: ethyl, n-butyl, —CH₂—CH₂—OH, —CH₂—CH₂—CH₂—OH, —CH₂—CHOHCH₃ and —CH₂—S—CH₃; phenylglycine; cyclohexylmethylalanine; modified amino residues having substituted benzyl or phenyl side chains wherein preferred substituents include one or more of the following: halogen, methyl, ethyl, nitro, methoxy, ethoxy and —CN; a substituted or unsubstituted aliphatic, aromatic or benzylic ester of glutamic or aspartic acid (e.g., methyl, ethyl, n-propyl iso-propyl, cyclohexyl, benzyl or substituted benzyl); CO—NH-alkylated glutamate or asparagine (e.g., methyl, ethyl, n-propyl and iso-propyl); and modified amino acids having the side chain —(CH₂).₃—COOH, an ester thereof (substituted or unsubstituted aliphatic, aromatic or benzylic ester), an amide thereof or a substituted or unsubstituted N-alkylated amide thereof; N-nitroarginine; beta-cycloarginine; gamma-hydroxyarginine; N-amidinocitruline; 2-amino-4-guanidinobutanoic acid; homologs of lysine; homologs of arginine; and modified amino acids having C1-C5 straight or branched alkyl side chains substituted with —OH or —SH.

In addition an amino acid may be modified or derivatized, for example by coupling the side chain with a label. Any amino acid known to a worker of skill in the art may be used as a reagent in a reagent-bearing article of the present invention.

Amino acid residues are constituents of oligopeptides, polypeptides and proteins. As used herein an “oligopeptide” or “peptide” may be at least 3 amino acid residues in length, and may be shorter than about 70, or about 60, or about 50, or about 40, or about 30, or about 20, or about 15, or about 10 amino acid residues in length. Many peptides are of direct interest, since a number of biologically active substances are relatively short peptides. In addition, amino acid sequences identified as serving as motifs or domains are relatively short. These and a wide range of other peptides or oligopeptides may serve as reagents in a reagent-bearing article of the invention.

As used herein a “polypeptide” or a “protein” may be considered to have a chain length of at least 50 amino acid residues, and may have as many as about 100, or about 150, or about 200, or about 300, or about 400, or about 500, or about 700, or about 1000 or more amino acids in the molecule. A protein is generally considered to be a composition that occurs naturally and may be isolated from a natural source. As such a protein may also have other characteristics. By way of nonlimiting example, a protein may additionally be a complex between two or more individual polypeptide chains held together by noncovalent interactions and/or by covalent bonds. A protein may additionally be a mature form of a polypeptide chain that is the gene product of an mRNA arising from a gene.

As used herein, a “mature” form of a polypeptide or protein disclosed in the present invention is the product of a naturally occurring polypeptide or precursor form or proprotein. The naturally occurring polypeptide, precursor or proprotein includes, by way of nonlimiting example, the full length gene product, encoded by the corresponding gene. Alternatively, it may be defined as the polypeptide, precursor or proprotein encoded by an open reading frame described herein. The product “mature” form arises, again by way of nonlimiting example, as a result of one or more naturally occurring processing steps as they may take place within the cell, or host cell, in which the gene product arises. Examples of such processing steps leading to a “mature” form of a polypeptide or protein include the cleavage of the N-terminal methionine residue encoded by the initiation codon of an open reading frame, or the proteolytic cleavage of a signal peptide or leader sequence. Thus a mature form arising from a precursor polypeptide or protein that has residues 1 to N, where residue 1 is the N-terminal methionine, would have residues 2 through N remaining after removal of the N-terminal methionine. Alternatively, a mature form arising from a precursor polypeptide or protein having residues 1 to N, in which an N-terminal signal sequence from residue 1 to residue M is cleaved, would have the residues from residue M+1 to residue N remaining. Further as used herein, a “mature” form of a polypeptide or protein may arise from a step of post-translational modification other than a proteolytic cleavage event. Such additional processes include, by way of non-limiting example, glycosylation, myristoylation or phosphorylation. In general, a mature polypeptide or protein may result from the operation of only one of these processes, or a combination of any of them.

A protein, polypeptide, oligopeptide or peptide may be modified by introducing one or more amino acid substitutions such that the amino acid sequence of the resulting product differs from the sequence that occurs in the naturally occurring substance.

Proteins have a wide range of functions and activities in biological organisms. Important examples of proteins include, by way of nonlimiting example, enzymes, receptors, and antibodies. Enzymes are reagents of interest in the present invention, since certain enzymes may be implicated, for example, in various pathological conditions. In such cases, it may be of interest to detect the presence of a substrate in a target sample, or to identify inhibitors from a set of candidates in a target sample. Likewise a receptor may be a reagent of interest, since binding of a specific ligand to a receptor as an agonist typically induces a signaling cascade leading to downstream sequellae in a cell. Many pathological states result from inappropriate receptor signaling. A receptor as a reagent bound to a particle may also be used to identify a therapeutic antagonist in a target composition to which it is exposed.

A reagent of the present invention may be any one of an amino acid, a peptide, an oligopeptide, a polypeptide, a protein, a receptor, an enzyme, or an antibody.

Antibodies

An antibody may be used as a probe to detect its cognate antigen in a target composition. For this reason antibodies are also an important class of reagent in a reagent-bearing article of the present invention. The term “antibody” as used herein refers to immunoglobulin molecules and immunologically active portions of immunoglobulin (Ig) molecules, i.e., molecules that contain an antigen binding site that specifically binds (immunoreacts with) an antigen. Such antibodies include, but are not limited to, polyclonal, monoclonal, chimeric, single chain, F_{ab}, F_{ab}′ and F_{(ab′)2} fragments, and an F_{ab} expression library. In general, antibody molecules obtained from humans relates to any of the classes IgG, IgM, IgA, IgE and IgD, which differ from one another by the nature of the heavy chain present in the molecule. Certain classes have subclasses as well, such as IgG1, Ig2, and others. Furthermore, in humans, the light chain may be a kappa chain or a lambda chain. Reference herein to antibodies includes a reference to all such classes, subclasses and types of human antibody species. Any antibody disclosed herein binds “immunospecifically” to its cognate antigen. By immunospecific binding is meant that an antibody raised by challenging a host with a particular immunogen binds to a molecule such as an antigen that includes the immunogenic moiety with a high affinity, and binds with only a weak affinity or not at all to non-immunogen-containing molecules. As used in this definition, high affinity means having a dissociation constant less than about 1 μM, and weak affinity means having a dissociation constant higher than about 1 μM.

An isolated protein of the invention intended to serve as an antigen, or a portion or fragment thereof, can be used as an immunogen to generate antibodies that immunospecifically bind the antigen, using standard techniques for polyclonal and monoclonal antibody preparation. The full-length protein can be used or, alternatively, antigenic peptide fragments of the antigen may be used as immunogens. An antigenic peptide fragment comprises at least 6, or at least 10, or at least 15 amino acid residues of the amino acid sequence of the full length protein, and encompasses an epitope thereof such that an antibody raised against the peptide forms a specific immune complex with the full length protein or with any fragment that contains the epitope. Antibodies that are specific for one or more domains within an antigenic protein, or derivatives, fragments, analogs or homologs thereof, may also be used as a reagent of the invention. A protein of the invention, or a derivative, fragment, analog, homolog or ortholog thereof, may be utilized as an immunogen in,the generation of antibodies that immunospecifically bind these protein components.

Various procedures known within the art may be used for the production of polyclonal or monoclonal antibodies directed against a protein of the invention, or against derivatives, fragments, analogs homologs or orthologs thereof (see, for example, Antibodies: A Laboratory Manual, Harlow E, and Lane D, 1988; Cold Spring Harbor Laboratory Press, Cold Spring Harbor, N.Y., incorporated herein by reference). Some of these antibodies are discussed below.

1. Polyclonal Antibodies

For the production of polyclonal antibodies, various suitable host animals (e.g., rabbit, goat, mouse or other mammal) may be immunized by one or more injections with the native protein, a synthetic variant thereof, or a derivative of the foregoing. An appropriate immunogenic preparation can contain, for example, the naturally occurring immunogenic protein, a chemically synthesized polypeptide representing the immunogenic protein, or a recombinantly expressed immunogenic protein. Furthermore, the protein may be conjugated to a second protein known to be immunogenic in the mammal being immunized. Examples of such immunogenic proteins include but are not limited to keyhole limpet hemocyanin, serum albumin, bovine thyroglobulin, and soybean trypsin inhibitor.

The polyclonal antibody molecules directed against the immunogenic protein can be isolated from the mammal (e.g., from the blood) and further purified by well known techniques, such as affinity chromatography using protein A or protein G, which provide primarily the IgG fraction of immune serum. Subsequently, or alternatively, the specific antigen which is the target of the immunoglobulin sought, or an epitope thereof, may be immobilized on a column to purify the immune specific antibody by immunoaffinity chromatography. Purification of immunoglobulins is discussed, for example, by D. Wilkinson (The Scientist, published by The Scientist, Inc., Philadelphia Pa., Vol. 14, No. 8 (Apr. 17, 2000), pp. 25-28).

2. Monoclonal Antibodies

The term “monoclonal antibody” (MAb) as used herein, refers to a population of antibody molecules that contain only one molecular species of antibody molecule consisting of a unique light chain gene product and a unique heavy chain gene product. In particular, the complementarity determining regions (CDRs) of the monoclonal antibody are identical in all the molecules of the population. MAbs thus contain an antigen binding site capable of immunoreacting with a particular epitope of the antigen characterized by a unique binding affinity for it.

Monoclonal antibodies can be prepared using hybridoma methods, such as those described by Kohler and Milstein, Nature, 256:495 (1975 (See also Goding, Monoclonal Antibodies: Principles and Practice, Academic Press, (1986) pp. 59-103)). In a hybridoma method, a mouse, hamster, or other appropriate host animal, is typically immunized with an immunizing agent to elicit lymphocytes that produce or are capable of producing antibodies that will specifically bind to the immunizing agent. Alternatively, the lymphocytes can be immunized in vitro.

The monoclonal antibodies can also be made by recombinant DNA methods, such as those described in U.S. Pat. No. 4,816,567. DNA encoding the intended monoclonal antibodies can be readily isolated and sequenced using conventional procedures (e.g., by using oligonucleotide probes that are capable of binding specifically to genes encoding the heavy and light chains of murine antibodies). The hybridoma cells of the invention serve as a preferred source of such DNA. Once isolated, the DNA can be placed into expression vectors, which are then transfected into host cells such as simian COS cells, Chinese hamster ovary (CHO) cells, or myeloma cells that do not otherwise produce immunoglobulin protein, to obtain the synthesis of monoclonal antibodies in the recombinant host cells.

3. Humanized Antibodies

The antibody reagents can further comprise humanized antibodies or human antibodies. Humanized forms of antibodies are chimeric immunoglobulins, immunoglobulin chains or fragments thereof (such as Fv, Fab, Fab′, F(ab′)2 or other antigen-binding subsequences of antibodies) that are principally comprised of the sequence of a human immunoglobulin, and contain minimal sequence derived from a non-human immunoglobulin. Humanization can be performed following the method of Winter and co-workers (Jones et al, Nature 321:522-525 (1986); Riechmann et al., Nature, 332:323-327 (1988); Verhoeyen et al., Science, 239:1534-1536 (1988)), by substituting rodent CDRs or CDR sequences for the corresponding sequences of a human antibody. (See also U.S. Pat. No. 5,225,539.)

4. Human Antibodies

Fully human antibodies relate to antibody molecules in which the entire sequence of both the light chain and the heavy chain, including the CDRs, arise from human genes. Such antibodies are termed “human antibodies”, or “fully human antibodies” herein. Human monoclonal antibodies can be prepared by the trioma technique; the human B-cell hybridoma technique (see Kozbor, et al. (1983) Immunol Today 4: 72) and the EBV hybridoma technique to produce human monoclonal antibodies (see Cole, et al. (1985) In: MONOCLONAL ANTIBODIES AND CANCER THERAPY, Alan R. Liss, inc., pp. 77-96). Human monoclonal antibodies may be utilized in the practice of the present invention and may be produced by using human hybridomas (see Cote, et al. (1983) Proc Natl Acad Sci USA 80: 2026-2030) or by transforming human B-cells with Epstein Barr Virus in vitro (see Cole, et al. (1985) in: MONOCLONAL ANTIBODIES AND CANCER THERAPY, Alan R. Liss, Inc., pp. 77-96).

In addition, human antibodies can also be produced using additional techniques, including phage display libraries (Hoogenboom and Winter (1991) J. Mol. Biol., 227:381; Marks et al. (1991) J. Mol. Biol., 222:581). Similarly, human antibodies can be made by introducing human immunoglobulin loci into transgenic animals e.g., mice in which the endogenous immunoglobulin genes have been partially or completely inactivated. Upon challenge, human antibody production is observed, which closely resembles that seen in humans in all respects, including gene rearrangement, assembly, and antibody repertoire. This approach is described, for example, in U.S. Pat. Nos. 5,545,807; 5,545,806; 5,569,825; 5,625,126; 5,633,425; 5,661,016, and in Marks et al. (1992) (Bio/Technology 10, 779-783); Lonberg et al. ((1994) Nature 368 856-859); Morrison ((1994) Nature 368, 812-13); Fishwild et al, ((1996) Nature Biotechnology 14, 845-51); Neuberger ((1996) Nature Biotechnology 14, 826); and Lonberg and Huszar ((1995) Intern. Rev. Immunol. 13 65-93).

5. Single Chain Antibodies and Fab Fragments

Single-chain antibodies specific to an antigenic protein of interest can also be used as a reagent in the invention (see e.g., U.S. Pat. No. 4,946,778). In addition, construction of Fab expression libraries (see e.g., Huse, et al., 1989 Science 246: 1275-1281) allow rapid and effective identification of monoclonal Fab fragments with the desired specificity for a protein, or derivatives, fragments, analogs or homologs thereof.

Any oligopeptide, polypeptide or protein that has been modified or derivatized may also serve as reagent in forming a reagent-bearing article of the invention. A common example of a derivatization is binding a label to an oligopeptide, polypeptide or protein. A label may be a luminescent label, or a reagent that is a member of a specific binding pair such as biotin, avidin, streptavidin, digoxin, digoxigenin, and the like. In addition an oligopeptide, polypeptide or protein may be chemically modified by any of a broad range of reagents such as those provided by Pierce Biotechnology, Inc., Rockford, Ill.

Organic Molecules, Antibiotics, Metabolites, and Drugs

Any of a broad range of synthetic organic molecules, antibiotics and their derivatives, metabolites, enzyme substrates and substrate analogs, enzyme inhibitors, chemical compounds that are members of a combinatorial library, other biochemical moieties, drug candidates and lead compounds, and the like, all may serve as reagents of the present invention. For example many antibiotics are currently known, and many more are being identified. An antibiotic may be used as a reagent of the invention in various assays and processes. Metabolomics is a growing field of investigation as one of the consequences of genomics studies. A metabolite, or a suspected or candidate metabolite, may be bound to a particle to facilitate investigational and diagnostic research concerning the role played by the metabolite. In addition, any enzyme substrate or substrate analog, or an enzyme inhibitor, or a candidate inhibitor in a screen of an inhibitor library, may be a reagent of the invention. Eukaryotic proteins contain many post-translational modifications, of which complex glycosidic substituents are very important. Synthetic libraries of complex saccharides may be bound as the reagents in the particles of the invention. Components of combinatorial libraries in general may be bound as reagents to particles of the invention as part of investigational studies directed toward identifying and optimizing a chemical substance for use as a pharmaceutical agent.

Inorganic Molecules

Any inorganic compound can be a reagent of the invention. An important example is an inorganic substance that is a catalyst. Other examples of inorganic reagents of the invention include nanoparticles (e.g. quantum dots), ceramic particles, semiconductor particles, and the like.

Organelles, Viruses and Cells

A reagent bound to coded particle of the invention may be a supramolecular construct, a subcellular particle, or a complete cell. For example, liposomes and lipid vesicles may be bound as reagents. Such constructs may include within the lumen or bound within the lipid membrane a reagent or molecule of interest for a particular application. Any subcellular particle may be bound to a coded particle, including, by way of nonlimiting example, microsomes, ribonucleoprotein particles, ribosomes, particles of endoplasmic reticulum, particles of Golgi apparatus, lysosomes, proteasomes, peroxisomes, mitochondria, and so forth. Additionally whole cells may be bound to a coded particle; including, by way of nonlimiting example, fibroblasts, hepatocytes, myocytes, erythrocytes, kidney cells, lymphocytes, macrophages, adipocytes, pancreatic islet cells, glial cells, dendroctyes, bacterial cells including any of a wide range of pathogens, and virus particles.

Assay Compositions

The invention includes assay compositions that contain a reagent particle of the invention and a fluid medium. Commonly the reagent particle is suspended in the fluid. In many applications of assay compositions, they may in addition contain an analyte in the fluid. The fluid may be any gaseous or liquid fluid, or a it may be a supercritical fluid. Commonly a fluid may be an aqueous liquid, such as a buffer optimized to carry out a particular assay.

In addition, an assay composition may contain a reagent library that includes a plurality of reagent particles of the invention and a fluid medium. Such a composition may also have an analyte contained in the fluid.

Chemical Synthesis Using Encoded Particles

The encoded particles of the invention may be used to synthesize identifiable compounds. In many such applications the particular compound synthesized is identified by a digital code of the particle used as the substrate. In this way libraries are conveniently synthesized, wherein each member of the library is known by the digital code of the particle on which it has been prepared.

In order to initiate the synthesis of a compound, an encoded reagent-bearing article is prepared having any reactant bound as the reagent. The reactant serves as one component in a synthetic chemical reaction, with one or more additional reactants provided in a liquid composition in which the particle is suspended. Contact of the reactant on the reagent-bearing article with the remaining reactant(s) in the composition under suitable reaction conditions provides a new chemical product synthesized on the particle. Nonbound reactants and side products are rinsed away from the particle. The new chemical product becomes the new reagent component of the reagent-bearing article, purified from all other substances involved in the reaction. Subsequently, any compound may be partially or totally synthesized on the substrate as intended.

Peptides, oligopeptides and polypeptides may be prepared using an encoded optical element. Additionally oligonucleotides and polynucleotides may be synthesized. Complex carbohydrates, such as those bound to glycoproteins, and related complex oligosaccharide chains, may be synthetically elaborated on a reagent-bearing article of the invention. Organic and inorganic compounds may likewise be prepared using appropriate chemical synthetic steps.

Peptides, oligopeptides and polypeptides may be synthesized using stepwise chain extension by well known techniques initially developed by B. Merrifield, and described, by way of nonlimiting example, in The Practice of Peptide Synthesis, 2^{nd} Ed., M Bodanszky and A. Bodanszky, Springer-Verlag, New York, N.Y. (1994).

In situ synthesis of oligonucleotide or polynucleotide probes on the substrate is performed in accordance with well-known chemical processes, including, but not limited to sequential addition of nucleotide phosphoramidites to surface-linked hydroxyl groups, as described by T. Brown and Dorcas J. S. Brown in Oligonucleotides and Analogues A Practical Approach, F. Eckstein, editor, Oxford University Press, Oxford, pp. 1-24 (1991), and incorporated herein by reference. Other methods of oligonucleotide synthesis include, but are not limited to solid-phase oligonucleotide synthesis according to the phosphotriester and phosphodiester methods (Narang, et al., (1979) Meth. Enzymol. 68:90), and to the H-phosphonate method (Garegg, P. J., et al., (1985) “Formation of internucleotidic bonds via phosphonate intermediates”, Chem. Scripta 25, 280-282; and Froehler, B. C., et al., (1986a) “Synthesis of DNA via deoxynucleoside H-phosphonate intermediates”, Nucleic Acid Res., 14, 5399-5407, among others) and synthesis on a support (Beaucage, et al. (1981) Tetrahedron Letters 22:1859-1862) as well as phosphoramidate techniques (Caruthers, M. H., et al., “Methods in Enzymology,” Vol. 154, pp. 287-314 (1988), U.S. Pat. Nos. 5,153,319, 5,132,418, 4,500,707, 4,458,066, 4,973,679, 4,668,777, and 4,415,732, and others described in “Synthesis and Applications of DNA and RNA,” S. A. Narang, editor, Academic Press, New York, 1987, and the references contained therein, and nonphosphoramidite techniques.

In general terms a coded polynucleotide reagent article, or a coded polynucleotide reagent library, may be synthesized by the steps of:
a) providing a one or more diffraction grating-based encoded elements, wherein each encoded element contains
   i) an optical substrate having at least one surface, and
   ii) an optical coding element comprising at least one diffraction grating disposed therein, the grating having at least one refractive index pitch superimposed at a common location effective to provide an optical code therein, the grating providing an output optical signal when illuminated by an incident light signal, the optical output signal being indicative of the code in the coding element;
b) binding first nucleotide reagent to a surface of each of the one or more optical substrates; and
c) extending the nucleotide sequence on each substrate by sequential addition reactions;
   thereby synthesizing one polynucleotide, or a library of polynucleotides, respectively, bound to the articles.
   In some greater detail, additional steps for synthesizing a polynucleotide library include
a′) in step a) above, maintaining a first optical substrate bearing a first code separate from a second substrate bearing a second code, and
b′) in steps b) and c) above, synthesizing a first polynucleotide on the first optical substrate and a second polynucleotide on the second optical substrate

In an alternative synthetic procedure for preparing a coded polynucleotide reagent article, or a coded polynucleotide reagent library, the following steps may be employed:
a) providing a one or more diffraction grating-based encoded elements, wherein each encoded element includes
   i) an optical substrate having at least one surface, and
   ii) an optical coding element containing at least one diffraction grating disposed therein, the grating having at least one refractive index pitch superimposed at a common location effective to provide an optical code therein, the grating providing an output optical signal when illuminated by an incident light signal, the optical output signal being indicative of the code in the coding element; and
b) binding a polynucleotide to a surface of each of the one or more optical substrates.

Oligosaccharide components of biological macromolecules may be synthesized using the encoded reagent-bearing articles of the invention. There are very many ramified structures of complex carbohydrates that may be potentially synthesized. The coded particles of the invention are highly advantageous, therefore, in creating oligosaccharide libraries. Nonlimiting examples describing synthetic protocols available for oligosaccharide synthesis include Adinolfi, M., Barone, G., De Napoli, L., ladonisi, A., and Piccialli, G., Solid Phase Synthesis of Oligosaccharides, Tet. Lett.,1996, 37, 5007-5010; Seeberger, P. H., Haase, W.-C., Solid-Phase Oligosaccharide Synthesis and Combinatorial Carbohydrate Libraries, Chem. Rev. 2000, 100, 4349-4394; Plante, O. J., Palmacci, E. R., Seeberger, P. H., Automated Solid-Phase Synthesis of Oligosaccharides, Science 2001, 291, 1523-1527; and Plante, O. J., Palmacci, E. R., Andrade, R. B., Seeberger, P. H., Oligosaccharide Synthesis Using Glycosyl Phosphate and Dithiophosphate Triesters as Glycosylating Agents, J. Am. Chem. Soc. 2001, 123, 9545-9554.

Since each particle is encoded, multiplexed chemical syntheses may be carried out simultaneously, providing a plurality of new chemical products bound to uniquely encoded particles. Thus each code corresponds uniquely to a particular chemical compound. High complexity combinatorial libraries may be prepared in this way using a large number of encoded reagent-bearing articles, including digitally encoded particles, of the invention. For example, a digitally encoded oligonucleotide library is synthesized by using a plurality of digitally encoded particles as substrates in the synthetic steps, and tracking each encoded particle as it proceeds through the various nucleotide addition steps. In this way, each particle bearing a unique digital code is identified as bearing an oligonucleotide having a particular sequence.

Use of Reagent-Bearing Articles in Assays

Referring to FIGS. 3-8, the substrate 10 of the diffraction grating-based encoded element (or microbead) 8 may be functionalized by coating or attaching a desired probe 76, such as a compound, chemical or molecule, which is then used in an assay as an attractant for certain complimentary compounds, chemicals or molecules, otherwise known as a “target” analyte 52-54 (see FIG. 6). This capability to uniquely encode a large number of microbeads 8 with a corresponding unique probe 76 attached thereto enables these functionalized microbeads 72 to be mixed with unknown “target” analytes 52-54 to perform a multiplexed experiment. The procedure 40 for performing such a multiplexed assay or experiment includes the steps of producing (step 42) the microbead 8, as described hereinbefore, and functionalizing (step 44) the substrate 10 of the microbead 8 by coating/depositing/growing it with a probe 76 that will react in a predetermined way with “target” analytes 52-54. An assay is then performed (step 46) with a plurality of functionalized microbeads 72 with different identification codes 58 at the same time. In step 48, the fluorescence of the functionalized microbeads 72 is analyzed, and the functionalized microbead 72 is read to determine the code 58 thereof to thereby determine which “target” analytes 5-54 are present in the solution 60.

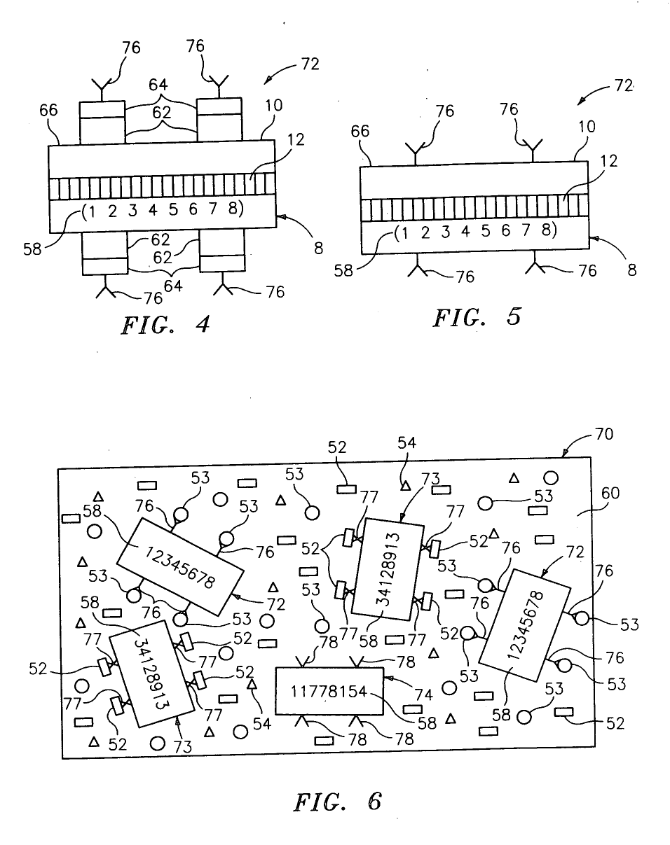

In FIGS. 4 and 5, a functionalized microbead 72 is shown, wherein the substrate 10 of the microbead 8 is coated with a probe 76 and used in an assay or as an attractant for certain “target” analytes 52-54 (see FIG. 6). In one embodiment shown in FIG. 4, the microbead 8 is coated with a linker molecule or complex 62 as is known in the art. A molecular group 64 is attached to the probe 76 to enable the probe to be bonded to the linker molecule or complex 62, and thus to the microbead 8 to form the functionalized microbead 72. The probe 76 may include one of an Oligonucleotides (oligos), antibodies, peptides, amino acid strings, cDNA, RNA, chemicals, nucleic acid oligomers, polymers, biological cells, or proteins. For example, the probe 76 may comprise a single strand of DNA (or portion thereof) and the “target” analyte 52-54 comprises at least one unknown single strand of DNA, wherein each different “target” analyte has a different DNA sequence.

In some instances as shown in FIG. 5, the probe 76 may be attached directly to the substrate 10 of the microbead 8, or directly synthesized (or grown) thereon, such as via phosphoramidite chemistry. Examples of surface chemistry for the functionalized microbeads 72 include Streptavidin/biotinylated oligos and Aldehyde/amine modified oligos. Further, the microbead may be coated with a blocker of non-specific binding (e.g., salmon sperm DNA) to prevent bonding of analytes 52-54 (e.g. DNA) to the non-functionalized surface 66 of the functionalized microbeads 72.

Referring to FIG. 6, an assay is performed by adding a solution 60 of different types of “target” analytes 52-54 into a cell or container 70 having a plurality of functionalized microbeads 72-74 disposed therein. As discussed in step 46 of FIG. 3, the functionalized microbeads 72-74 placed in the cell 70 have different identification codes 58 that correspond to unique probes 76-78 bonded thereto. For example, all functionalized microbeads 72 disposed within the cell 70 having an identification code of 12345678 is coated with a unique probe 76. All functionalized microbeads 73 disposed within the cell 72 having an identification code of 34128913 is coated with a unique probe 77. All functionalized microbeads 77 disposed within the cell 70 having an identification code of 11778154 is coated with a unique probe 78.

The “target” analytes 52-54 within the solution 60 are then mixed with the functionalized microbeads 72-74. During the mixing of the “target” analytes 52-54 and the functionalized microbeads 72-74, the “target” analytes attach to the complementary probes 76-78, as shown for functionalized microbeads 72,73 having codes 12345678 and 34128913. Specifically, as shown in FIG. 6, “target” analytes 53 bonded with probes 76 of the functionalized microbeads 72 having the code 12345678, and “target” analytes 52 bonded with probes 77 of the functionalized microbeads 73 having the code 34128913. On the other hand, “target” analytes 54 did not bond with any probes, and not “target” analytes 52-54 in the solution 60 bonded with probes 78 of the functionalized microbeads 74 having the code 11778154. Consequently, knowing which “target” analytes attach to which probes along with the capability of identifying each probe by the encoded microbead, the results of the assay would show that the unknown “target” analytes in the solution 60 includes “target” analytes 53, 54, as will be described in further detail.

For example as discussed hereinbefore, each coded functionalized microbead 72-74 has a unique probe 76-78, respectively bonded thereto, such as a portion of a single strand of DNA. Similarly, the “target” analytes 52-54 comprise a plurality of unknown and unique single strands of DNA. These “target” analytes 52-54 are also processed with a fluorescent, such as dyeing, such that the test molecules illuminate. As will be discussed hereinafter, the fluorescence of the “target” analytes provide the means to identify, which functionalized microbeads 72-74 have a “target” analyte attached thereto.

Once the reaction or combining is complete, the functionalized microbeads 72-74 are rinsed off with a saline solution to clean off the uncombined “target” analytes 52-54. As shown in FIG. 7, the functionalized microbeads 72-74 may be placed in a tray 84 with grooves 82 to allow the functionalized microbeads to be aligned in a predetermined direction, such as that described in U.S. patent application Ser. No. (Cidra Docket No. CC-0648), filed contemporaneously, which is incorporated herein by reference. The grooves 82 may have holes (not shown) that provide suction to keep the functionalized microbeads in position. Once aligned in the tray 84, the functionalized microbeads 52-54 are individually scanned and analyzed by the bead detector 20.

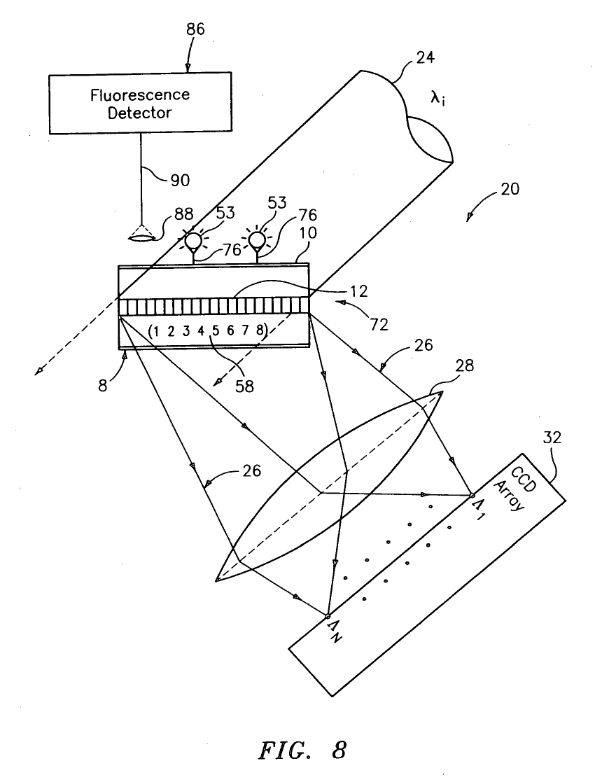

As best shown in FIG. 8, each functionalized microbead 72-74 is detected for fluorescence and analyzed to determine the identification code 58 of the functionalized microbeads. A light source (not shown) may be provided to luminate the microbeads 72-74. Once the fluorescent microbeads 72-74 are identified and knowing which probe 76-78 (or single strand of DNA) was attached to each coded, functionalized microbead 72-74, the bead detector 20 determines which “target” analytes 52-54 were present in the solution 60. As described hereinbefore, the bead detector 20 illuminates the functionalized microbeads 72-74 and focuses light 26 reflected by the diffraction grating 12 onto a CCD array or camera 32, whereby the code 58 of the functionalized microbead 72-74 is determined. Secondly, the bead detector 20 includes a fluorescence detector 86 for measuring the fluorescence emanating from “target” analytes 52-54 attached to the probes 76-78. The fluorescence meter 86 includes a lens 88 and optical fiber 90 for receiving and providing the fluorescence from the “target” analyte 52-54 to the fluorescence meter.

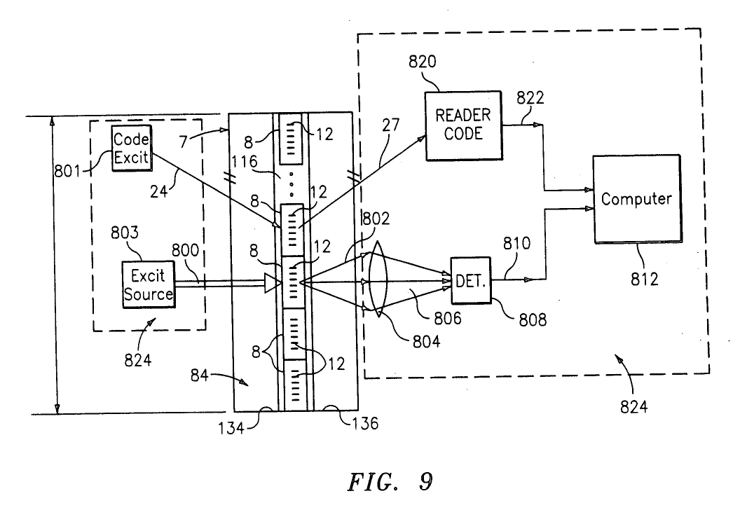

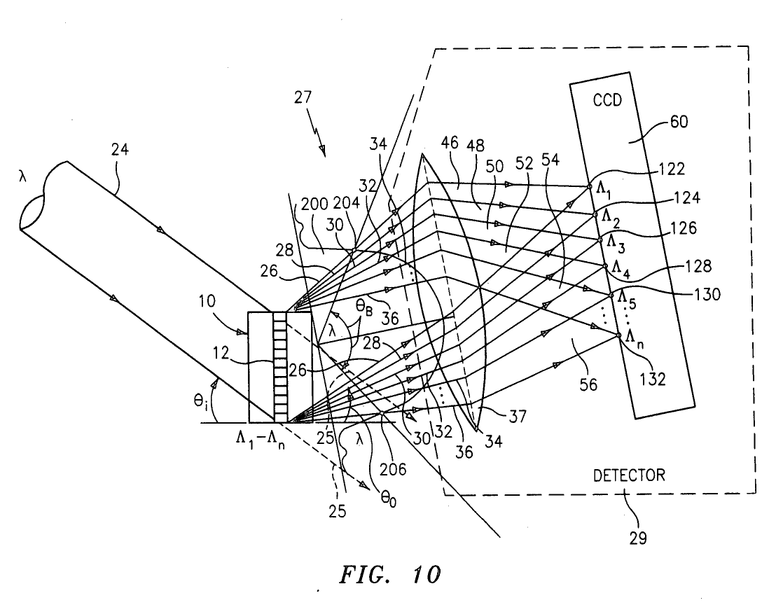

Referring to FIG. 9, more specifically, the codes in the microbeads 8 are detected when illuminated by incident light 24 which produces a diffracted or output light signal 27 to a reader 820, which includes the optics and electronics necessary to read the codes in each bead 8, as described herein and/or in the aforementioned copending patent application. The reader 820 provides a signal on a line 822 indicative of the code in each of the bead 8. The incident light 24 may be directed transversely from the side of the tray 84 (or from an end or any other angle) with a narrow band (single wavelength) and/or multiple wavelength source, in which case the code is represented by a spatial distribution of light and/or a wavelength spectrum, respectively, as described hereinafter and in the aforementioned copending patent application. Other illumination, readout techniques, types of gratings, geometries, materials, etc. may be used for the microbeads 8, as discussed hereinafter and in the aforementioned patent application.

For assays that use fluorescent molecule markers to label or tag chemicals, an optical excitation signal 800 is incident on the microbeads 8 through the tray 84 and a fluorescent optical output signal 802 emanates from the beads 8 that have the fluorescent molecule attached. The fluorescent optical output signal 802 passes through a lens 804, which provides focused light 802 to a known optical fluorescence detector 808. Instead of or in addition to the lens 802, other imaging optics may be used to provide the desired characteristics of the optical image/signal onto the fluorescence detector 808. The detector 808 provides an output signal on a line 810 indicative of the amount of fluorescence on a given bead 8, which can then be interpreted to determine what type of chemical is attached to the bead 10.

The tray 84 is made of glass or plastic or any material that is transparent to the code reading incident beam 24 and code reading output light beams 27 as well as the fluorescent excitation beam 800 and the output fluorescent optical signal 802, and is properly suited for the desired application or experiment, e.g., temperature range, harsh chemicals, or other application specific requirements.

The code signal 822 from the bead code reader 820 and the fluorescent signal 810 from the fluorescence detector are provided to a known computer 812. The computer reads the code associated with each bead and determines the chemical probe that was attached thereto from a predetermined table that correlates a predetermined relationship between the bead code and the attached probed. In addition, the computer 812 and reads the fluorescence associated with each bead and determines the sample or analyte that is attached to the bead from a predetermined table that correlates a predetermined relationship between the fluorescence tag and the analyte attached thereto. The computer 812 then determines information about the analyte and/or the probe as well as about the bonding of the analyte to the probe, and provides such information on a display, printout, storage medium or other interface to an operator, scientist or database for review and/or analysis. The sources 801, 803 the code reader 820, the fluorescence optics 804 and detector 808 and the computer 812 may all be part of an assay stick reader 824.

Alternatively, instead of having the code excitation source 801 and the fluorescence excitation source 803, the reader 24 may have only one source beam which provides both the reflected optical signal 27 for determining the code and the fluorescence signal 802 for reading the tagged analyte attached to the beads 8. In that case the input optical signal is a common wavelength that performs both functions simultaneously, or sequentially, if desired.

Generally, the assay of the present invention may be used to carry out any binding assay or screen involving immobilization of one of the binding agents. Such solid-phase assays or screens are well known in the chemical and biochemical arts. For example, such screening may involve specific binding of cells to a molecule (e.g. an antibody or antigen) immobilized on a microbead in the assay stick followed by analysis to detect whether or to what extent binding occurs. Alternatively, the beads may subsequently removed from the assay stick for sorting and analysis via flow cytometry (see e.g. by Needels et al. (1993). Examples of biological compounds that may be assayed or screened using the assay stick of the present invention include, e.g. agonists and antagonists for cell membrane receptors, toxins, venoms, viral epitopes, hormones, sugars, cofactors, peptides, enzyme substrates, drugs inclusive of opiates and steroids, proteins including antibodies, monoclonal antibodies, antisera reactive with specific antigenic determinants, nucleic acids, lectins, polysaccharides, cellular membranes and organelles. In addition, the present invention may be used in any of a large number of well-known hybridization assays where nucleic acids are immobilized on a surface of a substrate, e.g. genotyping, polymorphism detection, gene expression analysis, fingerprinting, and other methods of DNA- or RNA-based sample analysis or diagnosis.

Any of the great number of isotopic and non-isotopic labeling and detection methods well-known in the chemical and biochemical assay art may be used to detect binding with the present invention. Alternatively, spectroscopic methods well-known in the art may be used to determine directly whether a molecule is bound to a surface coating in a desired configuration. Spectroscopic methods include e.g., UV-VIS, NMR,EPR, IR, Raman, mass spectrometry and other methods well-known in the art. For example, mass spectrometry also is now widely employed for the analysis of biological macromolecules. The method typically involves immobilization of a protein on a surface of substrate where it is then exposed to a ligand binding interaction. Following ligand binding (or non-binding) the molecule is desorbed from the surface and into a spectrometer using a laser (see, e.g. Merchant and Weinberger, “Recent advancements in surface-enhanced laser desorption/ionization-time of flight-mass spectrometry,” Electrophoresis 21: 1164-1177 (2000)). The microbeads in the assay stick of the present invention may be used as substrates in the mass spectrometry detection methods described above.

Various aspects of the present invention may be conducted in an automated or semi-automated manner, generally with the assistance of well-known data processing methods. Computer programs and other data processing methods well known in the art may be used to store information including e.g. microbead identifiers, probe sequence information, sample information, and binding signal intensities. Data processing methods well known in the art may be used to read input data covering the desired characteristics.

The invention may be used in many areas such as drug discovery, functionalized substrates, biology, proteomics, combinatorial chemistry, DNA analysis/tracking/sorting/tagging, as well as tagging of molecules, biological particles, matrix support materials, immunoassays, receptor binding assays, scintillation proximity assays, radioactive or non-radioactive proximity assays, and other assays, (including fluorescent, mass spectroscopy), high throughput drug/genome screening, and/or massively parallel assay applications. The invention provides uniquely identifiable beads with reaction supports by active coatings for reaction tracking to perform multiplexed experiments.

Some current techniques used in combinatorial chemistry or biochemistry are described in U.S. Pat. No. 6,294,327, entitled “Particle and Method for Detecting Samples Labeled With Material Having Strong Light Scattering Properties, Using Reflection Mode Light and Diffuse Scattering”, issued Sep. 23, 2001 to Walton et al.; U.S. Pat. No. 6,242,180, entitled “Computer Aided Visualization and Analysis System for Sequence Evaluation”, issued Jun. 5, 2001, to Chee; U.S. Pat. No. 6,309,823 entitled “Arrays of Nucleic Acid Probes for Analyzing Biotransformation of Genes and Methods of Using the Same”, Oct. 30, 2001, to Cronin et al.; U.S. Pat. No. 6,440,667, entitled “Analysis of Target Molecules Using an Encoding System”; U.S. Pat. No. 6,355,432, entitled “Products for Detecting Nucleic Acids”; U.S. Pat. No. 6,197,506, entitled “Method of Detecting Nucleic Acids”; U.S. Pat. No. 6,309,822, entitled “Method for comparing copy number of nucleic acid sequences”; U.S. Pat. No. 5,547,839, entitled “Sequencing of surface immobilized polymers utilizing micro-fluorescence detection”, U.S. Pat. No. 6,383,754, entitled “Binary Encoded Sequence Tags”, and U.S. Pat. No. 6,383,754, entitled “Fixed Address Analysis of Sequence Tags”, which are all incorporated herein by reference to the extent needed to understand the present invention.

The invention can be used in combinatorial chemistry, active coating and functionalized polymers, as well as immunoassays, and hybridization reactions. The invention enables millions of parallel chemical reactions, enable large-scale repeated chemical reactions, increase productivity and reduce time-to-market for drug and other material development industries.

As discussed hereinbefore, although a fluorescent label is probably most convenient, other sorts of labels, e.g., radioactive, enzyme linked, optically detectable, or spectroscopic labels may be used. An appropriate detection method applicable to the selected labeling method can be selected. Suitable labels include radionucleotides, enzymes, substrates, cofactors, inhibitors, magnetic particles, heavy metal atoms, and particularly fluorescers, chemiluminescers, and spectroscopic labels. Patents teaching the use of such labels include U.S. Pat. Nos. 3,817,837; 3,850,752; 3,939,350; 3,996,345; 4,277,437; 4,275,149; and 4,366,241.

With an appropriate label selected, the detection system best adapted for high resolution and high sensitivity detection may be selected. As indicated above, an optically detectable system, e.g., fluorescence or chemilumnescence would be preferred but is not required. Other detection systems may be adapted to the purpose, e.g., electron microscopy, scanning electron microscopy (SEM), scanning tunneling electron microscopy (STEM), infrared microscopy, atomic force microscopy (AFM), electrical conductance, and image plate transfer.

Optical Particle

As described above, a significant embodiment of an optical particle of the invention is represented in FIG. 1, which shows a diffraction grating-based diffraction grating-based encoded element 8 (or encoded element or coded element) comprises a known optical substrate 10, having an optical diffraction grating 12 disposed (or written, impressed, embedded, imprinted, etched, grown, deposited or otherwise formed) in the volume of or on a surface of a substrate 10. The grating 12 is a periodic or aperiodic variation in the effective refractive index and/or effective optical absorption of at least a portion of the substrate 10. Certain features of the diffraction grating-based encoded element have been set forth above. Additional attributes of the particle, the optical diffraction grating, and principles and mode of use thereof are presented in the following.

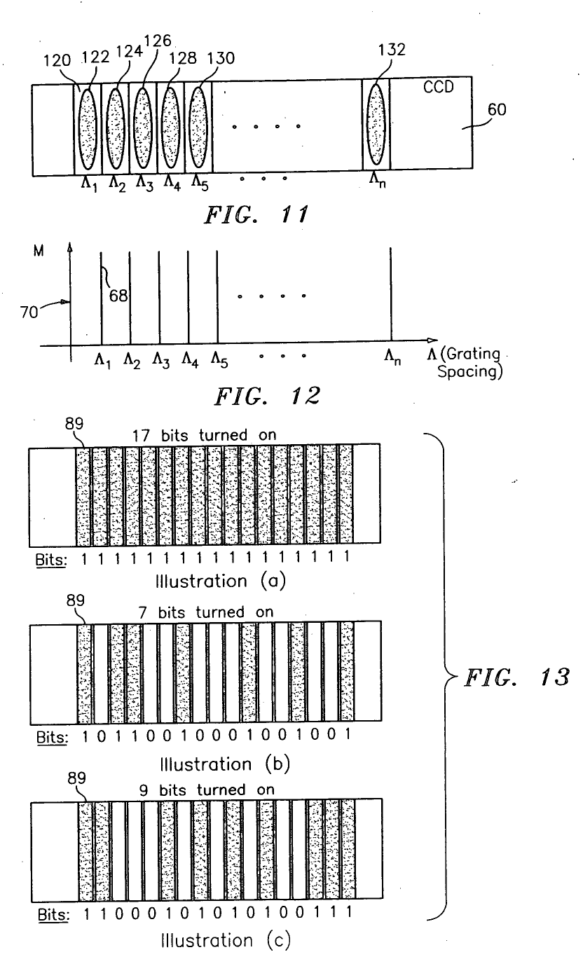

Referring to FIG. 10, The reflected light 27, comprises a plurality of beams 26-36 that pass through a lens 37, which provides focused light beams 46-56, respectively, which are imaged onto a CCD camera 60. The lens 37 and the camera 60, and any other necessary electronics or optics for performing the functions described herein, make up the reader 29. Instead of or in addition to the lens 37, other imaging optics may be used to provide the desired characteristics of the optical image/signal onto the camera 60 (e.g., spots, lines, circles, ovals, etc.), depending on the shape of the substrate 10 and input optical signals. Also, instead of a CCD camera other devices may be used to read/capture the output light.

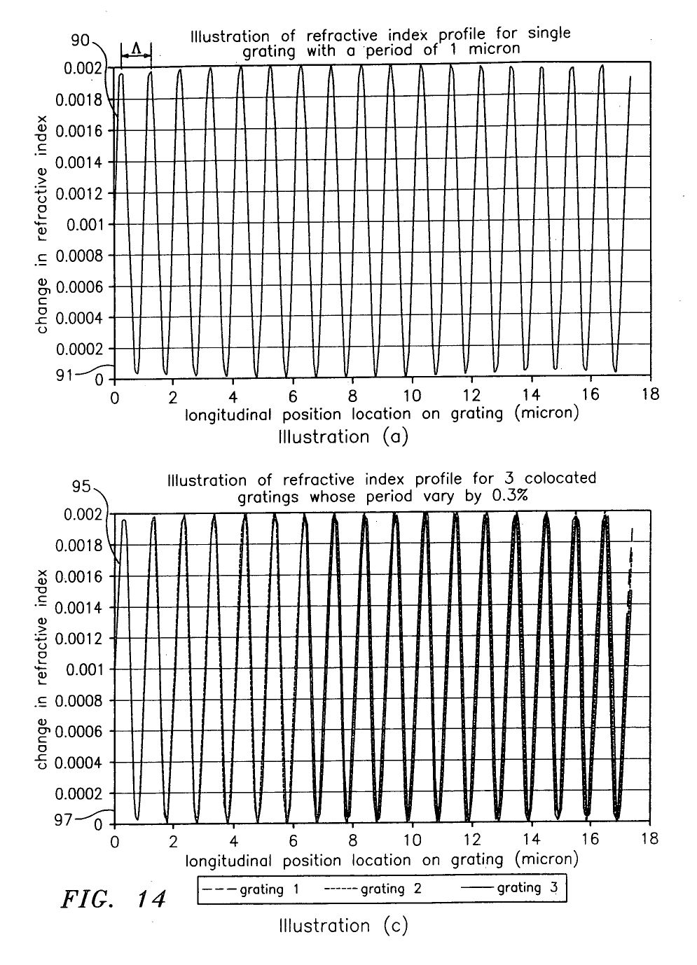

Referring to FIG. 11, the image on the CCD camera 60 is a series of illuminated stripes indicating ones and zeros of a digital pattern or code of the grating 12 in the element 8. Referring to FIG. 12, lines 68 on a graph 70 are indicative of a digitized version of the image of FIG. 11 as indicated in spatial periods (Λ1-Λn).

Each of the individual spatial periods (Λ1-Λn) in the grating 12 is slightly different, thus producing an array of N unique diffraction conditions (or diffraction angles) discussed more hereinafter. When the element 8 is illuminated from the side, in the region of the grating 12, at an appropriate input angle, e.g., about 30 degrees, with a single input wavelength λ (monochromatic) source, the diffracted (or reflected) beams 26-36 are generated. Other input angles θi may be used if desired, depending on various design parameters as discussed herein and/or in the aforementioned patent application, and provided that a known diffraction equation (Eq. 1 below) is satisfied:
sin(θᵢ)+sin(θₒ)=mλ/nΛ Eq. 1
where Eq. 1 is diffraction (or reflection or scatter) relationship between input wavelength λ, input incident angle θi, output incident angle θo, and the spatial period Λ of the grating 12. Further, m is the “order” of the reflection being observed, and n is the refractive index of the substrate 10. The value of m=1 or first order reflection is acceptable for illustrative purposes. Eq. 1 applies to light incident on outer surfaces of the substrate 10 which are parallel to the longitudinal axis of the grating (or the k_{B} vector). Because the angles θi,θo are defined outside the substrate 10 and because the effective refractive index of the substrate 10 is substantially a common value, the value of n in Eq. 1 cancels out of this equation.

Thus, for a given input wavelength λ, grating spacing Λ, and incident angle of the input light θi, the angle θo of the reflected output light may be determined. Solving Eq. 1 for θo and plugging in m=1, gives:
θo=sin⁻¹(λ/Λ−sin(θi)) Eq. 2
For example, for an input wavelength λ=532 nm, a grating spacing Λ=0.532 microns (or 532 nm), and an input angle of incidence θi=30 degrees, the output angle of reflection will be θo=30 degrees. Alternatively, for an input wavelength λ=632 nm, a grating spacing Λ=0.532 microns (or 532 nm), and an input angle θi of 30 degrees, the output angle of reflection θo will be at 43.47 degrees, or for an input angle θi=37 degrees, the output angle of reflection will be θo=37 degrees. Any input angle that satisfies the design requirements discussed herein and/or in the aforementioned patent application may be used.

In addition, to have sufficient optical output power and signal to noise ratio, the output light 27 should fall within an acceptable portion of the Bragg envelope (or normalized reflection efficiency envelope) curve 200, as indicated by points 204,206, also defined as a Bragg envelope angle θB, as also discussed herein and/or in the aforementioned patent application. The curve 200 may be defined as:

$$I ( ki , ko ) \approx {[ KD ]}^{2} sin {c}^{2} [ \frac{( ki - ko ) D}{2} ] \qquad Eq . 3$$

where K=27πδn/λ, where, δn is the local refractive index modulation amplitude of the grating and λ is the input wavelength, sinc(x)=sin(x)/x, and the vectors kᵢ=27π cos(θi)/λ and kₒ=27π cos (θₒ)/λ are the projections of the incident light and the output (or reflected) light, respectively, onto the line 203 normal to the axial direction of the grating 12 (or the grating vector k_{B}), D is the thickness or depth of the grating 12 as measured along the line 203 (normal to the axial direction of the grating 12). Other substrate shapes than a cylinder may be used and will exhibit a similar peaked characteristic of the Bragg envelope. We have found that a value for δn of about 10⁻⁴ in the grating region of the substrate is acceptable; however, other values may be used if desired.

Rewriting Eq. 3 gives the reflection efficiency profile of the Bragg envelope as:

$$I ( ki , ko ) \approx {{[ \frac{2 π \cdot δ n \cdot D}{λ} ]}^{2} [ \frac{Sin ( x )}{x} ]}^{2} \\ where \text{:} x = ( ki - ko ) D / 2 = ( π D / λ ) * ( cos θⅈ - cos θ o ) \qquad Eq . 4$$

Thus, when the input angle θi is equal to the output (or reflected) angle θₒ (i.e., θi=θₒ), the reflection efficiency I (Eqs. 3 & 4) is maximized, which is at the center or peak of the Bragg envelope. When θi=θo, the input light angle is referred to as the Bragg angle as is known. The efficiency decreases for other input and output angles (i.e., θi≠θₒ), as defined by Eqs. 3 & 4. Thus, for maximum reflection efficiency and thus output light power, for a given grating pitch Λ and input wavelength, the angle θi of the input light 24 should be set so that the angle θo of the reflected output light equals the input angle θi.

Also, as the thickness or diameter D of the grating decreases, the width of the sin(x)/x function (and thus the width of the Bragg envelope) increases and, the coefficient to or amplitude of the sinc² (or (sin(x)/x)² function (and thus the efficiency level across the Bragg envelope) also increases, and vice versa. Further, as the wavelength λ increases, the half-width of the Bragg envelope as well as the efficiency level across the Bragg envelope both decrease. Thus, there is a trade-off between the brightness of an individual bit and the number of bits available under the Bragg envelope. Ideally, δn should be made as large as possible to maximize the brightness, which allows D to be made smaller.

From Eq. 3 and 4, the half-angle of the Bragg envelope θ_{B} is defined as:

$${θ}_{B} = \frac{ηλ}{π D sin ( {θ}_{i} )} \qquad Eq . 5$$

where η is a reflection efficiency factor which is the value for x in the sinc²(x) function where the value of sinc²(x) has decreased to a predetermined value from the maximum amplitude as indicated by points 204,206 on the curve 200.

We have found that the reflection efficiency is acceptable when η≦1.39. This value for η corresponds to when the amplitude of the reflected beam (i.e., from the sinc²(x) function of Eqs. 3 & 4) has decayed to about 50% of its peak value. In particular, when x=1.39=η, sinc²(x)=0.5. However, other values for efficiency thresholds or factor in the Bragg envelope may be used if desired.

The beams 26-36 are imaged onto the CCD camera 60 to produce the pattern of light and dark regions 120-132 representing a digital (or binary) code, where light=1 and dark=0 (or vice versa). The digital code may be generated by selectively creating individual index variations (or individual gratings) with the desired spatial periods Al-An. Other illumination, readout techniques, types of gratings, geometries, materials, etc. may be used as discussed in the aforementioned patent application.

Referring to FIG. 13, illustrations (a)-(c), for the grating 12 in a cylindrical substrate 10 having a sample spectral 17 bit code (i.e., 17 different pitches Λ1-Λ17), the corresponding image on the CCD (Charge Coupled Device) camera 60 is shown for a digital pattern of 7 bits turned on (10110010001001001); 9 bits turned on of (11000101010100111); all 17 bits turned on of (11111111111111111).

For the images in FIG. 13, the length of the substrate 10 was 450 microns, the outer diameter D1 was 65 microns, the inner diameter D was 14 microns, An for the grating 12 was about 10⁻⁴, n1 in portion 20 was about 1.458 (at a wavelength of about 1550 nm), n2 in portion 18 was about 1.453, the average pitch spacing Λ for the grating 12 was about 0.542 microns, and the spacing between pitches ΔΛ was about 0.36% of the adjacent pitches Λ.

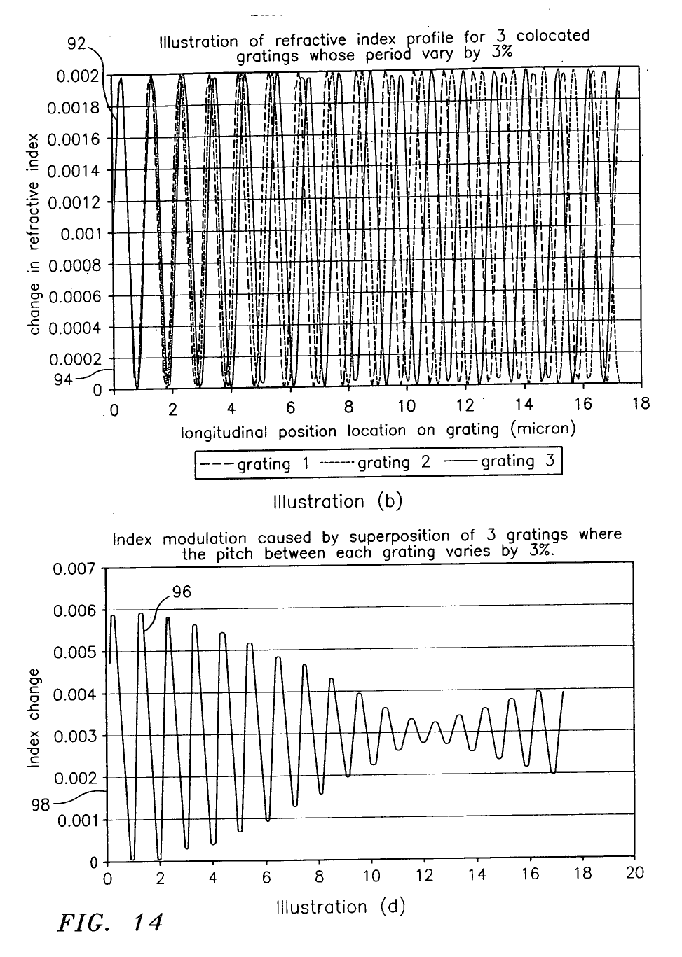

Referring to FIG. 14, illustration (a), the pitch Λ of an individual grating is the axial spatial period of the sinusoidal variation in the refractive index n1 in the region 20 of the substrate 10 along the axial length of the grating 12 as indicated by a curve 90 on a graph 91. Referring to FIG. 14, illustration (b), a sample composite grating 12 comprises three individual gratings that are co-located on the substrate 10, each individual grating having slightly different pitches, Λ1, Λ2, Λ3, respectively, and the difference (or spacing) ΔΛ between each pitch Λ being about 3.0% of the period of an adjacent pitch Λ as indicated by a series of curves 92 on a graph 94. Referring to FIG. 14, illustration (c), three individual gratings, each having slightly different pitches, Λ1, Λ2, Λ3, respectively, are shown, the difference ΔΛ between each pitch Λ being about 0.3% of the pitch Λ of the adjacent pitch as shown by a series of curves 95 on a graph 97. The individual gratings in FIG. 14, illustrations (b) and (c) are shown to all start at 0 for illustration purposes; however, it should be understood that, the separate gratings need not all start in phase with each other. Referring to FIG. 14, illustration (d), the overlapping of the individual sinusoidal refractive index variation pitches Λ1-Λn in the grating region 20 of the substrate 10, produces a combined resultant refractive index variation in the composite grating 12 shown as a curve 96 on a graph 98 representing the combination of the three pitches shown in FIG. 14, illustration (b). Accordingly, the resultant refractive index variation in the grating region 20 of the substrate 10 may not be sinusoidal and is a combination of the individual pitches Λ (or index variation).

The maximum number of resolvable bits N, which is equal to the number of different grating pitches Λ (and hence the number of codes), that can be accurately read (or resolved) using side-illumination and side-reading of the grating 12 in the substrate 10, is determined by numerous factors, including: the beam width w incident on the substrate (and the corresponding substrate length L and grating length Lg), the thickness or diameter D of the grating 12, the wavelength λ of incident light, the beam divergence angle θ_{R}, and the width of the Bragg envelope θ_{B} (discussed more in the aforementioned patent application), and may be determined by the equation:

$$N ≅ \frac{ηβ L}{2 D sin ( {θ}_{i} )} \qquad Eq . 6$$

Referring to FIG. 15, instead of having the input light 24 at a single wavelength λ (monochromatic) and reading the bits by the angle θo of the output light, the bits (or grating pitches Λ) may be read/detected by providing a plurality of wavelengths and reading the wavelength spectrum of the reflected output light signal. In this case, there would be one bit per wavelength, and thus, the code is contained in the wavelength information of the reflected output signal.

In this case, each bit (or Λ) is defined by whether its corresponding wavelength falls within the Bragg envelope, not by its angular position within the Bragg envelope 200. As a result, it is not limited by the number of angles that can fit in the Bragg envelope 200 for a given composite grating 12, as in the embodiment discussed hereinbefore. Thus, using multiple wavelengths, the only limitation in the number of bits N is the maximum number of grating pitches Λ that can be superimposed and optically distinguished in wavelength space for the output beam.

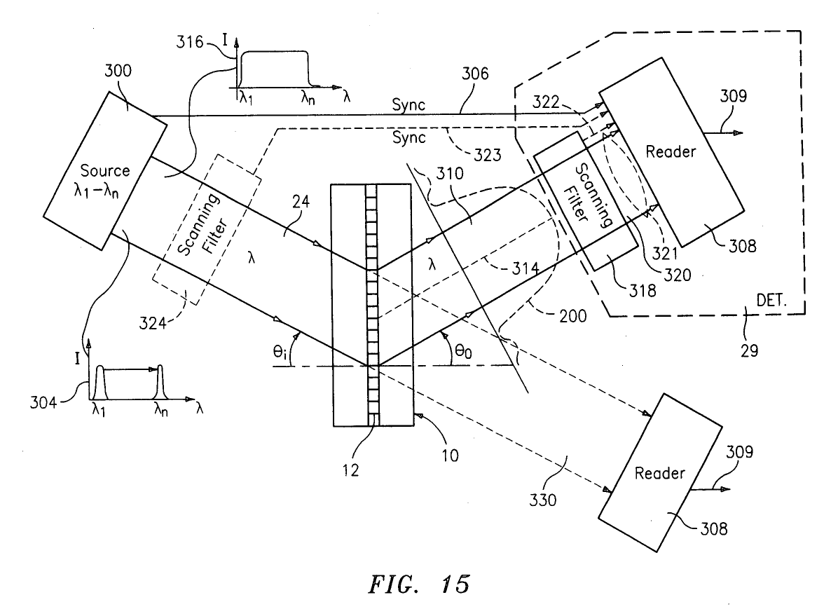

Referring to FIGS. 15 and 16, illustration (a), the reflection wavelength spectrum (λ1-λn) of the reflected output beam 310 will exhibit a series of reflection peaks 695, each appearing at the same output Bragg angle θo. Each wavelength peak 695 (λ1-λn) corresponds to an associated spatial period (Λ1-Λn), which make up the grating 12.

One way to measure the bits in wavelength space is to have the input light angle θi equal to the output light angle θo, which is kept at a constant value, and to provide an input wavelength λ that satisfies the diffraction condition (Eq. 1) for each grating pitch Λ. This will maximize the optical power of the output signal for each pitch Λ detected in the grating 12.

Referring to 16, illustration (b), the transmission wavelength spectrum of the transmitted output beam 330 (which is transmitted straight through the grating 12) will exhibit a series of notches (or dark spots) 696. Alternatively, instead of detecting the reflected output light 310, the transmitted light 330 may be detected at the detector/reader 308. It should be understood that the optical signal levels for the reflection peaks 695 and transmission notches 696 will depend on the “strength” of the grating 12, i.e., the magnitude of the index variation n in the grating 12.

In FIG. 15, the bits may be detected by continuously scanning the input wavelength. A known optical source 300 provides the input light signal 24 of a coherent scanned wavelength input light shown as a graph 304. The source 300 provides a sync signal on a line 306 to a known reader 308. The sync signal may be a timed pulse or a voltage ramped signal, which is indicative of the wavelength being provided as the input light 24 to the substrate 10 at any given time. The reader 308 may be a photodiode, CCD camera, or other optical detection device that detects when an optical signal is present and provides an output signal on a line 309 indicative of the code in the substrate 10 or of the wavelengths present in the output light, which is directly related to the code, as discussed herein. The grating 12 reflects the input light 24 and provides an output light signal 310 to the reader 308. The wavelength of the input signal is set such that the reflected output light 310 will be substantially in the center 314 of the Bragg envelope 200 for the individual grating pitch (or bit) being read.

Alternatively, the source 300 may provide a continuous broadband wavelength input signal such as that shown as a graph 316. In that case, the reflected output beam 310 signal is provided to a narrow band scanning filter 318 which scans across the desired range of wavelengths and provides a filtered output optical signal 320 to the reader 308. The filter 318 provides a sync signal on a line 322 to the reader, which is indicative of which wavelengths are being provided on the output signal 320 to the reader and may be similar to the sync signal discussed hereinbefore on the line 306 from the source 300. In this case, the source 300 does not need to provide a sync signal because the input optical signal 24 is continuous. Alternatively, instead of having the scanning filter being located in the path of the output beam 310, the scanning filter may be located in the path of the input beam 24 as indicated by the dashed box 324, which provides the sync signal on a line 323.

Alternatively, instead of the scanning filters 318,324, the reader 308 may be a known optical spectrometer (such as a known spectrum analyzer), capable of measuring the wavelength of the output light.

The desired values for the input wavelengths λ (or wavelength range) for the input signal 24 from the source 300 may be determined from the Bragg condition of Eq. 1, for a given grating spacing Λ and equal angles for the input light θi and the angle light θo. Solving Eq. 1 for λ and plugging in m=1, gives:
λ=Λ[ sin(θo)+sin(θi)] Eq. 7

It is also possible to combine the angular-based code detection with the wavelength-based code detection, both discussed hereinbefore. In this case, each readout wavelength is associated with a predetermined number of bits within the Bragg envelope. Bits (or grating pitches Λ) written for different wavelengths do not show up unless the correct wavelength is used.

Accordingly, the bits (or grating pitches Λ) can be read using one wavelength and many angles, many wavelengths and one angle, or many wavelengths and many angles.

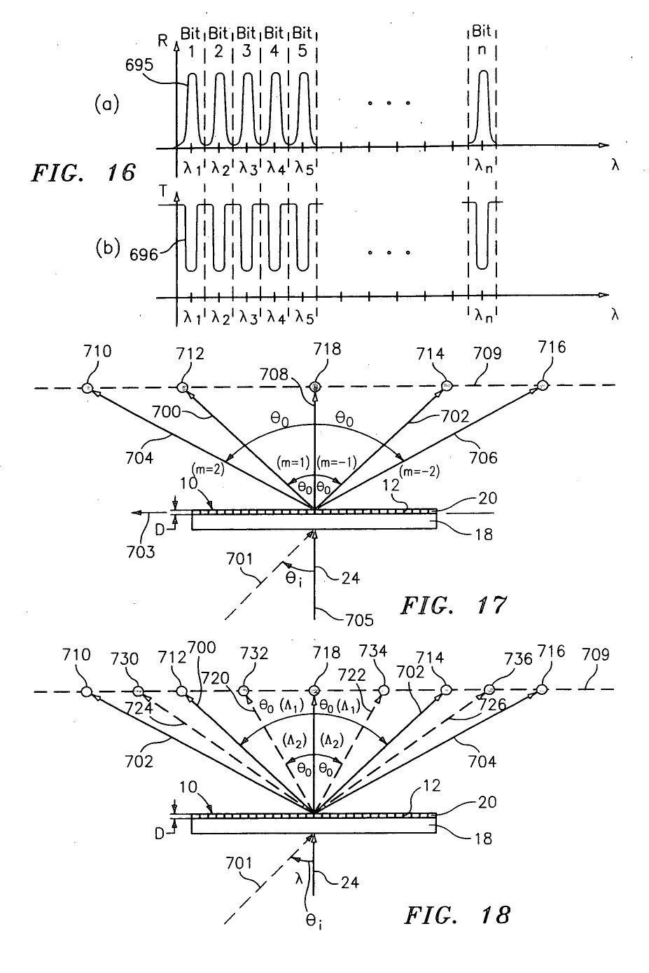

Referring to FIG. 17, the grating 12 may have a thickness or depth D which is comparable or smaller than the incident beam wavelength λ. This is known as a “thin” diffraction grating (or the full angle Bragg envelope is 180 degrees). In that case, the half-angle Bragg envelope θB is substantially 90 degrees; however, on must be made large enough to provide sufficient reflection efficiency, per Eqs. 3 and 4. In particular, for a “thin” grating, D*δn≈λ/2, which corresponds to a π phase shift between adjacent minimum and maximum refractive index values of the grating 12.

It should be understood that there is still a trade-off discussed hereinbefore with beam divergence angle θ_{R} and the incident beam width (or length L of the substrate), but the accessible angular space is theoretically now 90 degrees. Also, for maximum efficiency, the phase shift between adjacent minimum and maximum refractive index values of the grating 12 should approach a π phase shift; however, other phase shifts may be used.

In this case, rather than having the input light 24 coming in at the conventional Bragg input angle θi, as discussed hereinbefore and indicated by a dashed line 701, the grating 12 is illuminated with the input light 24 oriented on a line 705 orthogonal to the longitudinal grating vector 705. The input beam 24 will split into two (or more) beams of equal amplitude, where the exit angle θₒ can be determined from Eq. 1 with the input angle θᵢ=0 (normal to the longitudinal axis of the grating 12).

In particular, from Eq. 1, for a given grating pitch ζ1, the ±1^{st} order beams (m=+1 and m=−1), corresponds to output beams 700,702, respectively. For the ±2^{nd} order beams (m=+2 and m=−2), corresponds to output beams 704,706, respectively. The 0^{th} order (undiffracted) beam (m=0), corresponds to beam 708 and passes straight through the substrate. The output beams 700-708 project spectral spots or peaks 710-718, respectively, along a common plane, shown from the side by a line 709, which is parallel to the upper surface of the substrate 10.

For example, for a grating pitch Λ=1.0 um, and an input wavelength λ=400 nm, the exit angles θₒ are ±23.6 degrees (for m=±1), and ±53.1 degrees (from m=±2), from Eq. 1. It should be understood that for certain wavelengths, certain orders (e.g., m =±2) may be reflected back toward the input side or otherwise not detectable at the output side of the grating 12.

Alternatively, one can use only the ±1^{st} order (m=±1) output beams for the code, in which case there would be only 2 peaks to detect, 712, 714. Alternatively, one can also use any 20 one or more pairs from any order output beam that is capable of being detected. Alternatively, instead of using a pair of output peaks for a given order, an individual peak may be used.

Referring to FIG. 18, if two pitches Λ1,Λ2 exist in the grating 12, two sets of peaks will exist. In particular, for a second grating pitch Λ2, the ±1^{st} order beams (m=+1 and m=−1), corresponds to output beams 720,722, respectively. For the ±2^{nd} order beams (m=+2 and m=−2), corresponds to output beams 724,726, respectively. The 0^{th} order (undiffracted) beam (m=0), corresponds to beam 718 and passes straight through the substrate. The output beams 720-726 corresponding to the second pitch Λ2 project spectral spots or peaks 730-736, respectively, which are at a different location than the point 710-716, but along the same common plane, shown from the side by the line 709.

Thus, for a given pitch Λ (or bit) in a grating, a set of spectral peaks will appear at a specific location in space. Thus, each different pitch corresponds to a different elevation or output angle which corresponds to a predetermined set of spectral peaks. Accordingly, the presence or absence of a particular peak or set of spectral peaks defines the code.

In general, if the angle of the grating 12 is not properly aligned with respect to the mechanical longitudinal axis of the substrate 10, the readout angles may no longer be symmetric, leading to possible difficulties in readout. With a thin grating, the angular sensitivity to the alignment of the longitudinal axis of the substrate 10 to the input angle θi of incident radiation is reduced or eliminated. In particular, the input light can be oriented along substantially any angle θi with respect to the grating 12 without causing output signal degradation, due the large Bragg angle envelope. Also, if the incident beam 24 is normal to the substrate 10, the grating 12 can be oriented at any rotational (or azimuthal) angle without causing output signal degradation. However, in each of these cases, changing the incident angle θi will affect the output angle θo of the reflected light in a predetermined predictable way, thereby allowing for accurate output code signal detection or compensation.

Referring to FIG. 19, for a thin grating, in addition to multiplexing in the elevation or output angle based on grating pitch Λ, the bits can also be multiplexed in an azimuthal (or rotational) angle θa of the substrate. In particular, a plurality of gratings 750,752,754,756 each having the same pitch Λ are disposed in a surface 701 of the substrate 10 and located in the plane of the substrate surface 701. The input light 24 is incident on all the gratings 750,752,754,756 simultaneously. Each of the gratings provides output beams oriented based on the grating orientation. For example, the grating 750 provides the output beams 764,762, the grating 752 provides the output beams 766,768, the grating 754 provides the output beams 770,772, and the grating 756 provides the output beams 774,776. Each of the output beams provides spectral peaks or spots (similar to that discussed hereinbefore), which are located in a plane 760 that is parallel to the substrate surface plane 701. In this case, a single grating pitch Λ can produce many bits depending on the number of gratings that can be placed at different azimuthal (rotational) angles on the surface of the substrate 10 and the number of output beam spectral peaks that can be spatially and optically resolved/detected. Each bit may be viewed as the presence or absence of a pair of peaks located at a predetermined location in space in the plane 760. Note that this example uses only the m=±1^{st} order for each reflected output beam. Alternatively, the detection may also use the m=±2^{nd} order. In that case, there would be two additional output beams and peaks (not shown) for each grating (as discussed hereinbefore) that may lie in the same plane as the plane 760 and may be on a concentric circle outside the circle 760.

In addition, the azimuthal multiplexing can be combined with the elevation or output angle multiplexing discussed hereinbefore to provide two levels of multiplexing. Accordingly, for a thin grating, the number of bits can be multiplexed based on the number of grating pitches Λ and/or geometrically by the orientation of the grating pitches.

Furthermore, if the input light angle θi is normal to the substrate 10, the edges of the substrate 10 no longer scatter light from the incident angle into the “code angular space”, as discussed herein and/or in the aforementioned patent application.

Also, in the thin grating geometry, a continuous broadband wavelength source may be used as the optical source if desired.

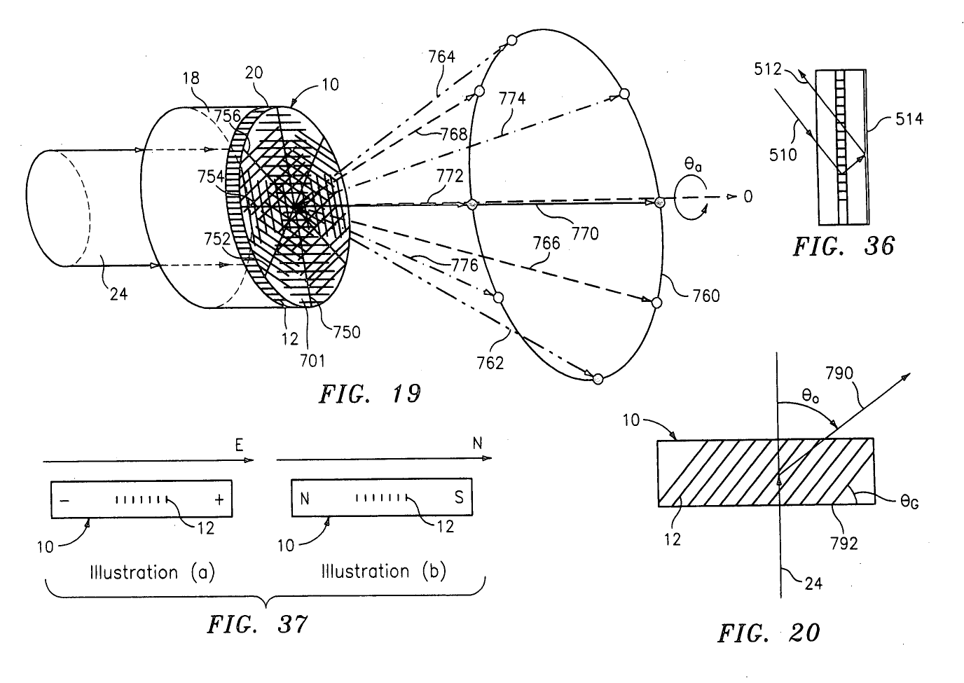

Referring to FIG. 20, instead of or in addition to the pitches Λ in the grating 12 being oriented normal to the longitudinal axis, the pitches may be created at a angle θg. In that case, when the input light 24 is incident normal to the surface 792, will produce a reflected output beam 790 having an angle θo determined by Eq. 1 as adjusted for the blaze angle θg. This can provide another level of multiplexing bits in the code.

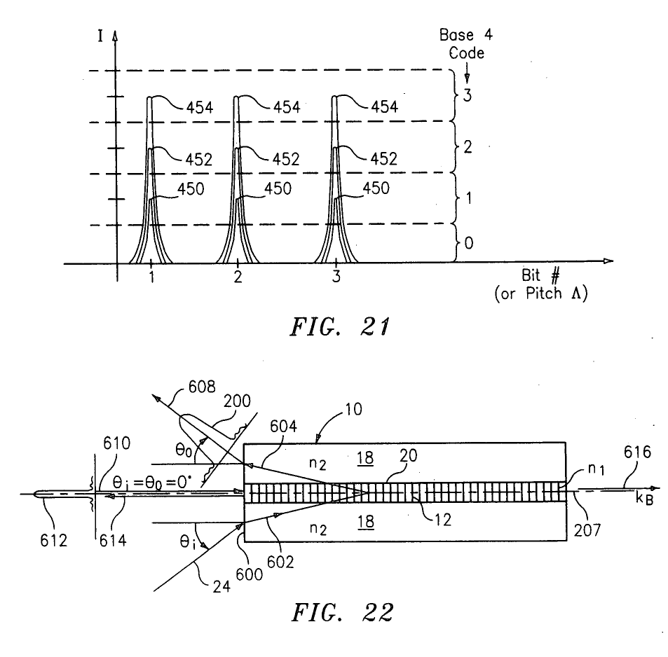

Referring to FIG. 21, instead of using an optical binary (0-1) code, an additional level of multiplexing may be provided by having the optical code use other numerical bases, if intensity levels of each bit are used to indicate code information. This could be achieved by having a corresponding magnitude (or strength) of the refractive index change (δn) for each grating pitch A. Four intensity ranges are shown for each bit number or pitch Λ, providing for a Base-4 code (where each bit corresponds to 0,1,2, or 3). The lowest intensity level, corresponding to a 0, would exist when this pitch Λ is not present in the grating 12. The next intensity level 450 would occur when a first low level δn1 exists in the grating that provides an output signal within the intensity range corresponding to a 1. The next intensity level 452 would occur when a second higher level δn2 exists in the grating 12 that provides an output signal within the intensity range corresponding to a 2. The next intensity level 452, would occur when a third higher level δn3 exists in the grating 12 that provides an output signal within the intensity range corresponding to a 3.

Referring to FIG. 22, the input light 24 may be incident on the substrate 10 on an end face 600 of the substrate 10. In that case, the input light 24 will be incident on the grating 12 having a more significant component of the light (as compared to side illumination discussed hereinbefore) along the longitudinal grating axis 207 of the grating (along the grating vector k_{B}), as shown by a line 602. The light 602 reflects off the grating 12 as indicated by a line 604 and exits the substrate as output light 608. Accordingly, it should be understood by one skilled in the art that the diffraction equations discussed hereinbefore regarding output diffraction angle θo also apply in this case except that the reference axis would now be the grating axis 207. Thus, in this case, the input and output light angles θi,θo, would be measured from the grating axis 207 and length Lg of the grating 12 would become the thickness or depth D of the grating 12. As a result, a grating 12 that is 400 microns long, would result in the Bragg envelope 200 being narrow. It should be understood that because the values of n1 and n2 are close to the same value, the slight angle changes of the light between the regions 18,20 are not shown herein.

In the case where incident light 610 is incident along the same direction as the grating vector (Kb) 207, i.e., θi=0 degrees, the incident light sees the whole length Lg of the grating 12 and the grating provides a reflected output light angle θo=0 degrees, and the Bragg envelope 612 becomes extremely narrow, as the narrowing effect discussed above reaches a limit. In that case, the relationship between a given pitch Λ in the grating 12 and the wavelength of reflection λ is governed by a known “Bragg grating” relation:
λ=2n_{eff}Λ Eq. 8
where n_{eff} is the effective index of refraction of the substrate, λ is the input (and output wavelength) and Λ is the pitch. This relation, as is known, may be derived from Eq. 1 where θi=θo=90 degrees.

In that case, the code information is readable only in the spectral wavelength of the reflected beam, similar to that discussed hereinbefore for wavelength based code reading. Accordingly, the input signal in this case may be a scanned wavelength source or a broadband wavelength source. In addition, as discussed hereinbefore for wavelength based code reading, the code information may be obtained in reflection from the reflected beam 614 or in transmission by the transmitted beam 616 that passes through the grating 12.

It should be understood that for shapes of the substrate 10 or element 8 other than a cylinder, the effect of various different shapes on the propagation of input light through the element 8, substrate 10, and/or grating 12, and the associated reflection angles, can be determined using known optical physics including Snell's Law, shown below:
nᵢₙ sin θin=nₒᵤₜ sin θout Eq. 9

where nᵢₙ is the refractive index of the first (input) medium, and nₒᵤₜ is the refractive index of the second (output) medium, and θin and θout are measured from a line 620 normal to an incident surface 622.

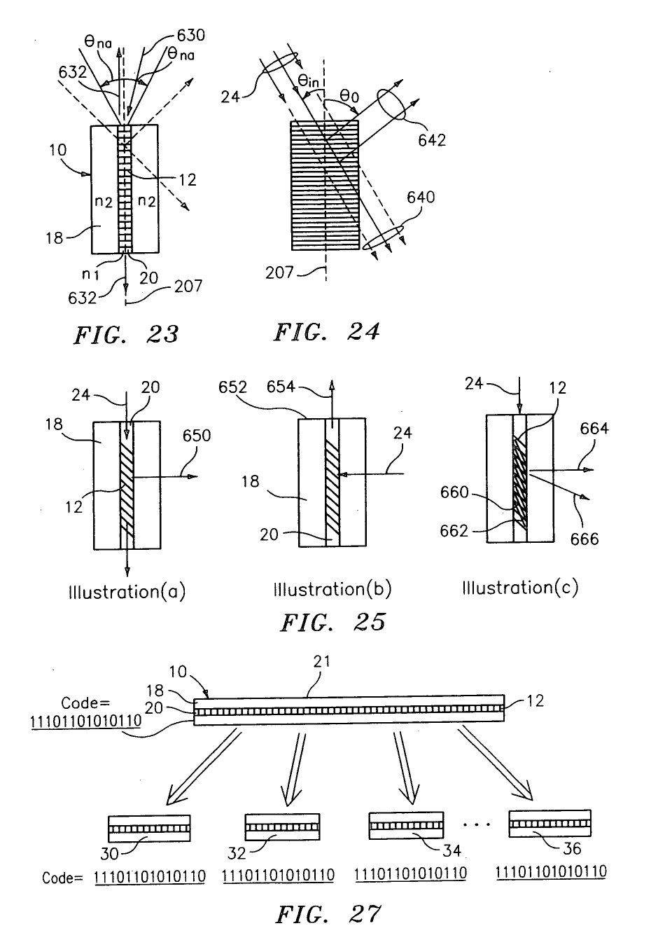

Referring to FIG. 23, if the value of n1 in the grating region 20 is greater than the value of n2 in the non-grating region 18, the grating region 20 of the substrate 10 will act as a known optical waveguide for certain wavelengths. In that case, the grating region 20 acts as a “core” along which light is guided and the outer region 18 acts as a “cladding” which helps confine or guide the light. Also, such a waveguide will have a known “numerical aperture” (θna) that will allow light that is within the aperture θna to be directed or guided along the grating axis 207 and reflected axially off the grating 12 and returned and guided along the waveguide. In that case, the grating 12 will reflect light having the appropriate wavelengths equal to the pitches Λ present in the grating 12 back along the region 20 (or core) of the waveguide, and pass the remaining wavelengths of light as the light 632. Thus, having the grating region 20 act as an optical waveguide for wavelengths reflected by the grating 12 allows incident light that is not aligned exactly with the grating axis 207 to be guided along and aligned with the grating 12 axis 207 for optimal grating reflection.

If an optical waveguide is used any standard waveguide may be used, e.g., a standard telecommunication single mode optical fiber (125 micron diameter or 80 micron diameter fiber with about a 8-10 micron diameter), or a larger diameter waveguide (greater than 0.5 mm diameter), such as is describe in U.S. patent application, Ser. No. 09/455,868, filed Dec. 6, 1999, entitled “Large Diameter Waveguide, Grating”. Further, any type of optical waveguide may be used for the optical substrate 10, such as, a multi-mode, birefringent, polarization maintaining, polarizing, multi-core, multi-cladding, or microsturctured optical waveguide, or a flat or planar waveguide (where the waveguide is rectangular shaped), or other waveguides.

Referring to FIG. 24, if the grating 12 extends across the entire dimension D of the substrate, the substrate 10 does not behave as a waveguide for the incident or reflected light and the incident light 24 will be diffracted (or reflected) as indicated by lines 642, and the codes detected as discussed hereinbefore for the end-incidence condition discussed hereinbefore with FIG. 25, and the remaining light 640 passes straight through.

Referring to FIG. 25, illustrations (a)-(c), in illustration (a), for the end illumination condition, if a blazed or angled grating is used, as discussed hereinbefore, the input light 24 is coupled out of the substrate 10 at a known angle as shown by a line 650. Referring to FIG. 25, illustration (b), alternatively, the input light 24 may be incident from the side and, if the grating 12 has the appropriate blaze angle, the reflected light will exit from the end face 652 as indicated by a line 654. Referring to FIG. 25, illustration (c), the grating 12 may have a plurality of different pitch angles 660, 662, which reflect the input light 24 to different output angles as indicated by lines 664, 666. This provides another level of multiplexing (spatially) additional codes, if desired.

Alternatively, instead of the grating 12 being impressed within the substrate material, the grating 12 may be partially or totally created by etching or otherwise altering the outer surface geometry of the substrate to create a corrugated or varying surface geometry of the substrate, such as is described in U.S. Pat. No. 3,891,302, entitled “Method of Filtering Modes in Optical Waveguides”, to Dabby et al, which is incorporated herein by reference to the extent necessary to understand the present invention, provided the resultant optical refractive profile for the desired code is created.

Further, alternatively, the grating 12 may be made by depositing dielectric layers onto the substrate, similar to the way a known thin film filter is created, so as to create the desired resultant optical refractive profile for the desired code.

The substrate 10 (and/or the element 8) may have end-view cross-sectional shapes other than circular, such as square, rectangular, elliptical, clam-shell, D-shaped, or other shapes, and may have side-view sectional shapes other than rectangular, such as circular, square, elliptical, clam-shell, D-shaped, or other shapes. Also, 3D geometries other than a cylinder may be used, such as a sphere, a cube, a pyramid or any other 3D shape. Alternatively, the substrate 10 may have a geometry that is a combination of one or more of the foregoing shapes.

The shape of the element 8 and the size of the incident beam may be made to minimize any end scatter off the end face(s) of the element 8, as is discussed herein and/or in the aforementioned patent application. Accordingly, to minimize such scatter, the incident beam 24 may be oval shaped where the narrow portion of the oval is smaller than the diameter D1, and the long portion of the oval is smaller than the length L of the element 8. Alternatively, the shape of the end faces may be rounded or other shapes or may be coated with an antireflective coating.

It should be understood that the size of any given dimension for the region 20 of the grating 12 may be less than any corresponding dimension of the substrate 10. For example, if the grating 12 has dimensions of length Lg, depth Dg, and width Wg, and the substrate 12 has different dimensions of length L, depth D, and width W, the dimensions of the grating 12 may be less than that of the substrate 12. Thus, the grating 12, may be embedded within or part of a much larger substrate 12. Also, the element 8 may be embedded or formed in or on a larger object for identification of the object.

The dimensions, geometries, materials, and material properties of the substrate 10 are selected such that the desired optical and material properties are met for a given application. The resolution and range for the optical codes are scalable by controlling these parameters as discussed herein and/or in the aforementioned patent application.

Referring to FIG. 26, the substrate 10 may have an outer coating 799, such as a polymer or other material that may be dissimilar to the material of the substrate 10, provided that the coating 799 on at least a portion of the substrate, allows sufficient light to pass through the substrate for adequate optical detection of the code. The coating 799 may be on any one or more sides of the substrate 10. Also, the coating 799 may be a material that causes the element 8 to float or sink in certain fluids (liquid and/or gas) solutions.

Also, the substrate 10 may be made of a material that is less dense than certain fluid (liquids and/or gas) solutions, thereby allowing the elements 8 to float or be buoyant or partially buoyant. Also, the substrate may be made of a porous material, such as controlled pore glass (CPG) or other porous material, which may also reduce the density of the element 8 and may make the element 8 buoyant or partially-buoyant in certain fluids.

Referring to FIG. 27, the grating 12 is axially spatially invariant. As a result, the substrate 10 with the grating 12 (shown as a long substrate 21) may be axially subdivided or cut into many separate smaller substrates 30-36 and each substrate 30-36 will contain the same code as the longer substrate 21 had before it was cut. The limit on the size of the smaller substrates 30-36 is based on design and performance factors discussed herein and/or in the aforementioned patent application.

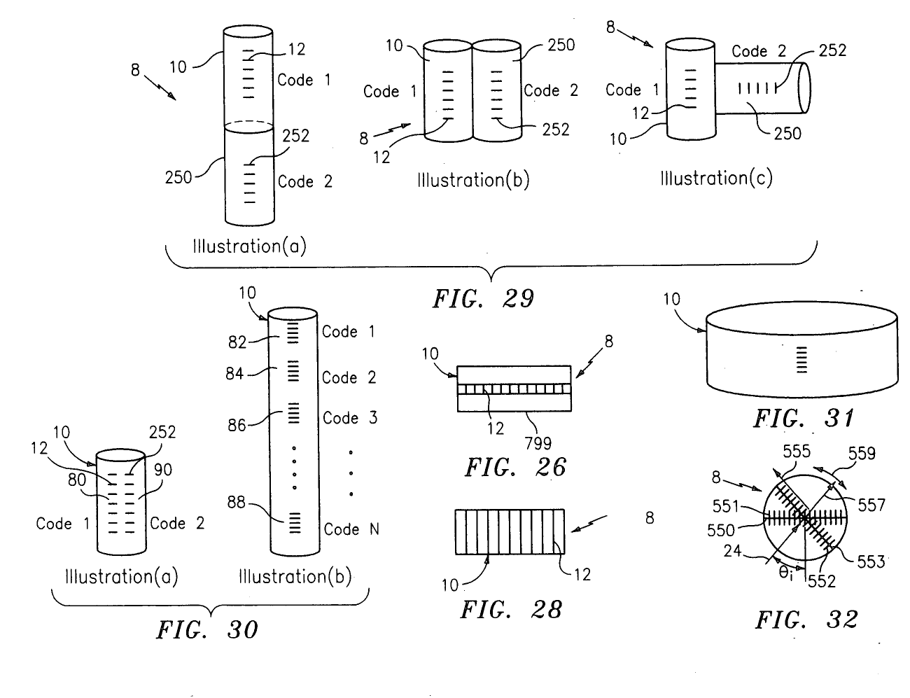

Referring to FIG. 28, one purpose of the outer region 18 (or region without the grating 12) of the substrate 10 is to provide mechanical or structural support for the inner grating region 20. Accordingly, the entire substrate 10 may comprise the grating 12, if desired. Alternatively, the support portion may be completely or partially beneath, above, or along one or more sides of the grating region 20, such as in a planar geometry, or a D-shaped geometry, or other geometries, as described herein and/or in the aforementioned patent application. The non-grating portion 18 of the substrate 10 may be used for other purposes as well, such as optical lensing effects or other effects (discussed herein or in the aforementioned patent application). Also, the end faces of the substrate 10 need not be perpendicular to the sides or parallel to each other. However, for applications where the elements 8 are stacked end-to-end, the packing density may be optimized if the end faces are perpendicular to the sides.

Referring to FIGS. 29, illustrations (a)-(c), two or more substrates 10,250, each having at least one grating therein, may be attached together to form the element 8, e.g., by an adhesive, fusing or other attachment techniques. In that case, the gratings 12,252 may have the same or different codes.

Referring to FIGS. 30, illustrations (a) and (b), the substrate 10 may have multiple regions 80,90 and one or more of these regions may have gratings in them. For example, there may be gratings 12,252 side-by-side (illustration (a)), or there may be gratings 82-88, spaced end-to-end (illustration (b)) in the substrate 10.

Referring to FIG. 31, the length L of the element 8 may be shorter than its diameter D, thus, having a geometry such as a plug, puck, wafer, disc or plate.

Referring to FIG. 32, to facilitate proper alignment of the grating axis with the angle θi of the input beam 24, the substrate 10 may have a plurality of the gratings 12 having the same codes written therein at numerous different angular or rotational (or azimuthal) positions of the substrate 10. In particular, two gratings 550, 552, having axial grating axes 551, 553, respectively may have a common central (or pivot or rotational) point where the two axes 551,553 intersect. The angle θi of the incident light 24 is aligned properly with the grating 550 and is not aligned with the grating 552, such that output light 555 is reflected off the grating 550 and light 557 passes through the grating 550 as discussed herein. If the element 8 is rotated as shown by the arrows 559, the angle θi of incident light 24 will become aligned properly with the grating 552 and not aligned with the grating 550 such that output light 555 is reflected off the grating 552 and light 557 passes through the grating 552. When multiple gratings are located in this rotational orientation, the bead may be rotated as indicated by a line 559 and there may be many angular positions that will provide correct (or optimal) incident input angles θi to the grating. While this example shows a circular cross-section, this technique may be used with any shape cross-section.

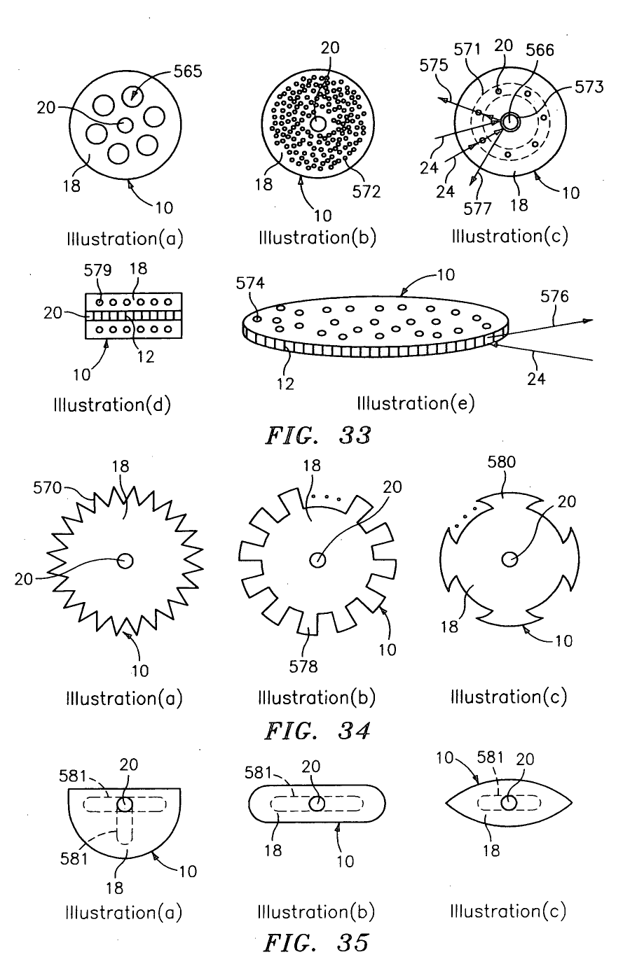

Referring to FIG. 33, illustrations (a), (b), (c), (d), and (e) the substrate 10 may have one or more holes located within the substrate 10. In illustration (a), holes 560 may be located at various points along all or a portion of the length of the substrate 10. The holes need not pass all the way through the substrate 10. Any number, size and spacing for the holes 560 may be used if desired. In illustration (b), holes 572 may be located very close together to form a honeycomb-like area of all or a portion of the cross-section. In illustration (c), one (or more) inner hole 566 may be located in the center of the substrate 10 or anywhere inside of where the grating region(s) 20 are located. The inner hole 566 may be coated with a reflective coating 573 to reflect light to facilitate reading of one or more of the gratings 12 and/or to reflect light diffracted off one or more of the gratings 12. The incident light 24 may reflect off the grating 12 in the region 20 and then reflect off the surface 573 to provide output light 577. Alternatively, the incident light 24 may reflect off the surface 573, then reflect off the grating 12 and provide the output light 575. In that case the grating region 20 may run axially or circumferentially 571 around the substrate 10. In illustration (d), the holes 579 may be located circumferentially around the grating region 20 or transversely across the substrate 10. In illustration (e), the grating 12 may be located circumferentially around the outside of the substrate 10, and there may be holes 574 inside the substrate 10.

Referring to FIG. 34, illustrations (a), (b), and (c), the substrate 10 may have one or more protruding portions or teeth 570, 578,580 extending radially and/or circumferentially from the substrate 10. Alternatively, the teeth 570, 578,580 may have any other desired shape.

Referring to FIG. 35, illustrations (a), (b), (c) a D-shaped substrate, a flat-sided substrate and an eye-shaped (or clam-shell or teardrop shaped) substrate 10, respectively, are shown. Also, the grating region 20 may have end cross-sectional shapes other than circular and may have side cross-sectional shapes other than rectangular, such as any of the geometries described herein for the substrate 10. For example, the grating region 20 may have a oval cross-sectional shape as shown by dashed lines 581, which may be oriented in a desired direction, consistent with the teachings herein. Any other geometries for the substrate 10 or the grating region 20 may be used if desired, as described herein.

Referring to FIG. 36, at least a portion of a side of the substrate 10 may be coated with a reflective coating to allow incident light 510 to be reflected back to the same side from which the incident light came, as indicated by reflected light 512.

Referring to FIG. 37, illustrations (a) and (b), alternatively, the substrate 10 can be electrically and/or magnetically polarized, by a dopant or coating, which may be used to ease handling and/or alignment or orientation of the substrate 10 and/or the grating 12, or used for other purposes. Alternatively, the bead may be coated with conductive material, e.g., metal coating on the inside of a holy substrate, or metallic dopant inside the substrate. In these cases, such materials can cause the substrate 10 to align in an electric or magnetic field. Alternatively, the substrate can be doped with an element or compound that fluoresces or glows under appropriate illumination, e.g., a rare earth dopant, such as Erbium, or other rare earth dopant or fluorescent or luminescent molecule. In that case, such fluorescence or luminescence may aid in locating and/or aligning substrates.

The dimensions and geometries for any of the embodiments described herein are merely for illustrative purposes and, as such, any other dimensions may be used if desired, depending on the application, size, performance, manufacturing requirements, or other factors, in view of the teachings herein.

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

### EXAMPLES

### Example 1

### Preparation of a Reagent Particle Having an Oligonucleotide Reagent

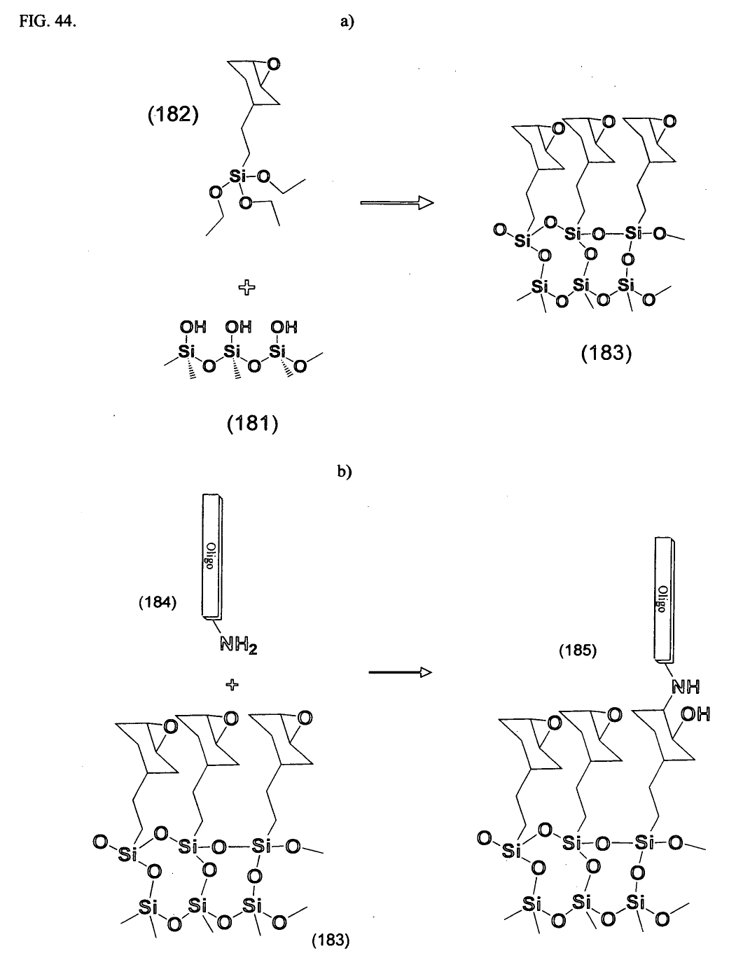

This example illustrates preparation of an oligonucleotide reagent particle using an epoxide linker to bind the oligonucleotide to the particle. As shown in FIG. 44, a silica substrate 181 is reacted with ethyl-1-cyclohexylepoxide-2-triethoxysilane 182 (2% solution in 95% ethanol, pH adjusted to 5.0 using acetic acid) at room temperature for 1 hr (FIG. 44, panel a)). The product is a silanated derivative of the silica substrate bearing pendant cyclohexyl epoxide linker moieties 183. A primary amine-derivatized generic oligonucleotide 184 having a desired sequence is reacted with the derivatized substrate 183 in aqueous buffer pH 9.5 for 1 hr (FIG. 44, panel b)) to form the vic-hydroxycyclohexyl-oligonucleotide secondary amine 185 as the product, the intended oligonucleotide reagent. The oligonucleotide reagent particle may be suspended in a suitable buffer to constitute an assay composition useful to probe for hybridizable nucleotide sequences in an assay.

### Example 2

### Preparation of a Multicomponent Article Having an Oligonucleotide Reagent

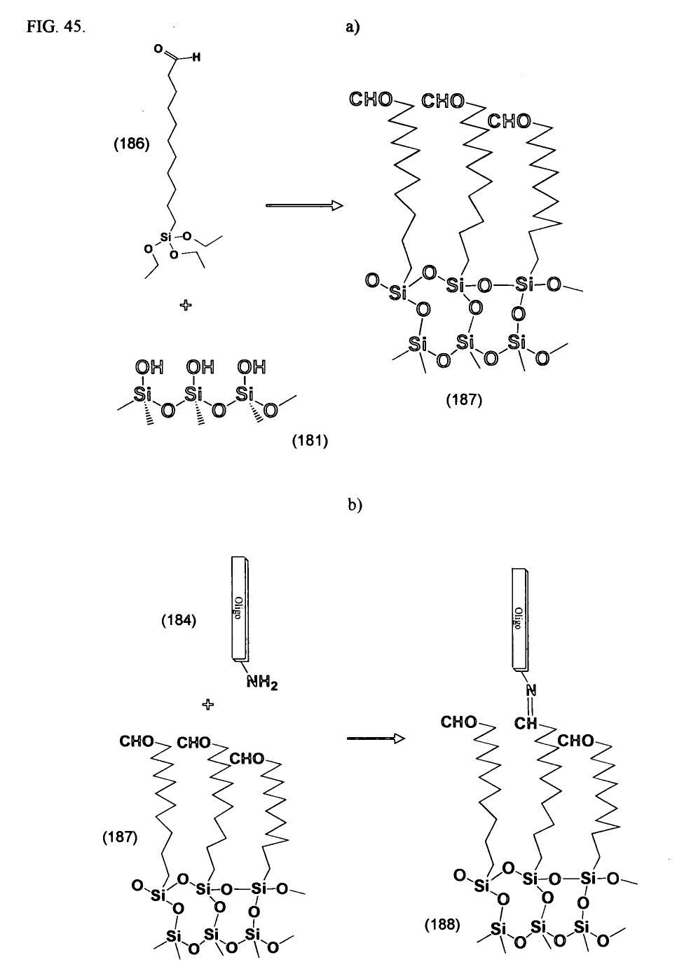

This example illustrates preparation of an oligonucleotide reagent-bearing article using an aldehyde linker to bind the oligonucleotide to a substrate. A silica substrate 181 is reacted with a normal alkyl aldehyde triethoxysilane 186 under the same conditions as in FIG. 44 (FIG. 45, panel a)). The product is a silanated derivative of the silica substrate bearing pendant normal alkyl aldehyde linker moieties 187. A primary amine-derivatized generic oligonucleotide 184 having a desired sequence is reacted with the derivatized substrate 187 in aqueous buffer pH 7.5 for 1 hr (FIG. 45, panel b)) to form the Schiff-base oligonucleotide adduct 188 as the product, the intended oligonucleotide reagent. The latter may further be stabilized by reduction of the Schiff base to form a saturated secondary amine group (not shown). The oligonucleotide reagent article may be suspended in a suitable buffer to constitute an assay composition useful to probe for hybridizable nucleotide sequences in an assay.

### Example 3

### Preparation of a Reagent Particle Having a Protected Thymidine Reagent

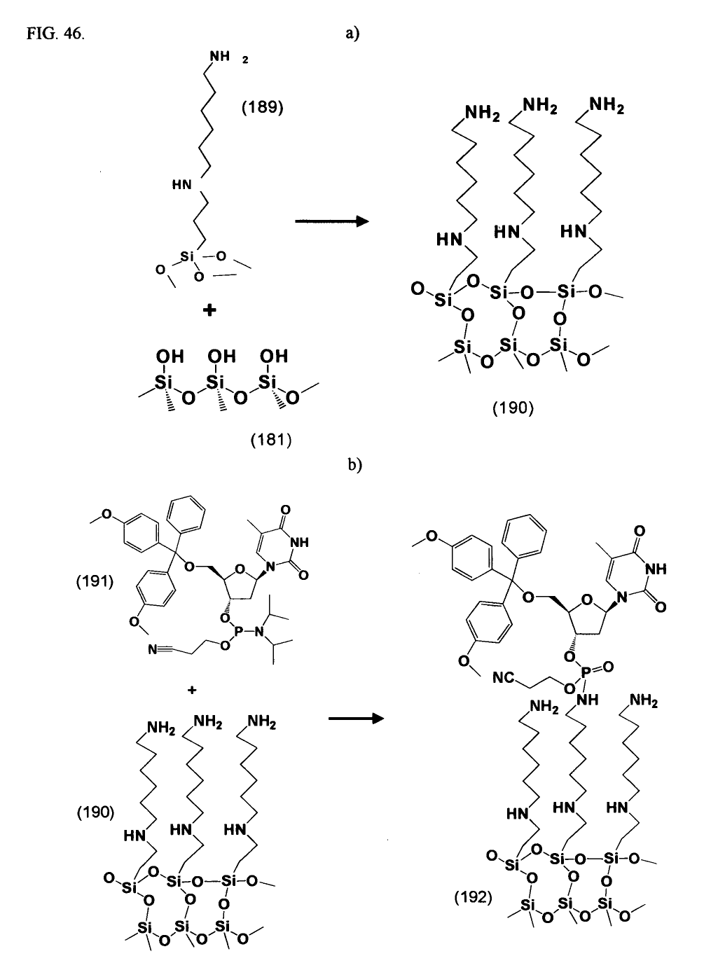

This example illustrates preparation of a nucleotide reagent particle bearing a protected thymidine derivative using an amine linker to bind the nucleotide to a particle. A silica substrate 181 is reacted with an ethylamino-N-alkylamine trimethoxysilane 189 using the same conditions as in Example 1 (FIG. 46, panel a)). Any alkylaminotrimethoxysilane or alkylaminotriethoxysilane may be used; in the embodiment shown in FIG. 46 the reagent is N-(6-aminohexyl)aminopropyl-trimethoxysilane. The product is a silanated derivative of the silica substrate bearing pendant ethylamino-N-alkylamine linker moieties 190. 0.1 M (or about 20-fold excess over linker groups) 5′-dimethoxytrityl deoxythymidine-3′-(N,N-di-isopropyl)phosphoramidite cyanoethyl ester 191 is reacted with the derivatized substrate 190 in acetonitrile in the presence of tetrazole or similar activator (5-ethylthio-1H-tetrazole; 4,5-dicyanoimidazole; 5-benzylthio-1H-tetrazole; benzimidazolium trifluoromethanesulfonate and imidazolium trifluoromethanesulfonate; 50-fold excess) (FIG. 46, panel b)) and treated to form the corresponding 5′-protected deoxythymidine ethylamino-N-alkylphosphoramidate 192 as the product, the intended deoxythymidine reagent. If desired, unreacted linker amino groups may be capped by acylation, for example by acetylation (not shown). The product may be suspended in a suitable solvent medium for use in in situ oligonucleotide synthesis employing the thymidine reagent particle.

### Example 4

### Preparation of a Multicomponent Article Having a Protected Thymidine Reagent

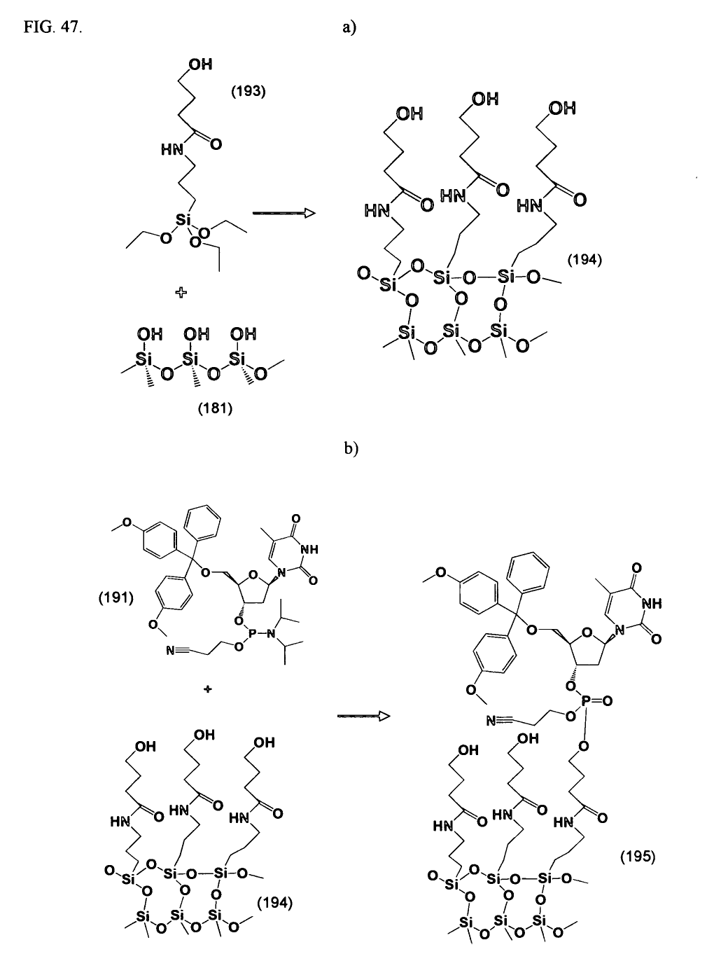

This example illustrates preparation of a nucleotide reagent-bearing article using a hydroxyl linker to bind a nucleotide to a substrate. A silica substrate 181 is reacted with N-(3-triethoxysilylpropyl)-4-hydroxybutyramide 193 using the same conditions as in Example 1 (FIG. 47, panel a)). The product is a silanated derivative of the silica substrate bearing pendant 4-hydroxybutyrylethylamido linker moieties 194. 0.1 M (or about 20-fold excess over linker groups) 5′-dimethoxytrityl deoxythymidine-3′-(N,N-di-isopropyl)phosphoramidite cyanoethyl ester 191 is reacted with the derivatized substrate 190 in acetonitrile in the presence of tetrazole or similar activator (5-ethylthio-1H-tetrazole; 4,5-dicyanoimidazole; 5-benzylthio-1H-tetrazole; benzimidazolium trifluoromethanesulfonate and imidazolium trifluoromethanesulfonate; 50-fold excess) (FIG. 47, panel b)) to form the corresponding phosphotriester; after oxidation the product is the 5′-protected deoxythymidine 4-hydroxybutyrylethylphosphate ester 195, the intended deoxythymidine reagent. If desired, unreacted linker hydroxyl groups may be capped by acylation, for example by acetylation (not shown). The thymidine reagent article may be contacted with a suitable solvent composition to serve as the starting point for in situ oligonucleotide synthesis.

### Example 5

### Attachment of an Amine Oligonucleotide on an Amine Functionalized Glass Beads with a Homobifunctionnal Crosslinker

This example illustrates preparation of an oligonucleotide reagent particle using an amine linker to bind the oligonucleotide to the particle. A silica substrate was reacted with aminopropyl triethoxysilane (2% solution in 95% ethanol, pH adjusted to 5.0 using acetic acid) at room temperature for 1 hr. The product is a silanated derivative of the silica substrate bearing pendant propylamine linker moieties.

Dithiobis-(succinimidylpropionate) (DSP; Pierce Biotechnology, Inc., Rockford, Ill.), a water-insoluble, homobifunctional N-hydroxysuccinimide ester (NHS-ester) crosslinker was dissolved in anhydrous DMSO (15.4 mg in 185 μL: 200 mM). One hundred (100) silanized beads were washed 4 times with DMSO. 10 μL of DMSO was added to the beads with 10 μL of the DSP solution. After 30 minutes, at room temperature, the beads were washed 5 times with 200 μL of anhydrous DMSO.

3′amino-oligonucleotide-5′cy3 was reconstituted in 1× PBS at a concentration of 0.1 μM. 20 μL of this solution was added to the bead overnight at room temperature. The beads were washed 3 times with 1× PBS, 3 times with ethanol and 3 time with 1× SSC, 0.1% SDS. The beads were scanned several time to verify the oligonucleotide loading and its stability. They were retrieved and used for further hybridization study.

### Example 6

### Synthesis of an Oligonucleotide Reagent Particle

A 26-nt DNA probe molecule was directly synthesized on beads bearing a particular code using standard phosphoramidite chemistry (referred to as in situ synthesis) with no post synthetic purification. The particles were cylindrically shaped glass beads, having dimensions of about 450 microns by 65 microns. About 20 to 30 beads were used. The beads were cleaned and silanized with 2% (v/v) triethoxyaminopropyl silane in ethanol/water 95/5 at pH 5.0. They were washed with ethanol, dried, and transferred into a DNA synthesizer. The beads were first derivatized with 1-[(2-cyanoethyl)-(N,N-diisopropyl)]-phosphoramidite-18-O-dimethoxytritylhexaethyleneglycol, to provide a spacer 18 atoms in length (Spacer18) using standard linker chemistry and ending with a reactive phosphoramidite The synthesizer dispensed an acetonitrile mixture of linker phosphoramidite and activator (S-ethyl tetrazol). The amino moiety of the silane, on the bead surface reacted with the resulting activated phosphoramidite (the tetrazol displace the phosphoramidite's diisopropylammonium after protonating diisipropylammonium to form a phosphoramidate, between the amine and the phosphorus of the phosphoramidite function. Then, the desired oligonucleotide sequence was grown base-by-base beginning at the 18-O-dimethoxytrityl group of Spacer 18, using standard oligonucleotide synthetic chemistry to create the respective oligonucleotide sequences. (Alternatively, the entire desired oligo sequence may be pre-synthesized and then bound to the bead after completion of the synthesis.) The product particles bearing the 26-mer oligonucleotide were used in assay compositions to probe for the presence of a hybridizable nucleotide sequence.

### Example 7

### Synthesis of a Library of Oligonucleotide Reagent Particles

A plurality of reactions as described in Example 6 was carried out in separate pieces of apparatus. About 20 to 30 beads were employed in each case. In each apparatus the particles bore a unique optical code, and an oligonucleotide with a unique 26 base sequence was synthesized on respective coded particles. The resulting collection of particles with pendant oligonucleotides constituted a coded oligonucleotide library, which was used in an assay composition to probe for particular nucleic acids that hybridize to the immobilized sequences.

### Example 8

### Synthesis of a Library of Oligonucleotide Reagent Particles

A library of eight oligonucleotides was prepared in situ following the procedures described in Examples 6 and 7. Four pairs of oligonucleotides having either 66 or 67 nucleotides, representing either sense sequences or antisense sequences of restriction fragments of bacteriophage φX-174 DNA, were prepared. This library was used in an assay composition to probe for the presence of the respective φX-174 fragments.

### Example 9

### Synthesis of a Library of Oligonucleotide Reagent Particles

A library of eleven 50-nt oligonucleotide-bearing particles was prepared by in situ synthesis. The members of the library were synthesized using the procedures described in Examples 6 and 7. The 50-mers were designed to serve as probes for a set of mouse mRNA transcripts indicated in Table 3.

TABLE 3

| | | GenBank | |
|---|---|---|---|
| | | Accession | |
| Probe Name | Short Name | Number | Gene Description |
| Rabbit bGlo- | BGlob | V00882 | Rabbit (O. cuniculus) |
| 50ac | | | beta-globin. |
| Ec16S-50ac | Ec16s | AE016767 | Escherichia coli CFT073 |
| | | | section 13 of 18 of the |
| | | | complete genome |
| Oligo Mouse | aMHC | M74751 | Mouse myosin heavy chain |
| aMHC-50ac | | | mRNA, 3 flank. |
| Oligo Mouse | ANF | K02781 | Mouse PND gene encoding |
| ANF-50ac | | | atrial natriuretic factor, |
| | | | complete CDS. |
| Oligo Mouse | bAct | X03672 | Mouse cytoskeletal mRNA |
| bACT-50ac | | | for beta-actin. |
| Oligo Mouse | bMHC | M38128 | Mouse cardiac myosin heavy |
| bMHC-50ac | | | chain beta isoform mRNA, |
| | | | 3 end. |
| Oligo Mouse | GAPD | M32599 | Mouse glyceraldehyde-3- |
| GAPD-50ac | | | phosphate dehydrogenase |
| | | | mRNA, complete CDS. |
| Oligo Mouse | LC1 | M19436 | Mouse atrial/fetal myosin |
| LC1-50ac | | | alkali light chain (Myla) |
| | | | mRNA, clone pCL10.4. |
| Oligo Mouse | LC2 | NM_010861 | Mus musculus myosin light |
| LC2-50ac | | | chain, phosphorylatable, |
| | | | cardiac ventricles |
| | | | (Mylpc), mRNA. |
| Oligo Mouse | RPL19 | NM_009078 | Mus musculus ribosomal |
| RPL19-50ac | | | protein L19 (Rp119), mRNA. |
| Oligo Mouse | Ubiq | X51703 | Mouse mRNA for ubiquitin. |
| Ubiquitin- | | | |
| 50ac | | | |

### Example 10

### Immobilization of Proteins on Particles

In this example a protein is immobilized to amino terminated particles using a protein side chain coupling reagent. In particular, the particles were cleaned and silanized with 2% (v/v) triethoxyaminopropyl silane in ethanol/water 95/5 at pH 5.0. The resulting amino terminated particles were washed 3 times with 0.1 M 2-(N-Morpholino)ethanesulfonic acid (MES), pH 4.5 to remove any residual buffer which may inhibit the reaction. Fifty (50) mg of both 1-(3-dimethylaminopropyl)-3-ethyl-carbodiimide HCl (EDC) and N-hydroxysulfosuccinimide (Sulfo-NHS) were weighed and diluted with 1.0 milliliter (ml) of 0.1M MES, pH 4.5 just before addition to particles. First 250 microliters (ul) of the Sulfo-NHS solution is added to the particles. The mixture was vortexed to resuspend particles for 2 seconds and 250 ul of the EDC mixture is added. The mixture was vortexed to resuspend particles and incubated with rocking at ambient temperature for about 60 minutes.

The particles were then separated and washed once with 0.1M MES, pH 4.5 to remove excess coupling reagent. The excess buffer was removed and a known protein was added. It is important to have the protein free of other proteins or compounds with amino groups which can bind during the coupling reaction of the protein of interest. The protein is dissolved in 0.1 M phosphate, 1× phosphate buffered saline (PBS) or any other suitable buffer at a concentration of between 1-200 ug/ml. The protein is coupled via its available carboxyl groups to the amine terminated particles by the coupling reagents, for a minimum of about 60 minutes not to exceed about 16 hours. Longer or shorter incubation time may be used providing sufficient numbers of protein molecules are attached to the particles. The protein coupled particles are washed twice with PBS-0.05% Tween-20 (PBST) to remove uncoupled protein. A final wash consists of PBS-1.0 mg/ml of Bovine Serum Albumin (BSA) to remove excess detergent and to block potential sites for non-specific binding that would interfere with subsequent use. The protein reagent particles may be suspended in a suitable medium to form an assay composition to determine whether a specific binding ligand is present in the assay medium.

### Example 11

### Immobilization of Proteins on Particles

A protein is immobilized on a particle as described in Example 10. Instead of using a coupling reagent, however, a bifunctional crosslinking agent is used to link a protein to an amino-derivatized particle. A large variety of bifunctional crosslinkers targeting amino groups, carboxyl groups, or sulfhydryl groups on a protein may be used; these are available from Pierce Biotechnology, Inc., Rockford Ill., as well as other suppliers. Examples include crosslinkers such as bis(sulfosuccinimidyl) suberate, N-succinimidyl S-acetylthioacetate, various N-hydroxysuccinimidyl-ester-maleimide crosslinkers, methyl N-succinimidyl adipate, and so forth. Reaction conditions are available from the reagent suppliers.

### Example 12

### Immobilization of Antibodies on Particles

This Example illustrates binding two antibodies to coded particles. The antibodies were raised against tumor necrosis factor-alpha (TNF-α) and recombinant interleukin-6 (IL-6). Either goat anti-TNF-α antibody or goat anti-IL-6 antibody (R & D Systems, Minneapolis, Minn.) was coupled to uniquely coded particles which had been derivatized with aminopropyl silane as described in Example 6, using EDC-NHS coupling chemistry (Example 10). The resulting particles represent a prototypical antibody library. Such libraries are useful in multiplexed immunoassays for proteins such as these and other cytokines.

### Example 13

### Immobilization of Proteins on Particles by Adsorption

Various concentrations (20, 2, and 0.2 ug/ml) of recombinant tumor necrosis factor-alpha in phosphate buffered saline (PBS), pH 7.4, were allowed to adsorb to amine functionalized digitally encoded particles overnight at 25 C. The antigen particles were washed 3 times and blocked for 1 hour with PBS containing 1% bovine serum albumin. The TNF-α-adsorbed particles are useful in immunoassays and similar assays.

Although the invention has been described and illustrated with respect to exemplary embodiments thereof, the foregoing and various other alterations, additions and omissions may be made therein and thereto without departing from the spirit and scope of the present invention.

1. A multicomponent article comprising
a) a diffraction grating-based encoded element, wherein the encoded element comprises an optical substrate having at least one surface and comprising at least one substrate material, said substrate having at least one diffraction grating disposed therein, said grating having a resultant refractive index variation at a grating location, said grating being embedded within a substantially single material of said substrate, said grating providing an output optical signal indicative of a code when illuminated by an incident light signal propagating from outside said substrate, said optical output signal being a result of passive, non-resonant scattering from said grating when illuminated by said incident light signal; and
b) a substance disposed on at least a portion of the surface of the substrate.

2. The multicomponent article described in claim 1 wherein the multicomponent article is a particle.

3. The multicomponent article described in claim 1 wherein the at least one substrate material comprises silica, a silicate, a glass, a semiconducting material, or a ceramic material.

4. The multicomponent article described in claim 1 wherein the at least one substrate material comprises a polymer, a resin, a rubber material, or a derivative thereof.

5. The multicomponent article of claim 1 wherein said refractive index variation comprises at least one refractive index pitch superimposed at said grating location.

6. The multicomponent article of claim 1 wherein said refractive index variation comprises a plurality of refractive index pitches superimposed at said grating location.

7. The multicomponent article of claim 1 wherein said code comprises a plurality of digital bits.

8. The multicomponent article of claim 1 wherein said code comprises at least a predetermined number of digital bits, said number being: 3, 5, 7, 9, 10, 12, 14, 16, 18, 20, 24, 28, 30, 40, 50, or 100.

9. The multicomponent article of claim 1 wherein said substrate has a length that is less than about 1000 microns.

10. The multicomponent article of claim 1 wherein said substrate has a width or diameter that is less than about 1000 microns.

11. The multicomponent article of claim 1 wherein said code comprises a plurality of bits, each bit having a corresponding spatial location and each bit in said code having a value related to the intensity of said output optical signal at the spatial location of each bit.

12. The multicomponent article of claim 1 wherein at least a portion of said substrate has a 3-D shape selected from the group: a cylinder, a sphere, an ellipsoid, a cube, a rectangular prism, and a pyramid.

13. The multicomponent article described in claim 1 wherein the substance is bound to the substrate with a chemical bond.

14. The multicomponent article described in claim 1 wherein the substance is bound to the substrate by noncovalent interactions.

15. The multicomponent article described in claim 1 wherein the substance is a coating disposed on at least a portion of said substrate.

16. The multicomponent article described in claim 15 wherein the coating comprises a lipid monolayer, a lipid bilayer, a gel, a polymer, or a resin.

17. The multicomponent article described in claim 15 wherein the substance further comprises a reagent bound to the coating.

18. The particle described in claim 2 wherein the substance comprises a reagent.

19. The particle described in claim 18 wherein the reagent is bound to the substrate.

20. The particle described in claim 18 wherein a single reagent is bound to a particle such that the code identifies the reagent.

21. The particle described in claim 18 wherein a plurality of reagents is bound to a particle.

22. The particle described in claim 18 wherein the reagent comprises a nucleic acid, a polynucleotide, an oligonucleotide, a nucleotide, a nucleoside, a protein nucleic acid, an oligopeptide nucleic acid, a protein or fragment thereof, an enzyme or fragment thereof, a receptor or fragment thereof, a polypeptide, an oligopeptide, an amino acid, a derivative of any of them, or a modification of any of them.

23. The particle described in claim 18 wherein the reagent comprises a moiety chosen from the group consisting of a synthetic organic molecule, a synthetic intermediate, a synthetic precursor, an antibiotic, a metabolite, a candidate pharmaceutical agent, or a pharmaceutical agent.

24. The particle described in claim 18 wherein the reagent comprises a moiety chosen from the group consisting of a virus particle or any portion thereof, a prokaryotic cell, a eukaryotic cell, a vertebrate cell, a mammalian cell, a human cell, any portion of said cell, a liposome, a vesicle, and a subcellular organelle.

25. The particle described in claim 18 further comprising a linker between a surface and a moiety comprising the reagent.

26. The particle described in claim 25 wherein the moiety further comprises a spacer between the linker and the reagent.

27. The particle described in claim 25 wherein the linker comprises a structure
-A_{L}-R_{L}—Y_{L};
wherein A_{L} binds a surface of the particle;
wherein R_{L} comprises (D)ₙ,
wherein each D moiety is independently a heteroatom, a C(R₁)(R₂) group, an amino acyl residue, a modified amino acyl residue, a nucleotidyl group, or a modified nucleotidyl group;
wherein n varies from 0 to 3000;
wherein each R₁ and R₂ is independently H, OH, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino;
wherein R₁, and R₂ each independently comprise between 0 and 20 C atoms; and
wherein Y_{L} binds the moiety comprising the reagent.

28. The particle described in claim 27 wherein A_{L} comprises T or a Z-Si(R_{A})(R_{B}) moiety; wherein
T comprises Q, S—S, O-QC, NR₃-Q, CQ-O, CQ-NR₃, N═N, SO₂—NR₃, or NR₃—SO₂;
Z is absent or comprises Q;
R_{A} and R_{B} are independently X, Z, OR₃, or NR₃R₃;
wherein X is F, Cl, Br, or I;
wherein each R₃ is independently H, normal or branched chain alkyl, normal or branched chain alkylene, cycloalkyl, aryl, or aralkyl; and
wherein R₃ comprises between 0 and 20 C atoms; and
Q is O or S.

29. The particle described in claim 28 wherein Y_{L} is absent or comprises
Q, NR₃, CR₃═, N═, C(R₃)(OH)C(R₃)(R₄), 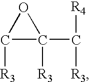
SO₂, CQ, NR₃CQ, C(R₃)(R₄)C(R₃)-M, 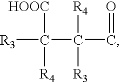
Diels, Alder, or cyclopentadienyl;
wherein each R₃ and R₄ is independently H, normal or branched chain alkyl, normal or branched chain alkylene, cycloalkyl, aryl, or aralkyl,
wherein R₃, and R₄ each independently comprise between 0 and 20 C atoms;
wherein Q is O or S; and
wherein M is COOH, COOR₃, CHO, CN, CON(R₃)(R₄), NO₂, SOR₃, or SO₂R₃.

30. The particle described in claim 25 wherein the linker comprises a cleavable moiety.

31. The particle described in claim 25 wherein the linker is bound to the substrate by a covalent bond.

32. The particle described in claim 25 wherein the linker is bound to the substrate by a noncovalent interaction.

33. The particle described in claim 28 wherein the particle comprises silica or a silicate and A_{L} comprises a Z-Si(R_{A})(R_{B}) moiety.

34. The particle described in claim 26 wherein the moiety comprises
—Y_{S}—R_{S}-T_{R};
wherein Y_{S} binds the linker, R_{S} is the spacer, and T_{R} is the reagent.

35. The particle described in claim 34 wherein Y_{S} is absent or comprises
Q, NR₃, ═CR₃, ═N, C(R₃)(R₄)—C(R₃)(OH), 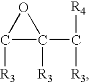
SO₂, CQ, CQNR₃, M-C(R₃)(R₃)(R₄), 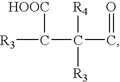
Diels, Alder, or cyclopentadienyl;
wherein each R₃ and R₄ is independently H, normal or branched chain alkyl, normal or branched chain alkylene, cycloalkyl, aryl, or aralkyl,
wherein R₃ and R₄ each independently comprise between 0 and 20 C atoms;
wherein Q is O or S;
wherein M is COOH, COOR₃, CHO, CN, CON(R₃)(R₄), NO₂, SOR₃, or SO₂R₃; and
wherein cyclopentadienyl is any monocyclic or polycyclic cyclopentadienyl radical.

36. The particle described in claim 34 wherein R_{S} comprises (D)ₙ,
wherein each D moiety is independently a heteroatom, a C(R₁)(R₂) group, an amino acyl residue, a modified amino acyl residue, a nucleotidyl group, or a modified nucleotidyl group;
wherein n varies from 0 to 3000; and
wherein each R₁ and R₂ is independently H, OH, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino; and
wherein R₁, and R₂ each independently comprise between 0 and 20 C atoms.

37. A coded reagent library comprising a plurality of particles wherein each particle comprises
a) a diffraction grating-based encoded element, wherein the encoded element comprises an optical substrate having at least one surface and comprising at least one substrate material, said substrate having at least one diffraction grating disposed therein, said grating having a resultant refractive index variation at a grating location, said grating being embedded within a substantially single material of said substrate, said grating providing an output optical signal indicative of a code when illuminated by an incident light signal propagating from outside said substrate, said optical output signal being a result of passive, non-resonant scattering from said grating when illuminated by said incident light signal; and
b) a reagent disposed on at least a portion of the surface of the substrate.

38. The reagent library described in claim 37 wherein a first optical substrate bearing a first code is bound to a first reagent and a second substrate bearing a second code is bound to a second reagent.

39. The reagent library described in claim 37 wherein a plurality of reagents is bound to a particle.

40. The reagent library described in claim 37 wherein a reagent that is bound to a particle of the library comprises a nucleic acid, a polynucleotide, an oligonucleotide, a nucleotide, a nucleoside, a protein nucleic acid, an oligopeptide nucleic acid, a protein or fragment thereof, an enzyme or fragment thereof, a receptor or fragment thereof, a polypeptide, an oligopeptide, an amino acid, a derivative of any of them, or a modification of any of them.

41. The reagent library described in claim 37 wherein a reagent that is bound to a particle of the library comprises a moiety chosen from the group consisting of a synthetic organic molecule, a synthetic intermediate, a synthetic precursor, an antibiotic, a metabolite, a candidate pharmaceutical agent, or a pharmaceutical agent.

42. The reagent library described in claim 37 wherein a reagent that is bound to a particle of the library comprises a moiety chosen from the group consisting of a virus particle or any portion thereof, a prokaryotic cell, a eukaryotic cell, a vertebrate cell, a mammalian cell, a human cell, any portion of said cell, a liposome, a vesicle, and a subcellular organelle.

43. The reagent library described in claim 37 further comprising a linker between a surface and the reagent.

44. The reagent library described in claim 37 further comprising a spacer between a surface and the reagent.

45. An assay composition comprising a particle described in claim 18 and a fluid medium.

46. The assay composition described in claim 45 further comprising an analyte contained in the fluid.

47. An assay composition comprising a reagent library described in claim 37 and a fluid medium.

48. The assay composition described in claim 47 further comprising at least one analyte contained in the fluid.

49. A method of preparing a multicomponent article comprising the steps of:
a) providing a diffraction grating-based encoded element, wherein the encoded element comprises an optical substrate having at least one surface and comprising at least one substrate material, said substrate having at least one diffraction grating disposed therein, said grating having a resultant refractive index variation at a grating location, said grating being embedded within a substantially single material of said substrate, said grating providing an output optical signal indicative of a code when illuminated by an incident light signal propagating from outside said substrate, said optical output signal being a result of passive, non-resonant scattering from said grating when illuminated by said incident light signal; and
b) binding a substance to at least a portion of a surface of said optical substrate.

50. The method described in claim 49 wherein the article is a particle.

51. The method described in claim 49 wherein the substance is a reagent.

52. The method described in claim 51 wherein the reagent comprises a nucleic acid, a polynucleotide, an oligonucleotide, a nucleotide, a nucleoside, a protein nucleic acid, an oligopeptide nucleic acid, a protein or fragment thereof, an enzyme or fragment thereof, a receptor or fragment thereof, a polypeptide, an oligopeptide, an amino acid, a derivative of any of them, or a modification of any of them.

53. The method described in claim 51 wherein the reagent comprises a moiety chosen from the group consisting of a synthetic organic molecule, a synthetic intermediate, a synthetic precursor, an antibiotic, a metabolite, a candidate pharmaceutical agent, or a pharmaceutical agent.

54. The method described in claim 51 wherein the reagent comprises a moiety chosen from the group consisting of a virus, a prokaryotic cell, a eukaryotic cell, a vertebrate cell, a mammalian cell, a human cell, and a subcellular organelle.

55. The method described in claim 51 further comprising
a) identifying the code embedded in the article, and
b) binding a single reagent to the substrate,
thereby identifying the coded particle as bearing the reagent.

56. The method described in claim 49 wherein the substrate comprises silica, a silicate, a glass, a semiconducting material, or a ceramic material.

57. The method described in claim 49 wherein the substrate comprises a polymer, a resin, a rubber material, or a derivative thereof.

58. The method described in claim 51 wherein step b) further comprises
b′) contacting the surface of the optical substrate with a first composition comprising a linker precursor, wherein the precursor comprises a linker, under conditions whereby the linker precursor binds to the substrate; and
b″) contacting the linker precursor bound to the substrate with a second composition comprising a reagent precursor, wherein the precursor comprises the reagent, under conditions whereby the reagent precursor binds the linker precursor;
thereby binding the reagent to the article.

59. The method described in claim 51 wherein step b) further comprises
b′) combining a linker precursor and a reagent precursor, wherein the reagent precursor comprises the reagent, under conditions whereby the reagent precursor binds the linker precursor to form a conjugate; and
b″) contacting the surface of the optical substrate with a composition comprising the conjugate, under conditions whereby the linker moiety comprised within the conjugate binds to the substrate;
thereby binding the reagent to the article.

60. The method described in claim 51 wherein step b) further comprises binding a linker precursor to a reagent precursor, wherein the linker precursor comprises a structure
A_{LP}-R_{L}—Y_{LP};
wherein A_{LP} forms a covalent bond with the substrate
wherein R_{L} comprises (D)ₙ,
wherein each D moiety is independently a heteroatom, a C(R₁)( R₂) group, an amino acyl residue, a modified amino acyl residue, a nucleotidyl group, or a modified nucleotidyl group;
wherein n varies from 0 to 3000;
wherein Y_{LP} forms a covalent bond with the reagent precursor;
wherein each R₁ and R₂ is independently H, OH, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino; and
wherein R₁, and R₂ each independently comprise between 0 and 20 C atoms.

61. The method described in claim 60 wherein A_{LP} comprises T or a Z-Si(R_{A})(R_{B}) moiety; wherein
T comprises HQ, HS—S, X-QC, X—NR₃CQ, X-CQ-O, X—CQ-NR₃, HN═N, X—SO₂—NR₃, or X—NR₃—SO₂;
Z comprises R_{C}; and
R_{A}, R_{B}, and R_{C} are independently X, Z, OR₃, or NR₃R₃;
wherein each R₃ is independently H, normal or branched chain alkyl, normal or branched chain alkylene, cycloalkyl, aryl, or aralkyl,
wherein R₃ comprises between 0 and 20 C atoms;
wherein X is F, Cl, Br, or I; and
wherein Q is O or S.

62. The method described in claim 60 wherein Y_{LP} comprises
QH, N(R₃)H, C(R₃)═O, C(R₃)(OR₃)(OH), C(R₃)(OR₃)(OR₃), 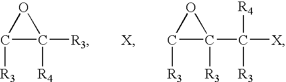
SO₂—X, CQOR₅, (R₃)NCQOR₃, N(R₃)C=Q, C(R₃)(R₄)═C(R₃)-M, 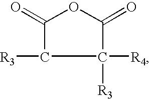
Diels-Alder diene, C(R₃)(R₄)═C(R₃)(R₄), or cyclopentadienyl;
wherein R₃ and R₄ is are independently H, normal or branched chain alkyl, normal or branched chain alkylene, cycloalkyl, aryl, or aralkyl,
wherein R₃ and R₄ each independently comprise between 0 and 20 C atoms;
wherein R₅ is either H and the second composition further comprises a carbodiimide coupling agent, or pentachlorophenyl, or N-hydroxysuccinimidyl;
wherein Q is O or S;
wherein M is COOH, COOR₃, CHO, CN, CON(R₃)(R₄), NO₂, SOR₃, or SO₂R₃,
wherein cyclopentadienyl is any monocyclic or polycyclic cyclopentadienyl radical.;
wherein [Me] designates any metal cation that forms a metallocene complex with cyclopentadiene or derivatives thereof; and
X is F, Cl, Br, or I.

63. The method described in claim 60 wherein the reagent precursor comprises a structure
Y_{SP}—R_{S}-T_{R};
wherein T_{R} is the reagent;
wherein Y_{SP} forms a covalent bond with the linker; and
wherein R_{S} comprises (D)ₙ,
wherein each D moiety is independently a heteroatom, a C(R₁)(R₂) group, an amino acyl residue, a modified amino acyl residue, a nucleotidyl group, or a modified nucleotidyl group;
wherein each R₁ and R₂ is independently H, OH, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino; and
wherein R₁ and R₂ each independently comprise between 0 and 20 C atoms;

64. The method described in claim 63 wherein Y_{SP} comprises
QH, N(R₃)H, O═C(R₃), (R₃O)(HO)C(R₃)), (R₃O)(R₃O)C(R₃), 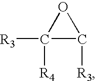
X, 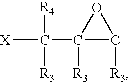
X—SO₂, R₅OCQ, R₃OCQN(R₃), Q=CNR₃, (M)(R₃)C═C(R₃)(R₄), 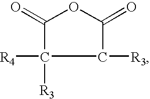
Diels-Alder diene, C(R₃)(R₄)═C(R₃)(R₄), or [Me] +cyclopentadienyl;
wherein R₃ and R₄ is are independently H, normal or branched chain alkyl, normal or branched chain alkylene, cycloalkyl, aryl, or aralkyl,
wherein each R₁ and R₂ is independently H, normal or branched chain alkyl, normal or branched chain alkylene, cycloalkyl, aryl, normal or branched chain alkoxy, cycloalkoxy, aryloxy, normal or branched chain alkylamino, normal or branched chain alkyleneamino, cycloalkylamino or arylamino;
wherein R₁, R₂, R₃, and R₄ each independently comprise between 0 and 20 C atoms;
wherein R₅ is either H and the second composition further comprises a carbodiimide coupling agent, or pentachlorophenyl, or N-hydroxysuccinimidyl;
wherein Q is O or S;
wherein [Me] designates any metal cation that forms a metallocene complex with cyclopentadiene or a derivative thereof;
wherein M is COOH, COOR₃, CHO, CN, CON(R₃)(R₄), NO₂, SOR₃, or SO₂R₃;
wherein cyclopentadienyl is any monocyclic or polycyclic cyclopentadienyl radical; and
wherein X is F, Cl, Br, or I.

65. The method described in claim 51 further comprising, in step a), providing a plurality of diffraction grating-based encoded elements; and in step b), binding a reagent to at least a portion of the optical substrate of each diffraction grating-based encoded element provided in step a);
thereby providing a coded reagent library.

66. The method described in claim 65 further comprising
a′) in step a) maintaining a first optical substrate bearing a first code separate from a second substrate bearing a second code, and
b′) in step b) binding a first reagent to the first optical substrate and a second reagent to the second optical substrate.

67. The method described in claim 51 wherein the reagent in step b) is a first nucleotide reagent; and further extending the nucleotide sequence by sequential addition reactions;
thereby providing a coded polynucleotide reagent.

68. The method described in claim 67 further comprising
a) identifying the code embedded in the particle, and
b) identifying the sequence of the polynucleotide,
thereby identifying the coded article as bearing the polynucleotide.

69. The method described in claim 51 wherein the reagent in step b) is a polynucleotide reagent; thereby providing a coded polynucleotide reagent.

70. The method described in claim 51 further comprising, in step a), providing a plurality of diffraction grating-based encoded elements; in step b), binding a first nucleotide reagent to at least a portion of the optical substrate of each diffraction grating-based encoded element provided in step a); and further extending the nucleotide sequence bound to each optical substrate by sequential addition reactions;
thereby providing a coded polynucleotide reagent library.

71. The method described in claim 70 further comprising
a′) in step a) maintaining a first optical substrate bearing a first code separate from a second substrate bearing a second code, and
b′) in step b) and further in the extending step, synthesizing a first polynucleotide on the first optical substrate and a second polynucleotide on the second optical substrate.

72. The method described in claim 51 further comprising, in step a), providing a plurality of diffraction grating-based encoded elements; and in step b), binding a polynucleotide reagent to at least a portion of the optical substrate of each diffraction grating-based encoded element provided in step a);
thereby providing a coded polynucleotide reagent library.
